(19) United States
(12) Patent Application Publication
(10) Pub. No.: US 2025/0117849 A1
(43) Pub. Date: Apr. 10, 2025

(54) Decentralized Exchange with Price Oracle Apparatuses, Processes and Systems

(71) Applicant: FMR LLC, Boston, MA (US)

(72) Inventors: Man Hei Raymond Yim, Cambridge, MA (US); Derrick Chan, Boston, MA (US)

(21) Appl. No.: 18/378,296

(22) Filed: Oct. 10, 2023

(51) Int. Cl. G06Q 40/04; G06Q 20/02; G06Q 30/0201

(52) U.S. Cl. CPC G06Q 40/04; G06Q 20/02; G06Q 30/0206; G06Q 2220/00

(57) ABSTRACT

The Decentralized Exchange with Price Oracle Apparatuses, Processes and Systems (“DEPO”) transforms decentralized exchange liquidity provision request, decentralized exchange crypto asset swap request, decentralized exchange liquidity redemption request datastructure/inputs via DEPO components into decentralized exchange liquidity provision response, decentralized exchange crypto asset swap response, decentralized exchange liquidity redemption response outputs. A decentralized exchange liquidity provision transaction is obtained via a bidirectional decentralized exchange smart contract deployed on a blockchain. A crypto assets exchange quotient for exchanging a first crypto asset type and a second crypto asset type is determined. A quantity of fungible tokens specific to a crypto assets liquidity tranche datastructure to generate is calculated. The calculated quantity of fungible tokens specific to the crypto assets liquidity tranche datastructure is transferred to a provision blockchain address controlled by a sender of the decentralized exchange liquidity provision transaction.

This application for letters patent disclosure document describes inventive aspects that include various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### FIELD

The present innovations generally address information technology, and more particularly, include Decentralized Exchange with Price Oracle Apparatuses, Processes and Systems.

However, in order to develop a reader's understanding of the innovations, disclosures have been compiled into a single description to illustrate and clarify how aspects of these innovations operate independently, interoperate as between individual innovations, and/or cooperate collectively. The application goes on to further describe the interrelations and synergies as between the various innovations; all of which is to further compliance with 35 U.S.C. § 112.

### BACKGROUND

Ethereum is an open source software application and a shared protocol. It allows users to anonymously and instantaneously transact Ether, a digital currency, without needing to trust counterparties or separate intermediaries. Ethereum achieves this trustless anonymous network using public/private key pairs, a popular encryption technique.

### BRIEF DESCRIPTION OF THE DRAWINGS

Appendices and/or drawings illustrating various, non-limiting, example, innovative aspects of the Decentralized Exchange with Price Oracle Apparatuses, Processes and Systems (hereinafter “DEPO”) disclosure, include:

FIG. 1 shows non-limiting, example embodiments of a datagraph illustrating data flow(s) for the DEPO;

FIG. 2 shows non-limiting, example embodiments of a logic flow illustrating a bidirectional decentralized exchange liquidity provision (BDELP) component for the DEPO;

FIG. 3 shows non-limiting, example embodiments of a datagraph illustrating data flow(s) for the DEPO;

FIG. 4 shows non-limiting, example embodiments of a logic flow illustrating a bidirectional decentralized exchange swap processing (BDESP) component for the DEPO;

FIG. 5 shows non-limiting, example embodiments of a datagraph illustrating data flow(s) for the DEPO;

FIG. 6 shows non-limiting, example embodiments of a logic flow illustrating a bidirectional decentralized exchange liquidity redemption (BDELR) component for the DEPO;

FIG. 7 shows non-limiting, example embodiments of a datagraph illustrating data flow(s) for the DEPO;

FIG. 8 shows non-limiting, example embodiments of a logic flow illustrating a unidirectional decentralized exchange liquidity provision (UDELP) component for the DEPO;

FIG. 9 shows non-limiting, example embodiments of a datagraph illustrating data flow(s) for the DEPO;

FIG. 10 shows non-limiting, example embodiments of a logic flow illustrating a unidirectional decentralized exchange swap processing (UDESP) component for the DEPO;

FIG. 11 shows non-limiting, example embodiments of a datagraph illustrating data flow(s) for the DEPO;

FIG. 12 shows non-limiting, example embodiments of a logic flow illustrating a unidirectional decentralized exchange liquidity redemption (UDELR) component for the DEPO;

FIG. 13 shows non-limiting, example embodiments of a logic flow illustrating a crypto assets exchange quotient computation (CAEQC) component for the DEPO;

FIG. 14 shows non-limiting, example embodiments of a logic flow illustrating a crypto assets swap capacity computation (CASCC) component for the DEPO;

FIG. 15 shows non-limiting, example embodiments of a screenshot illustrating user interface(s) of the DEPO;

FIG. 16 shows non-limiting, example embodiments of a screenshot illustrating user interface(s) of the DEPO;

FIG. 17 shows a block diagram illustrating non-limiting, example embodiments of a DEPO controller.

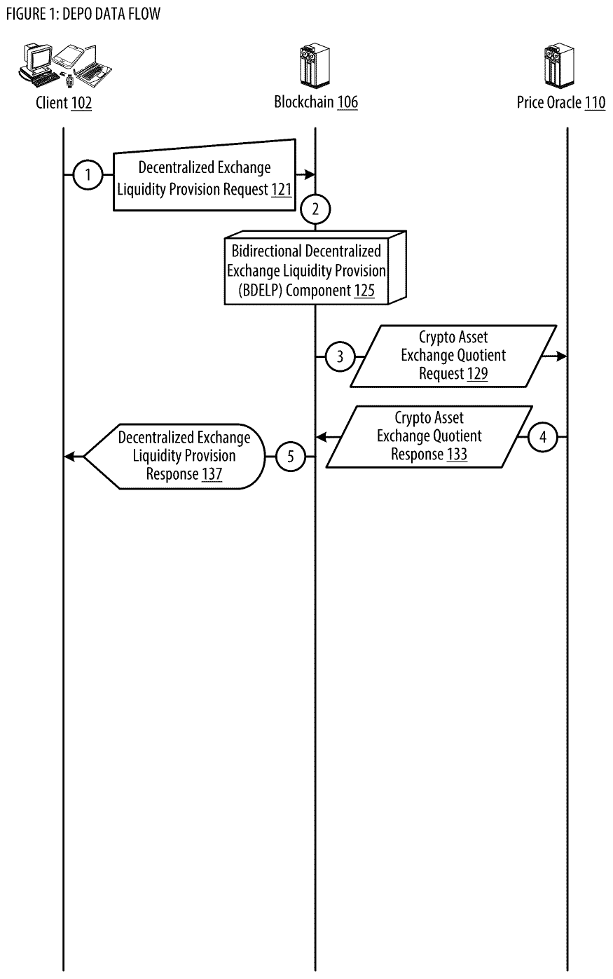

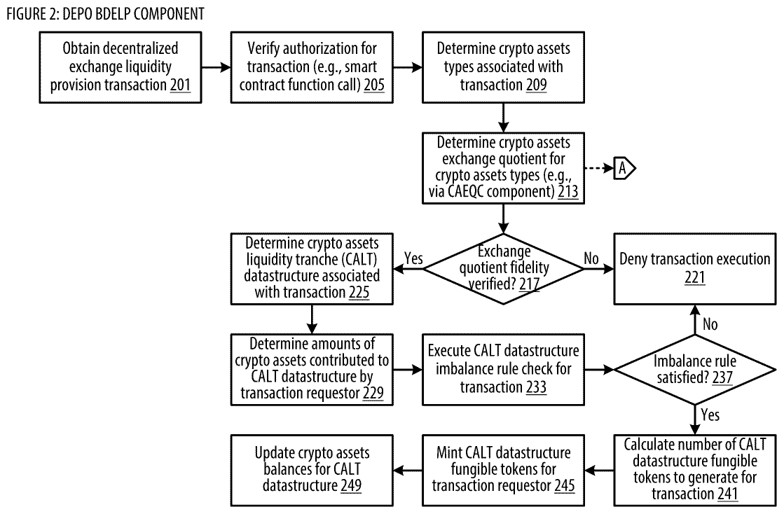

Generally, the leading number of each citation number within the drawings indicates the figure in which that citation number is introduced and/or detailed. As such, a detailed discussion of citation number 101 would be found and/or introduced in FIG. 1. Citation number 201 is introduced in FIG. 2, etc. Any citations and/or reference numbers are not necessarily sequences but rather just example orders that may be rearranged and other orders are contemplated. Citation number suffixes may indicate that an earlier introduced item has been re-referenced in the context of a later figure and may indicate the same item, evolved/modified version of the earlier introduced item, etc., e.g., server 199 of FIG. 1 may be a similar server 299 of FIG. 2 in the same and/or new context.

### DETAILED DESCRIPTION

The Decentralized Exchange with Price Oracle Apparatuses, Processes and Systems (hereinafter “DEPO”) transforms decentralized exchange liquidity provision request, decentralized exchange crypto asset swap request, decentralized exchange liquidity redemption request datastructure/inputs, via DEPO components (e.g., BDELP, BDESP, BDELR, UDELP, UDESP, UDELR, CAEQC, CASCC, etc. components), into decentralized exchange liquidity provision response, decentralized exchange crypto asset swap response, decentralized exchange liquidity redemption response outputs. The DEPO components, in various embodiments, implement advantageous features as set forth below.

### INTRODUCTION

The DEPO provides unconventional features (e.g., a blockchain protocol that utilizes multiple types of fungible tokens for different crypto assets liquidity tranche datastructures, a blockchain protocol that utilizes non-fungible tokens (NFTs) with a redemption delay to implement limit orders for an associated crypto assets liquidity tranche datastructure) that were never before available in information technology.

In one embodiment, the DEPO implements an automated market making (AMM) protocol on blockchain that integrates with oracle price feed and allows market impact. In various embodiments, the DEPO may reduce impermanent loss and adverse selection, integrate with use of NFT-based limit order with protection to liquidity provider (LP) and/or liquidity takers, and/or the like.

In various embodiments, the DEPO may implement the use of multiple liquidity tranches that pivots against price oracle with dynamic spread adjustment (e.g., based on imbalance creation), the use of swap capacity to protect liquidity providers, the use of NFT limit order with delay cancellation and integration with AMM protocols, and/or the like.

In various embodiments, the DEPO may implement an AMM protocol with one or more of the following features:
The creation of multiple liquidity tranches for liquidity provision
The use of multiple types of fungible tokens to keep track of LPs in different tranches
Minting and redemption of fungible tokens
The use of maximum swap capacity per liquidity tranches to protect LPs against adverse selection
Time-varying market impact cost for liquidity takers given state of liquidity tranches
The use of price oracle to determine fair swap value when price oracle is active
The use of effective price oracle when price oracle is inactive

### DEPO

FIG. 1 shows non-limiting, example embodiments of a datagraph illustrating data flow(s) for the DEPO. In FIG. 1, a client 102 (e.g., of a user (e.g., a liquidity provider)) may send a decentralized exchange liquidity provision request 121 to a bidirectional decentralized exchange smart contract deployed on a blockchain (e.g., Ethereum, Solana) 106 to provide liquidity for a decentralized exchange by contributing crypto assets (e.g., crypto currency tokens such as Ethereum tokens, Solana tokens). For example, the client may be a desktop, a laptop, a tablet, a smartphone, a smartwatch, and/or the like that is executing a client application. It is to be understood that, in various implementations, the client may send the decentralized exchange liquidity provision request directly to the blockchain or via an intermediary server (e.g., providing a cryptographic wallet service to the user). In one implementation, the decentralized exchange liquidity provision request may include data such as a request identifier, a smart contract address, function call details, and/or the like. In one embodiment, the client may provide the following example decentralized exchange liquidity provision request, substantially in the form of a (Secure) Hypertext Transfer Protocol (“HTTP(S)”) POST message including extensible Markup Language (“XML”) formatted data, as provided below:

```
POST /authrequest.php HTTP/1.1
Host: www.server.com
Content-Type: Application/XML
Content-Length: 667
<?XML version = “1.0” encoding = “UTF-8”?>
<auth_request>
  <timestamp>2020-12-31 23:59:59</timestamp>
  <user_accounts_details>
      <user_account_credentials>
          <user_name>JohnDaDoeDoeDoooe@gmail.com</user_name>
          <password>abc123</password>
          //OPTIONAL <cookie>cookieID</cookie>
          //OPTIONAL <digital_cert_link>www.mydigitalcertificate.com/
JohnDoeDaDoeDoe@gmail.com/mycertifcate.dc</digital_cert_link>
          //OPTIONAL <digital_certificate>_DATA_</digital_certificate>
      </user_account_credentials>
  </user_accounts_details>
  <client_details> //iOS Client with App and Webkit
          //it should be noted that although several client details
          //sections are provided to show example variants of client
          //sources, further messages may include only one to save
          //space
      <client_IP>10.0.0.123</client_IP>
      <user_agent_string>Mozilla/5.0 (iPhone; CPU iPhone OS 7_1_1 like Mac
OS X) AppleWebKit/537.51.2 (KHTML, like Gecko) Version/7.0 Mobile/11D201
Safari/9537.53</user_agent_string>
      <client_product_type>iPhone6,1</client_product_type>
      <client_serial_number>DNXXX1X1XXXX</client_serial_number>
      <client_UDID>3XXXXXXXXXXXXXXXXXXXXXXXXD</client_UDID>
      <client_OS>iOS</client_OS>
      <client_OS_version>7.1.1</client_OS_version>
      <client_app_type>app with webkit</client_app_type>
      <app_installed_flag>true</app_installed_flag>
      <app_name>DEPO.app</app_name>
      <app_version>1.0 </app_version>
      <app_webkit_name>Mobile Safari</client_webkit_name>
      <client_version>537.51.2</client_version>
  </client_details>
  <client_details> //iOS Client with Webbrowser
      <client_IP>10.0.0.123</client_IP>
      <user_agent_string>Mozilla/5.0 (iPhone; CPU iPhone OS 7_1_1 like Mac
OS X) AppleWebKit/537.51.2 (KHTML, like Gecko) Version/7.0 Mobile/11D201
Safari/9537.53</user_agent_string>
      <client_product_type>iPhone6,1</client_product_type>
      <client_serial_number>DNXXX1X1XXXX</client_serial_number>
      <client_UDID>3XXXXXXXXXXXXXXXXXXXXXXXXD</client_UDID>
      <client_OS>iOS</client_OS>
      <client_OS_version>7.1.1</client_OS_version>
      <client_app_type>web browser</client_app_type>
      <client_name>Mobile Safari</client_name>
      <client_version>9537.53</client_version>
  </client_details>
  <client_details> //Android Client with Webbrowser
      <client_IP>10.0.0.123</client_IP>
      <user_agent_string>Mozilla/5.0 (Linux; U; Android 4.0.4; en-us; Nexus
S Build/IMM76D) AppleWebKit/534.30 (KHTML, like Gecko) Version/4.0 Mobile
Safari/534.30</user_agent_string>
      <client_product_type>Nexus S</client_product_type>
      <client_serial_number>YXXXXXXXXZ</client_serial_number>
      <client_UDID>FXXXXXXXXX-XXXX-XXXX-XXXX-XXXXXXXXXXXXX</client_UDID>
      <client_OS>Android</client_OS>
      <client_OS_version>4.0.4</client_OS_version>
      <client_app_type>web browser</client_app_type>
      <client_name>Mobile Safari</client_name>
      <client_version>534.30</client_version>
  </client_details>
  <client_details> //Mac Desktop with Webbrowser
      <client_IP>10.0.0.123</client_IP>
      <user_agent_string>Mozilla/5.0 (Macintosh; Intel Mac OS X 10_9_3)
AppleWebKit/537.75.14 (KHTML, like Gecko) Version/7.0.3
Safari/537.75.14</user_agent_string>
      <client_product_type>MacPro5,1</client_product_type>
      <client_serial_number>YXXXXXXXXZ</client_serial_number>
      <client_UDID>FXXXXXXXXX-XXXX-XXXX-XXXX-XXXXXXXXXXXXX</client_UDID>
      <client_OS>Mac OS X</client_OS>
      <client_OS_version>10.9.3</client_OS_version>
      <client_app_type>web browser</client_app_type>
      <client_name>Mobile Safari</client_name>
      <client_version>537.75.14</client_version>
  </client_details>
  <decentralized_exchange_liquidity_provision_request>
    <request_identifier>ID_request_1</request_identifier>
    <smart_contract_address>
      address of the bidirectional decentralized exchange smart contract
    </smart_contract_address>
    <function_call_details>
      <function_name>provide</function_name>
      <crypto_asset_types>
        crypto_asset_A, crypto_asset_B
      </crypto_asset_types>
      <liquidity_tranche_datastructure_identifier>
        ID_liquidity_tranche_datastructure_1
      </liquidity_tranche_datastructure_identifier>
      <contribution>
        <crypto_asset_type>crypto_asset_A</crypto_asset_type>
        <amount>200 units</amount>
      </contribution>
      <contribution>
        <crypto_asset_type>crypto_asset_B</crypto_asset_type>
        <amount>100 units</amount>
      </contribution>
      <to_address>
        blockchain address associated with the user to which to transfer
        fungible tokens
      </to_address>
      <transaction_signature>
        signature of the user
      </transaction_signature>
    </function_call_details>
  </decentralized_exchange_liquidity_provision_request>
</auth_request>
```

A bidirectional decentralized exchange liquidity provision (BDELP) component 125 (e.g., implemented via the bidirectional decentralized exchange smart contract) may utilize data provided in the decentralized exchange liquidity provision request to facilitate liquidity provision for the decentralized exchange. See FIG. 2 for additional details regarding the BDELP component.

The bidirectional decentralized exchange smart contract deployed on the blockchain 106 may send a crypto asset exchange quotient request 129 to a price oracle 110 (e.g., an on-chain price oracle such as Pyth) to determine a crypto assets exchange quotient (e.g., price for exchanging crypto asset A to crypto asset B) for crypto asset types associated with the decentralized exchange liquidity provision request. In one implementation, the crypto asset exchange quotient request may include data such as a request identifier, a from crypto asset type, a to crypto asset type, and/or the like. In one embodiment, the bidirectional decentralized exchange smart contract deployed on the blockchain may provide the following example crypto asset exchange quotient request, substantially in the form of a HTTP(S) POST message including XML-formatted data, as provided below:

```
POST /crypto_asset_exchange_quotient_request.php HTTP/1.1
Host: www.server.com
Content-Type: Application/XML
Content-Length: 667
<?XML version = “1.0” encoding = “UTF-8”?>
<crypto_asset_exchange_quotient_request>
  <request_identifier>ID_request_2</request_identifier>
  <from_crypto_asset_type>crypto_asset_A</from_crypto_asset_type>
  <to_crypto_asset_type>crypto_asset_B</to_crypto_asset_type>
</crypto_asset_exchange_quotient_request>
```

The price oracle 110 may send a crypto asset exchange quotient response 133 to the bidirectional decentralized exchange smart contract deployed on the blockchain 106 with the requested crypto assets exchange quotient data. In one implementation, the crypto asset exchange quotient response may include data such as a response identifier, the requested crypto assets exchange quotient data, and/or the like. In one embodiment, the price oracle may provide the following example crypto asset exchange quotient response, substantially in the form of a HTTP(S) POST message including XML-formatted data, as provided below:

```
POST /crypto_asset_exchange_quotient_response.php HTTP/1.1
Host: www.server.com
Content-Type: Application/XML
Content-Length: 667
<?XML version = “1.0” encoding = “UTF-8”?>
<crypto_asset_exchange_quotient_response>
  <response_identifier>ID_response_2</response_identifier>
  <crypto_assets_exchange_quotient_data>
    <crypto_assets_exchange_quotient>2</crypto_assets_exchange_quotient>
    <confidence_interval>0.01 at 95% confidence level</confidence_interval>
    <timestamp>2024-01-01 12:00:01</timestamp>
  </crypto_assets_exchange_quotient_data>
</crypto_asset_exchange_quotient_response>
```

The bidirectional decentralized exchange smart contract deployed on the blockchain 106 may send (e.g., via emitting an event) a decentralized exchange liquidity provision response 137 to the client 102 to inform the user whether the decentralized exchange liquidity provision request was processed successfully. In one implementation, the decentralized exchange liquidity provision response may include data such as a response identifier, a status, and/or the like. In one embodiment, the bidirectional decentralized exchange smart contract deployed on the blockchain may provide the following example decentralized exchange liquidity provision response, substantially in the form of a HTTP(S) POST message including XML-formatted data, as provided below:

```
POST /decentralized_exchange_liquidity_provision_response.php
HTTP/1.1
Host: www.server.com
Content-Type: Application/XML
Content-Length: 667
<?XML version = “1.0” encoding = “UTF-8”?>
<decentralized_exchange_liquidity_provision_response>
  <response_identifier>ID_response_1</response_identifier>
  <status>OK</status>
</decentralized_exchange_liquidity_provision_response>
```

FIG. 2 shows non-limiting, example embodiments of a logic flow illustrating a bidirectional decentralized exchange liquidity provision (BDELP) component for the DEPO. In FIG. 2, a decentralized exchange liquidity provision transaction may be obtained at 201. For example, the decentralized exchange liquidity provision transaction may be obtained as a result of a function call to a function (e.g., provide) implemented by a bidirectional decentralized exchange smart contract from a user (e.g., a liquidity provider) to provide liquidity for a decentralized exchange by contributing crypto assets.

Authorization for the decentralized exchange liquidity provision transaction (e.g., smart contract function call) may be verified at 205. In one embodiment, verification may be performed to ensure that the decentralized exchange liquidity provision transaction was submitted by an authorized entity (e.g., the user). In one implementation, authorization for the decentralized exchange liquidity provision transaction may be verified via Solidity commands (e.g., via a require ( ) statement) that implement access control (e.g., ownable access control, role-based access control) for the functions implemented by the bidirectional decentralized exchange smart contract.

Crypto assets types associated with the decentralized exchange liquidity provision transaction may be determined at 209. In one implementation, the bidirectional decentralized exchange smart contract may be structured as specifying the (e.g., two) crypto asset types that may be swapped via the bidirectional decentralized exchange smart contract (e.g., crypto asset types crypto_asset_A and crypto_asset_B). In another implementation, the decentralized exchange liquidity provision transaction may be parsed (e.g., using Solidity commands) to determine the associated crypto asset types (e.g., based on the value of the crypto_asset_types field).

A crypto assets exchange quotient for the associated crypto assets types may be determined at 213. For example, a crypto assets exchange quotient of 2 would indicate that 2 units of crypto assets crypto_asset_A would be exchanged for 1 unit of crypto assets crypto_asset_B (e.g., via a liquidity tranche datastructure utilizing an atomic liquidity utilization measure multiple of 0 (e.g., no additional spread or fee)). In one implementation, a price oracle may be queried (e.g., via a crypto asset exchange quotient request) to determine the crypto assets exchange quotient for the associated crypto assets types. In another implementation, the crypto assets exchange quotient for the associated crypto assets types may be determined via the CAEQC component.

A determination may be made at 217 whether exchange quotient fidelity associated with the crypto assets exchange quotient may be verified. In one implementation, the price oracle may specify a confidence measure associated with the crypto assets exchange quotient (e.g., 0.01 confidence interval at 95% confidence level), and the exchange quotient fidelity is verified if the confidence measure satisfies a confidence measure threshold rule (e.g., the confidence interval is not excessively large (e.g., less than 3%) against the crypto assets exchange quotient (e.g., the price value)). In another implementation, the CAEQC component may specify whether the exchange quotient fidelity is verified.

If the exchange quotient fidelity associated with the crypto assets exchange quotient is not verified, transaction execution may be denied at 221. In one implementation, a message indicating that execution of the decentralized exchange liquidity provision transaction was denied may be generated (e.g., via emitting an event).

If the exchange quotient fidelity associated with the crypto assets exchange quotient is verified, a crypto assets liquidity tranche (CALT) datastructure associated with the decentralized exchange liquidity provision transaction may be determined at 225. In one embodiment, a liquidity pool comprising multiple CALT datastructures each corresponding to a different liquidity tranche may be utilized by the DEPO. In one implementation, multiple types of fungible tokens may be issued by the DEPO to keep track of liquidity in different liquidity tranches. In some embodiments, each liquidity tranche may be considered as a sub-AMM with a specific spread (or fee) against the price oracle. Let SAB denote the atomic liquidity utilization measure (e.g., atomic spread) for a given swap of crypto assets crypto_asset_A and crypto_asset_B, and let PAB be the oracle price for exchanging crypto assets crypto_asset_A to crypto assets crypto_asset_B. Each liquidity tranches may accept a swap transaction at a specific atomic liquidity utilization measure multiple (e.g., from 0 to n):

| Liquidity Tranche | Transaction Price A to B | Transaction Price B to A |
|---|---|---|
| Tranche 0 | P_{AB} | P_{AB} |
| Tranche 1 | P_{AB} + S_{AB} | P_{AB} − S_{AB} |
| Tranche 2 | P_{AB} + 2S_{AB} | P_{AB} − 2S_{AB} |
| Tranche 3 | P_{AB} + 3S_{AB} | P_{AB} − 3S_{AB} |
| . . . | . . . | . . . |
| Tranche n | P_{AB} + nS_{AB} | P_{AB} − nS_{AB} |

In one embodiment, when liquidity is present in tranche 0, liquidity takers interact with this tranche. However, when liquidity in tranche 0 is exhausted, liquidity takers interact with tranche 1. This process continues iteratively from best (tranche 0) to worst tranche (tranche n). In some embodiments, in addition to spread, a fee may be charged to liquidity takers. Liquidity providers may specify which tranche to utilize for their crypto assets and generate yield via liquidity utilization measure and/or fee collection. For example, tranche 0 may have the highest likelihood of receiving swap transactions, but liquidity utilization measure accrual may be the lowest, while tranche n may have a low likelihood of receiving swap transactions, but liquidity utilization measure accrual may be the highest.

The atomic liquidity utilization measure may be determined in a variety of ways. In one implementation, DEPO administrators vote to determine the quantity, such as 1bps of price of oracle, may be utilized. In another implementation, dynamic computation based on recent deviation of P_{AB} may be utilized. To do so, the DEPO may compute exponential moving average of P_{AB} (EP) and square of P_{AB} (EP2) each block with a decay factor. The exponential moving standard deviation at given block is sqrt (EP2−EP×EP). Atomic liquidity utilization measure may be set to a multiple of the exponential moving standard deviation value. When the price oracle is deemed inactive, a default value may be set using a combination of historical values and/or other defaulting parameters approved by DEPO administrators. In another implementation, adaptive Linear Decrease Multiplicative Increase (LDMI) technique based on liquidity taking transaction that uses the different traches may be utilized. Let S_{AB} be the latest atomic liquidity utilization measure value (e.g., 0.1). The DEPO keeps track of exponential moving average of transaction values at different tranches (V₀, V₁, . . . , Vₙ) and determines the tranche factor (TF):

$$TF = \frac{{\sum }_{i = 0}^{n} {iV}_{i}}{{\sum }_{i = 0}^{n} {V}_{i}}$$

If TF is lower than a threshold, adverse selection risk is low, and the DEPO may increase likelihood of higher tranche usage by decreasing S_{AB} (e.g., linearly), so that S_{AB}←S_{AB}−Δ. An absolute minimum atomic liquidity utilization measure may be imposed after the update. For example, the minimum value may be obtained via one of the previous methods discussed above. If TF is larger than a threshold, adverse selection risk is high, and the DEPO may increase the atomic liquidity utilization measure (e.g., multiplicatively), so that S_{AB}←S_{AB}×Γ.

In one implementation, the decentralized exchange liquidity provision transaction may be parsed (e.g., using Solidity commands) to determine the CALT datastructure associated with the decentralized exchange liquidity provision transaction (e.g., based on the value of the liquidity_tranche_datastructure_identifier field). For example, a CALT datastructure with identifier ID_liquidity_tranche_datastructure_1 (e.g., corresponding to tranche 1) may utilize an atomic liquidity utilization measure multiple of 1.

Amounts of crypto assets contributed to the CALT datastructure by the transaction requestor (e.g., the user) may be determined at 229. In one embodiment, the user may contribute one or more crypto asset types that may be utilized to provide liquidity via the decentralized exchange. For example, the user may contribute crypto assets crypto_asset_A and/or crypto assets crypto_asset_B. In one implementation, the decentralized exchange liquidity provision transaction may be parsed (e.g., using Solidity commands) to determine the types and/or amounts of crypto assets contributed to the CALT datastructure by the user (e.g., based on the values of the contribution fields). For example, the user may contribute 200 units of crypto_asset_A and 100 units of crypto_asset_B.

An imbalance rule check for the CALT datastructure for the decentralized exchange liquidity provision transaction may be executed at 233. In one embodiment, for a given CALT datastructure at a given time, the DEPO has issued L fungible tokens for existing liquidity providers who have a share of the value locked in the given CALT datastructure. Let Q_{A} be the total number of crypto assets crypto_asset_A in the given CALT datastructure, Q_{B} be the total number of crypto assets crypto_asset_B in the given CALT datastructure, and P_{AB} be the crypto assets exchange quotient (e.g., swap price) to convert crypto assets crypto_asset_A to crypto assets crypto_asset_B. The total value locked (TVL) in the given CALT datastructure is:

$$TVL = {Q}_{A} + {Q}_{B} {P}_{AB} units of crypto assets crypto\_asset \_A$$

A liquidity provider may provide additional liquidity for the given CALT datastructure by contributing additional N_{A} units of crypto_asset_A and/or N_{B} units of crypto_asset_B.

In one embodiment, the imbalance rule check may be performed to ensure that additional crypto assets contributions associated with the decentralized exchange liquidity provision transaction do not create additional imbalance for the CALT datastructure. In one implementation, the imbalance rule may be checked as follows to ensure that the user contributes additional crypto assets such that:

If Q_{A}≥Q_{B}P_{AB},

$$( {Q}_{B} + {N}_{B} ) {P}_{AB} - {Q}_{A} \leq {N}_{A} \leq \frac{{Q}_{A}}{{Q}_{B}} {N}_{B}$$

And if Q_{A}≤Q_{B}P_{AB},

$$\frac{{Q}_{A} + {N}_{A}}{{P}_{AB}} - {Q}_{B} \leq {N}_{B} \leq \frac{{Q}_{B}}{{Q}_{A}} {N}_{A}$$

A determination may be made at 237 whether the imbalance rule was satisfied. If the imbalance rule check was not satisfied, transaction execution may be denied at 221.

If the imbalance rule check was satisfied, the number of fungible tokens specific to the CALT datastructure to generate for the decentralized exchange liquidity provision transaction may be calculated at 241. In one embodiment, different CALT datastructures may utilize different types of fungible tokens. As such, these tokens may be fungible with regard to their corresponding CALT datastructure, but may not be fungible among different CALT datastructures. In one implementation, the number of fungible tokens specific to the CALT datastructure to generate (e.g., mint) M may be calculated as follows:

$$M = \frac{{N}_{A} + {N}_{B} {P}_{AB}}{TVL} L$$

In another implementation (e.g., before any fungible tokens specific to the CALT datastructure have been minted), the number of fungible tokens specific to the CALT datastructure to generate (e.g., mint) M may be calculated as follows:

$$M = {N}_{A} + {N}_{B} {P}_{AB}$$

For example, the calculation may indicate that 400 fungible tokens specific to the CALT datastructure should be minted.

The determined number of fungible tokens specific to the CALT datastructure may be minted for the transaction requestor (e.g., the user) at 245. For example, ERC-20, ERC-1155, and/or the like tokens may be minted. In one embodiment, minting the fungible tokens specific to the CALT datastructure may comprise transferring the determined number of fungible tokens specific to the CALT datastructure (e.g., newly minted tokens, tokens from a fixed supply) to a blockchain address of the user. In one implementation, the decentralized exchange liquidity provision transaction may be parsed (e.g., using Solidity commands) to determine the blockchain address of the user (e.g., based on the value of the to_address field).

Crypto assets balances for the CALT datastructure may be updated at 249. In one embodiment, the crypto assets balances for the CALT datastructure may be updated to reflect the newly contributed units of crypto_asset_A and/or units of crypto_asset_B. In one implementation, internal variables of the CALT datastructure may be updated to reflect the updated crypto assets balances. For example, a variable of the CALT datastructure that tracks the number of crypto assets crypto_asset_A may be increased by 200 units, and a variable of the CALT datastructure that tracks the number of crypto assets crypto_asset_B may be increased by 100 units.

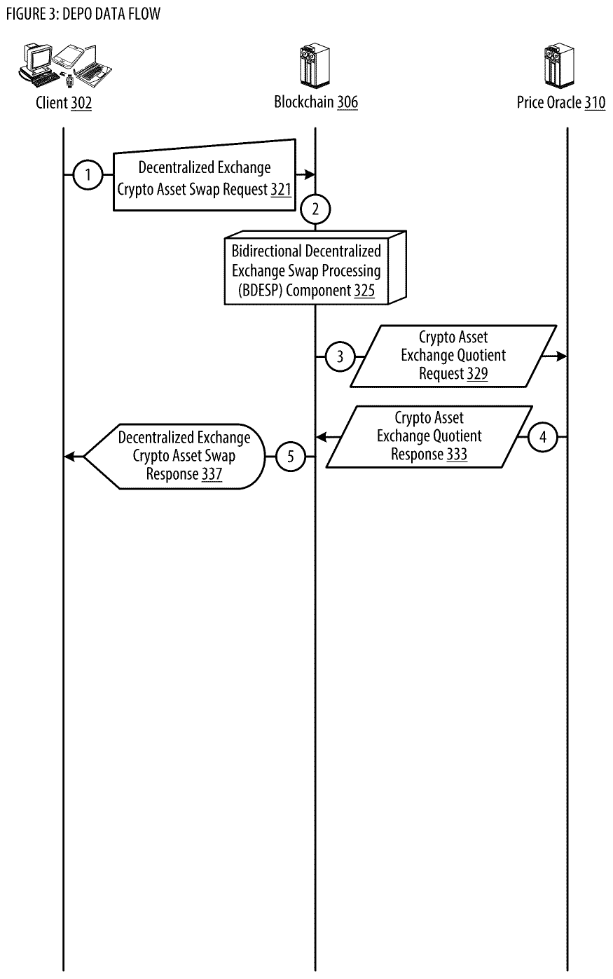

FIG. 3 shows non-limiting, example embodiments of a datagraph illustrating data flow(s) for the DEPO. In FIG. 3, a client 302 (e.g., of a user (e.g., a liquidity taker)) may send a decentralized exchange crypto asset swap request 321 to a bidirectional decentralized exchange smart contract deployed on a blockchain (e.g., Ethereum, Solana) 306 to swap one type of crypto assets (e.g., user provided crypto assets crypto_asset_A) for another type of crypto assets (e.g., user desired crypto assets crypto_asset_B). For example, the client may be a desktop, a laptop, a tablet, a smartphone, a smartwatch, and/or the like that is executing a client application. It is to be understood that, in various implementations, the client may send the decentralized exchange liquidity provision request directly to the blockchain or via an intermediary server (e.g., providing a cryptographic wallet service to the user). In one implementation, the decentralized exchange crypto asset swap request may include data such as a request identifier, a smart contract address, function call details, and/or the like. In one embodiment, the client may provide the following example decentralized exchange crypto asset swap request, substantially in the form of a HTTP(S) POST message including XML-formatted data, as provided below:

```
POST /decentralized_exchange_crypto_asset_swap_request.php HTTP/1.1
Host: www.server.com
Content-Type: Application/XML
Content-Length: 667
<?XML version = “1.0” encoding = “UTF-8”?>
<decentralized_exchange_crypto_asset_swap_request>
  <request_identifier>ID_request_11</request_identifier>
  <smart_contract_address>
    address of the bidirectional decentralized exchange smart contract
  </smart_contract_address>
  <function_call_details>
    <function_name>swap</function_name>
    <crypto_asset_types>
      crypto_asset_A, crypto_asset_B
    </crypto_asset_types>
    <provided_crypto_assets>
      <crypto_asset_type>crypto_asset_A</crypto_asset_type>
      <maximum_amount_to_spend>120 units</maximum_amount_to_spend>
    </provided_crypto_assets>
    <desired_crypto_assets>
      <crypto_asset_type>crypto_asset_B</crypto_asset_type>
      <amount>50 units</amount>
    </desired_crypto_assets>
    <to_address>
      blockchain address associated with the user to which to transfer
      desired crypto assets
    </to_address>
    <transaction_signature>
      signature of the user
    </transaction_signature>
  </function_call_details>
</decentralized_exchange_crypto_asset_swap_request>
```

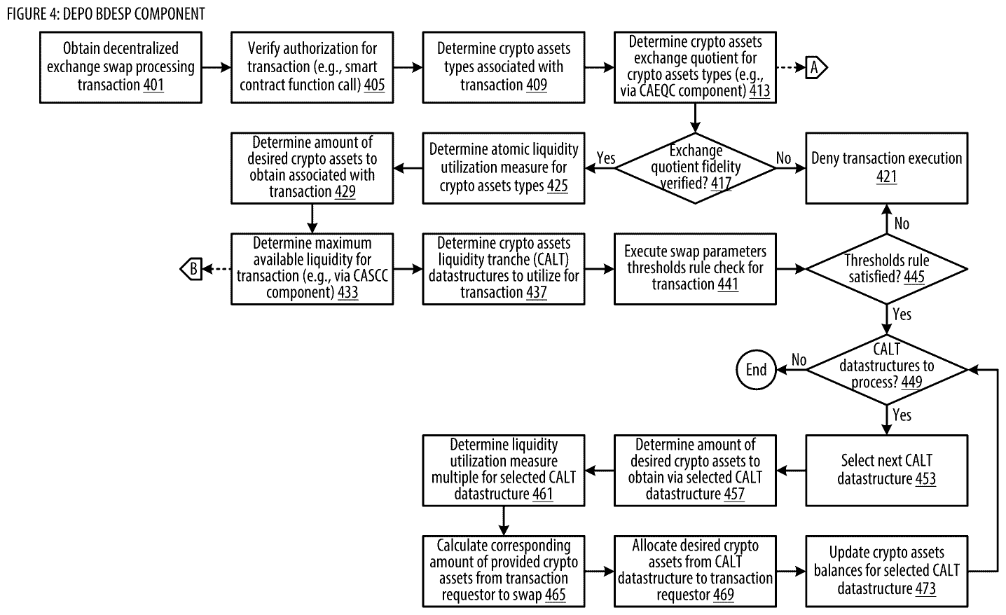

A bidirectional decentralized exchange swap processing (BDESP) component 325 (e.g., implemented via the bidirectional decentralized exchange smart contract) may utilize data provided in the decentralized exchange crypto asset swap request to facilitate swapping of crypto assets. See FIG. 4 for additional details regarding the BDESP component.

The bidirectional decentralized exchange smart contract deployed on the blockchain 306 may send a crypto asset exchange quotient request 329 to a price oracle 310 (e.g., an on-chain price oracle such as Pyth) to determine a crypto assets exchange quotient (e.g., price for exchanging crypto asset A to crypto asset B) for crypto asset types associated with the decentralized exchange crypto asset swap request. In one implementation, the crypto asset exchange quotient request may include data such as a request identifier, a from crypto asset type, a to crypto asset type, and/or the like. In one embodiment, the bidirectional decentralized exchange smart contract deployed on the blockchain may provide the following example crypto asset exchange quotient request, substantially in the form of a HTTP(S) POST message including XML-formatted data, as provided below:

```
POST /crypto_asset_exchange_quotient_request.php HTTP/1.1
Host: www.server.com
Content-Type: Application/XML
Content-Length: 667
<?XML version = “1.0” encoding = “UTF-8”?>
<crypto_asset_exchange_quotient_request>
  <request_identifier>ID_request_12</request_identifier>
  <from_crypto_asset_type>crypto_asset_A</from_crypto_asset_type>
  <to_crypto_asset_type>crypto_asset_B</to_crypto_asset_type>
</crypto_asset_exchange_quotient_request>
```

The price oracle 310 may send a crypto asset exchange quotient response 333 to the bidirectional decentralized exchange smart contract deployed on the blockchain 306 with the requested crypto assets exchange quotient data. In one implementation, the crypto asset exchange quotient response may include data such as a response identifier, the requested crypto assets exchange quotient data, and/or the like. In one embodiment, the price oracle may provide the following example crypto asset exchange quotient response, substantially in the form of a HTTP(S) POST message including XML-formatted data, as provided below:

```
POST /crypto_asset_exchange_quotient_response.php HTTP/1.1
Host: www.server.com
Content-Type: Application/XML
Content-Length: 667
<?XML version = “1.0” encoding = “UTF-8”?>
<crypto_asset_exchange_quotient_response>
  <response_identifier>ID_response_12</response_identifier>
  <crypto_assets_exchange_quotient_data>
    <crypto_assets_exchange_quotient>2</crypto_assets_exchange_quotient>
    <confidence_interval>0.01 at 95% confidence level</confidence_interval>
    <timestamp>2024-01-01 12:20:01</timestamp>
  </crypto_assets_exchange_quotient_data>
</crypto_asset_exchange_quotient_response>
```

The bidirectional decentralized exchange smart contract deployed on the blockchain 306 may send a decentralized exchange crypto asset swap response 337 to the client 302 to inform the user whether the decentralized exchange crypto asset swap request was processed successfully. In one implementation, the decentralized exchange crypto asset swap response may include data such as a response identifier, a status, and/or the like. In one embodiment, the bidirectional decentralized exchange smart contract deployed on the blockchain may provide the following example decentralized exchange crypto asset swap response, substantially in the form of a HTTP(S) POST message including XML-formatted data, as provided below:

```
POST /decentralized_exchange_crypto_asset_swap_response.php
HTTP/1.1
Host: www.server.com
Content-Type: Application/XML
Content-Length: 667
<?XML version = “1.0” encoding = “UTF-8”?>
<decentralized_exchange_crypto_asset_swap_response>
  <response_identifier>ID_response_11</response_identifier>
  <status>OK</status>
</decentralized_exchange_crypto_asset_swap_response>
```

FIG. 4 shows non-limiting, example embodiments of a logic flow illustrating a bidirectional decentralized exchange swap processing (BDESP) component for the DEPO. In FIG. 4, a decentralized exchange swap processing transaction may be obtained at 401. For example, the decentralized exchange swap processing transaction may be obtained as a result of a function call to a function (e.g., swap) implemented by a bidirectional decentralized exchange smart contract from a user (e.g., a liquidity taker) to swap one type of crypto assets (e.g., user provided crypto assets crypto_asset_A) for another type of crypto assets (e.g., user desired crypto assets crypto_asset_B).

Authorization for the decentralized exchange swap processing transaction (e.g., smart contract function call) may be verified at 405. In one embodiment, verification may be performed to ensure that the decentralized exchange swap processing transaction was submitted by an authorized entity (e.g., the user). In one implementation, authorization for the decentralized exchange swap processing transaction may be verified via Solidity commands (e.g., via a require ( ) statement) that implement access control (e.g., ownable access control, role-based access control) for the functions implemented by the bidirectional decentralized exchange smart contract.

Crypto assets types associated with the decentralized exchange swap processing transaction may be determined at 409. In one implementation, the bidirectional decentralized exchange smart contract may be structured as specifying the (e.g., two) crypto asset types that may be swapped via the bidirectional decentralized exchange smart contract (e.g., crypto asset types crypto_asset_A and crypto_asset_B). In another implementation, the decentralized exchange swap processing transaction may be parsed (e.g., using Solidity commands) to determine the associated crypto asset types (e.g., based on the value of the crypto_asset_types field).

A crypto assets exchange quotient for the associated crypto assets types may be determined at 413. For example, a crypto assets exchange quotient of 2 would indicate that 2 units of crypto assets crypto_asset_A would be exchanged for 1 unit of crypto assets crypto_asset_B (e.g., via a liquidity tranche datastructure utilizing an atomic liquidity utilization measure multiple of 0 (e.g., no additional spread or fee)). In one implementation, a price oracle may be queried (e.g., via a crypto asset exchange quotient request) to determine the crypto assets exchange quotient for the associated crypto assets types. In another implementation, the crypto assets exchange quotient for the associated crypto assets types may be determined via the CAEQC component.

A determination may be made at 417 whether exchange quotient fidelity associated with the crypto assets exchange quotient may be verified. In one implementation, the price oracle may specify a confidence measure associated with the crypto assets exchange quotient (e.g., 0.01 confidence interval at 95% confidence level), and the exchange quotient fidelity is verified if the confidence measure satisfies a confidence measure threshold rule (e.g., the confidence interval is not excessively large (e.g., less than 3%) against the crypto assets exchange quotient (e.g., the price value)). In another implementation, the CAEQC component may specify whether the exchange quotient fidelity is verified.

If the exchange quotient fidelity associated with the crypto assets exchange quotient is not verified, transaction execution may be denied at 421. In one implementation, a message indicating that execution of the decentralized exchange swap processing transaction was denied may be generated (e.g., via emitting an event).

If the exchange quotient fidelity associated with the crypto assets exchange quotient is verified, an atomic liquidity utilization measure for the associated crypto assets types may be determined at 425. In various implementations, the atomic liquidity utilization measure may be determined in a variety of ways as discussed with regard to FIG. 2 at 225. For example, an internal variable of the bidirectional decentralized exchange smart contract may be queried to determine the atomic liquidity utilization measure for the associated crypto assets types.

An amount of user desired crypto assets units to obtain associated with the decentralized exchange swap processing transaction may be determined at 429. In one embodiment, the user may specify the type and/or the number of units of desired crypto assets to obtain (e.g., and a maximum amount of provided crypto assets units to spend on obtaining the desired crypto assets units). In an alternative embodiment, the user may specify the type and/or the number of units of provided crypto assets (e.g., to obtain as many desired crypto assets units as possible using the provided crypto assets units). In one implementation, the decentralized exchange swap processing transaction may be parsed (e.g., using Solidity commands) to determine the type and/or the number of units of crypto assets to obtain (e.g., based on the value of the desired_crypto_assets field). For example, the user may desire to obtain 50 units of crypto assets crypto_asset_B.

Maximum available liquidity for the decentralized exchange swap processing transaction may be determined at 433. In one embodiment, the bidirectional decentralized exchange smart contract may specify a maximum amount (e.g., for each crypto assets type) that liquidity takers may obtain via each CALT datastructure during a time period (e.g., within the current block, within a set of recent blocks). Accordingly, the decentralized exchange swap processing transaction (e.g., for a large order) may be processed via multiple CALT datastructures depending on the maximum available liquidity of each CALT datastructure for the decentralized exchange swap processing transaction. In one implementation, the maximum available liquidity for the decentralized exchange swap processing transaction may be determined via the CASCC component. For example, the CASCC component may specify which CALT datastructures to utilize (e.g., ID_liquidity_tranche_datastructure_0 and ID_liquidity_tranche_datastructure_1) and/or how many units of desired crypto assets to obtain from each utilized CALT datastructure (e.g., 30 units of crypto assets crypto_asset_B from ID_liquidity_tranche_datastructure_0, and 20 units of crypto assets crypto_asset_B from ID_liquidity_tranche_datastructure_1).

CALT datastructures to utilize for the decentralized exchange swap processing transaction may be determined at 437. In one implementation, the CALT datastructures to utilize for the decentralized exchange swap processing transaction may be determined via the CASCC component. For example, the CASCC component may specify that the decentralized exchange swap processing transaction should utilize CALT datastructures with identifiers ID_liquidity_tranche_datastructure_0 (e.g., corresponding to tranche 0) and ID_liquidity_tranche_datastructure_1 (e.g., corresponding to tranche 1).

A swap parameters thresholds rule check for the decentralized exchange swap processing transaction may be executed at 441. In one embodiment, the swap parameters thresholds rule check may be performed to ensure that the determined crypto assets exchange quotient, CALT datastructures to utilize, fees, and/or the like determined values satisfy swap parameters thresholds specified by the user. In one implementation, the determined values may be checked to verify compliance with the swap parameters thresholds. For example, the swap parameters thresholds specified by the user may indicate whether to utilize imbalance reducing quantities (e.g., to swap up to quantities that reduce imbalance), the worst crypto assets exchange quotient that the decentralized exchange swap processing transaction is allowed to utilize, the worst tranche that the decentralized exchange swap processing transaction is allowed to utilize, whether the decentralized exchange swap processing transaction is allowed to incur a transaction fee, and/or the like.

In one embodiment, the decentralized exchange swap processing transaction may increase CALT datastructure imbalance. In one implementation, a CALT datastructure is considered balanced when the value locked in crypto assets crypto_asset_A equals to value locked in crypto assets crypto_asset_B (Q_{A}=Q_{B}P_{AB}). A balanced CALT datastructure may provide maximum liquidity to liquidity takers for either direction of a swap. If a liquidity taker swaps crypto assets crypto_asset_A to crypto assets crypto_asset_B, the swap may cause additional imbalance if Q_{A}≥Q_{B}P_{AB}. Analogously, if a liquidity taker swaps crypto assets crypto_asset_B to crypto assets crypto_asset_A, the swap may cause additional imbalance if Q_{A}≤Q_{B}P_{AB}. In some implementations, a transaction fee may be incurred by liquidity takers where a swap increases CALT datastructure imbalance.

In another embodiment, the decentralized exchange swap processing transaction may reduce CALT datastructure imbalance. A liquidity taker can create a swap transaction that reduces CALT datastructure imbalance. In this case, the action of liquidity taker may increase the efficiency of subsequent transactions. Such liquidity taking swap transaction may also be viewed as a liquidity provider adding liquidity to a liquidity pool, and subsequently removing liquidity from the liquidity pool within the same block so that imbalance is reduced. Hence, in some implementations, a swap transaction that reduces imbalance may incur no transaction fee or a reduced transaction fee. It is possible that given a liquidity pool with a starting imbalance of Q_{A}≥Q_{B}P_{AB}, a swap transaction from token B to token A can be done so that the end liquidity pool changes direction of imbalance to Q_{A}≤Q_{B}P_{AB}. In this case, this single swap transaction may be considered to be composed of two swap transactions, one reducing imbalance, and then one increasing imbalance. Here, in some implementations, the portion of a swap transaction that increases imbalance may incur a transaction fee. In some implementations, a liquidity taker may submit a swap transaction with specific instructions to constraint execution of the swap transaction to reduce imbalance and avoid a transaction fee.

A determination may be made at 445 whether the swap parameters thresholds rule was satisfied. If the swap parameters thresholds rule check was not satisfied, transaction execution may be denied at 421.

If the swap parameters thresholds rule check was satisfied, a determination may be made at 449 whether there remain CALT datastructures to process. In one implementation, each of the CALT datastructures to utilize for the decentralized exchange swap processing transaction may be processed. If there remain CALT datastructures to process, the next CALT datastructure to utilize may be selected for processing at 453.

An amount of user desired crypto assets units to obtain via the selected CALT datastructure may be determined at 457. In one implementation, the number of user desired crypto assets units to obtain via the selected CALT datastructure may be determined via the CASCC component. For example, the CASCC component may specify that the decentralized exchange swap processing transaction should obtain 30 units of crypto assets crypto_asset_B via the CALT datastructure with identifier ID_liquidity_tranche_datastructure_0, and 20 units of crypto assets crypto_asset_B via the CALT datastructure with identifier ID_liquidity_tranche_datastructure_1.

An atomic liquidity utilization measure multiple for the selected CALT datastructure may be determined at 461. In one implementation, an internal variable of the selected CALT datastructure may be queried to determine the atomic liquidity utilization measure multiple for the selected CALT datastructure. For example, the CALT datastructure with identifier ID_liquidity_tranche_datastructure_0 (e.g., corresponding to tranche 0) may utilize an atomic liquidity utilization measure multiple of 0, and the CALT datastructure with identifier ID_liquidity_tranche_datastructure_1 (e.g., corresponding to tranche 1) may utilize an atomic liquidity utilization measure multiple of 1.

A corresponding amount of provided crypto assets from the transaction requestor to swap for the determined amount of user desired crypto assets units to obtain via the selected CALT datastructure may be calculated at 465. In one implementation, the corresponding amount of provided crypto assets may be determined via a calculation as discussed with regard to FIG. 2 at 225. For example, the corresponding amount of provided crypto assets from the transaction requestor to swap may be calculated as follows:

Price for one A to B=P_{AB}+S_{AB} (atomic liquidity utilization measure multiple)
For tranche 0:
atomic liquidity utilization measure multiple=0
# of A= # of B*(2+S_{AB}*0)
# of A=30*(2+0.1*0)
# of A=60
   For tranche 1:
atomic liquidity utilization measure multiple=1
# of A= # of B*(2+S_{AB}*1)
# of A=20*(2+0.1*1)
# of A=42
Accordingly, 60 units of crypto assets crypto_asset_A for the CALT datastructure with identifier ID_liquidity_tranche_datastructure_0, and 42 units of crypto assets crypto_asset_A for the CALT datastructure with identifier ID_liquidity_tranche_datastructure_1 may be calculated as the corresponding amounts during the two iterations of the loop for a total of 102 units (e.g., out of a maximum of 120 units specified by the user).

The user desired crypto assets units to obtain may be allocated to the transaction requestor (e.g., the user) at 469. In one implementation, the bidirectional decentralized exchange smart contract may transfer (e.g., via a Solidity transfer ( ) function) the user desired crypto assets units to obtain from the selected CALT datastructure (e.g., 30 units of crypto assets crypto_asset_B from CALT the datastructure with identifier ID_liquidity_tranche_datastructure_0, 20 units of crypto assets crypto_asset_B from the CALT datastructure with identifier ID_liquidity_tranche_datastructure_1) to a blockchain address of the user. In one implementation, the decentralized exchange swap processing transaction may be parsed (e.g., using Solidity commands) to determine the blockchain address of the user (e.g., based on the value of the to_address field).

Crypto assets balances for the selected CALT datastructure may be updated at 473. In one embodiment, the crypto assets balances for the selected CALT datastructure may be updated to reflect the new balances of crypto assets crypto_asset_A and/or of crypto assets crypto_asset_B. In one implementation, internal variables of the selected CALT datastructure may be updated to reflect the updated crypto assets balances. For example, a variable of the selected CALT datastructure that tracks the number of crypto assets crypto_asset_A may be increased by 60 units, and a variable of the CALT datastructure that tracks the number of crypto assets crypto_asset_B may be decreased by 30 units for the CALT datastructure with identifier ID_liquidity_tranche_datastructure_0. In another example, a variable of the selected CALT datastructure that tracks the number of crypto assets crypto_asset_A may be increased by 42 units, and a variable of the CALT datastructure that tracks the number of crypto assets crypto_asset_B may be decreased by 20 units for the CALT datastructure with identifier ID_liquidity_tranche_datastructure_1.

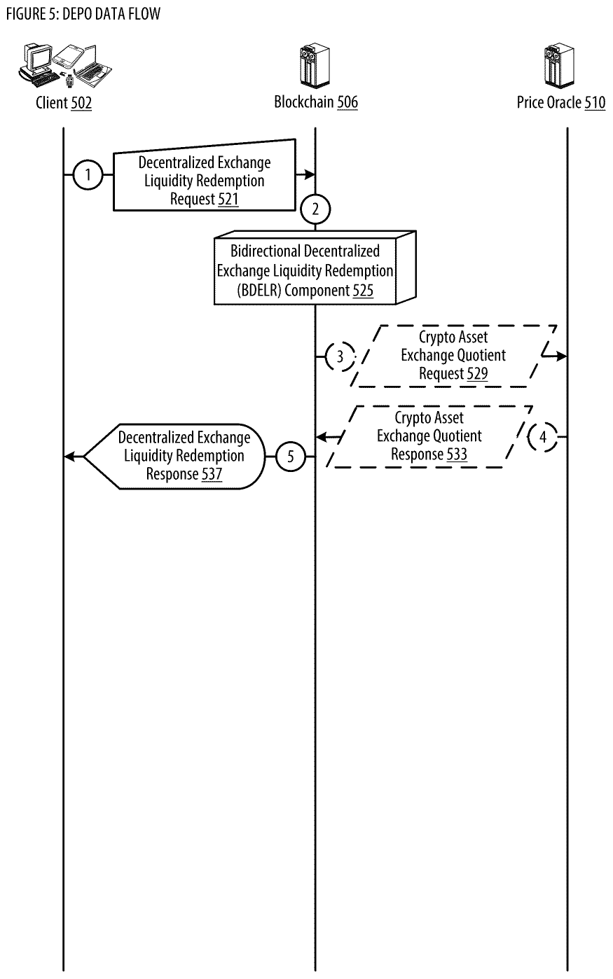

FIG. 5 shows non-limiting, example embodiments of a datagraph illustrating data flow(s) for the DEPO. In FIG. 5, dashed lines indicate data flow elements that may be more likely to be optional. In FIG. 5, a client 502 (e.g., of a user (e.g., a liquidity provider)) may send a decentralized exchange liquidity redemption request 521 to a bidirectional decentralized exchange smart contract deployed on a blockchain (e.g., Ethereum, Solana) 506 to redeem fungible tokens specific to a CALT datastructure for crypto assets (e.g., crypto assets crypto_asset_A and/or crypto assets crypto_asset_B). For example, the client may be a desktop, a laptop, a tablet, a smartphone, a smartwatch, and/or the like that is executing a client application. It is to be understood that, in various implementations, the client may send the decentralized exchange liquidity redemption request directly to the blockchain or via an intermediary server (e.g., providing a cryptographic wallet service to the user). In one implementation, the decentralized exchange liquidity redemption request may include data such as a request identifier, a smart contract address, function call details, and/or the like. In one embodiment, the client may provide the following example decentralized exchange liquidity redemption request, substantially in the form of a HTTP(S) POST message including XML-formatted data, as provided below:

```
POST /decentralized_exchange_liquidity_redemption_request.php HTTP/1.1
Host: www.server.com
Content-Type: Application/XML
Content-Length: 667
<?XML version = “1.0” encoding = “UTF-8”?>
<decentralized_exchange_liquidity_redemption_request>
  <request_identifier>ID_request_21</request_identifier>
  <smart_contract_address>
    address of the bidirectional decentralized exchange smart contract
  </smart_contract_address>
  <function_call_details>
    <function_name>redeem</function_name>
    <crypto_asset_types>
      crypto_asset_A, crypto_asset_B
    </crypto_asset_types>
    <liquidity_tranche_datastructure_identifier>
      ID_liquidity_tranche_datastructure_1
    </liquidity_tranche_datastructure_identifier>
    <amount_of_tokens_to_redeem>400 units</amount_of_tokens_to_redeem>
    <to_address>
      blockchain address associated with the user to which to transfer
      redeemed crypto assets
    </to_address>
    <transaction_signature>
      signature of the user
    </transaction_signature>
  </function_call_details>
</decentralized_exchange_liquidity_redemption_request>
```

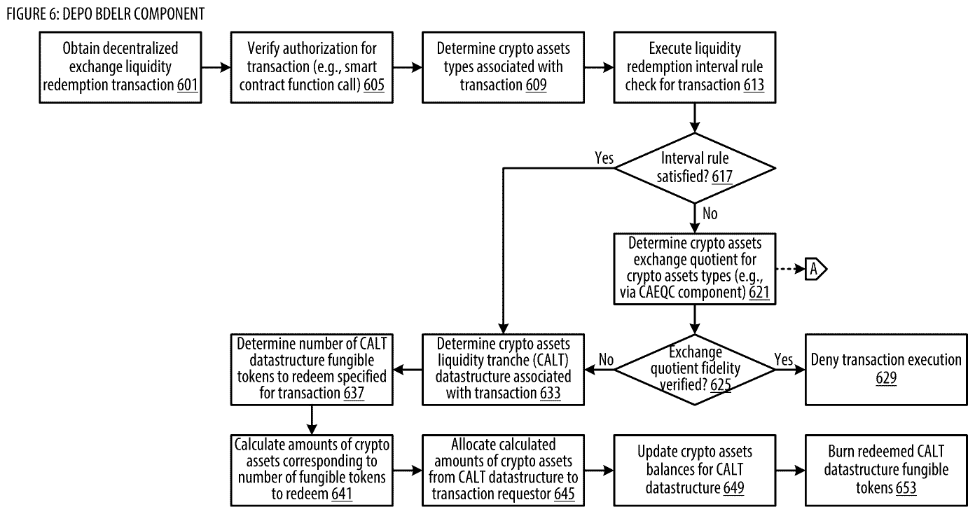

A bidirectional decentralized exchange liquidity redemption (BDELR) component 525 may utilize data provided in the decentralized exchange liquidity redemption request to facilitate liquidity redemption. See FIG. 6 for additional details regarding the BDELR component.

In some embodiments, the bidirectional decentralized exchange smart contract deployed on the blockchain 506 may send a crypto asset exchange quotient request 529 to a price oracle 510 (e.g., an on-chain price oracle such as Pyth) to determine a crypto assets exchange quotient (e.g., price for exchanging crypto asset A to crypto asset B) for crypto asset types associated with the decentralized exchange crypto asset swap request. In one implementation, the crypto asset exchange quotient request may include data such as a request identifier, a from crypto asset type, a to crypto asset type, and/or the like. In one embodiment, the bidirectional decentralized exchange smart contract deployed on the blockchain may provide the following example crypto asset exchange quotient request, substantially in the form of a HTTP(S) POST message including XML-formatted data, as provided below:

```
POST /crypto_asset_exchange_quotient_request.php HTTP/1.1
Host: www.server.com
Content-Type: Application/XML
Content-Length: 667
<?XML version = “1.0” encoding = “UTF-8”?>
<crypto_asset_exchange_quotient_request>
  <request_identifier>ID_request_22</request_identifier>
  <from_crypto_asset_type>crypto_asset_A</from_crypto_asset_type>
  <to_crypto_asset_type>crypto_asset_B</to_crypto_asset_type>
</crypto_asset_exchange_quotient_request>
```

The price oracle 510 may send a crypto asset exchange quotient response 533 to the bidirectional decentralized exchange smart contract deployed on the blockchain 506 with the requested crypto assets exchange quotient data. In one implementation, the crypto asset exchange quotient response may include data such as a response identifier, the requested crypto assets exchange quotient data, and/or the like. In one embodiment, the price oracle may provide the following example crypto asset exchange quotient response, substantially in the form of a HTTP(S) POST message including XML-formatted data, as provided below:

```
POST /crypto_asset_exchange_quotient_response.php HTTP/1.1
Host: www.server.com
Content-Type: Application/XML
Content-Length: 667
<?XML version = “1.0” encoding = “UTF-8”?>
<crypto_asset_exchange_quotient_response>
  <response_identifier>ID_response_22</response_identifier>
  <crypto_assets_exchange_quotient_data>
    <crypto_assets_exchange_quotient>2</crypto_assets_exchange_quotient>
    <confidence_interval>0.01 at 95% confidence level</confidence_interval>
    <timestamp>2024-01-01 12:40:01</timestamp>
  </crypto_assets_exchange_quotient_data>
</crypto_asset_exchange_quotient_response>
```

The bidirectional decentralized exchange smart contract deployed on the blockchain 506 may send a decentralized exchange liquidity redemption response 537 to the client 502 to inform the user whether the decentralized exchange liquidity redemption request was processed successfully. In one implementation, the decentralized exchange liquidity redemption response may include data such as a response identifier, a status, and/or the like. In one embodiment, the bidirectional decentralized exchange smart contract deployed on the blockchain may provide the following example decentralized exchange liquidity redemption response, substantially in the form of a HTTP(S) POST message including XML-formatted data, as provided below:

```
POST /decentralized_exchange_liquidity_redemption_response.php
HTTP/1.1
Host: www.server.com
Content-Type: Application/XML
Content-Length: 667
<?XML version = “1.0” encoding = “UTF-8”?>
<decentralized_exchange_liquidity_redemption_response>
  <response_identifier>ID_response_21</response_identifier>
  <status>OK</status>
</decentralized_exchange_liquidity_redemption_response>
```

FIG. 6 shows non-limiting, example embodiments of a logic flow illustrating a bidirectional decentralized exchange liquidity redemption (BDELR) component for the DEPO. In FIG. 6, a decentralized exchange liquidity redemption transaction may be obtained at 601. For example, the decentralized exchange liquidity redemption transaction may be obtained as a result of a function call to a function (e.g., redeem) implemented by a bidirectional decentralized exchange smart contract from a user (e.g., a liquidity provider) to redeem fungible tokens specific to a CALT datastructure for crypto assets (e.g., crypto assets crypto_asset_A and/or crypto assets crypto_asset_B).

Authorization for the decentralized exchange liquidity redemption transaction (e.g., smart contract function call) may be verified at 605. In one embodiment, verification may be performed to ensure that the decentralized exchange liquidity redemption transaction was submitted by an authorized entity (e.g., the user). In one implementation, authorization for the decentralized exchange liquidity redemption transaction may be verified via Solidity commands (e.g., via a require ( ) statement) that implement access control (e.g., ownable access control, role-based access control) for the functions implemented by the bidirectional decentralized exchange smart contract.

Crypto assets types associated with the decentralized exchange liquidity redemption transaction may be determined at 609. In one implementation, the bidirectional decentralized exchange smart contract may be structured as specifying the (e.g., two) crypto asset types that may be swapped via the bidirectional decentralized exchange smart contract (e.g., crypto asset types crypto_asset_A and crypto_asset_B). In another implementation, the decentralized exchange liquidity provision transaction may be parsed (e.g., using Solidity commands) to determine the associated crypto asset types (e.g., based on the value of the crypto_asset_types field).

A liquidity redemption interval rule check for the decentralized exchange liquidity redemption transaction may be executed at 613. In one embodiment, to ensure stability of liquidity available via the bidirectional decentralized exchange smart contract, the DEPO allows liquidity redemption at epoch ending time. In one implementation, the bidirectional decentralized exchange smart contract may utilize the following parameters:
Epoch Interval: Amount of time in an Epoch
Epoch Offset: Starting reference of Epoch
Redemption Interval: Amount of time redemption is allowed before the end of an epoch

For example, epoch interval may be set to 24 hours, with offset at 5 pm, and redemption interval at 15 hours. This means that allowed redemption time is between 5 pm and Sam every day (e.g., when transactions volume may be low).

In another example, epoch interval may be set to 1 hour, with offset at 9 am, and redemption interval at 5 minutes. In this case, allowed redemption time is the last 5 minutes of every hour.

As another example, epoch interval may be set to 7 days, with offset on Friday at 5 pm, and redemption interval at 63 hours. Here, allowed redemption time is between Friday at 5 pm and following Monday at 8 am.

In one implementation, the liquidity redemption interval rule check may be performed by verifying that a timestamp associated with the decentralized exchange liquidity redemption transaction is within the allowed redemption time. In some implementations, liquidity redemption may also be permitted (e.g., outside the allowed redemption time) when oracle price for the associated crypto asset types is deemed inaccurate or unavailable. It is to be understood that, in some implementations, liquidity provision may be done at any time and is not restricted by the allowed redemption time.

A determination may be made at 617 whether the liquidity redemption interval rule was satisfied. If the liquidity redemption interval rule check was not satisfied, a crypto assets exchange quotient for the associated crypto assets types may be determined at 621. For example, a crypto assets exchange quotient of 2 would indicate that 2 units of crypto assets crypto_asset_A would be exchanged for 1 unit of crypto assets crypto_asset_B (e.g., via a liquidity tranche datastructure utilizing an atomic liquidity utilization measure multiple of 0 (e.g., no additional spread or fee)). In one implementation, a price oracle may be queried (e.g., via a crypto asset exchange quotient request) to determine the crypto assets exchange quotient for the associated crypto assets types. In another implementation, the crypto assets exchange quotient for the associated crypto assets types may be determined via the CAEQC component.

A determination may be made at 625 whether exchange quotient fidelity associated with the crypto assets exchange quotient may be verified. In one implementation, the price oracle may specify a confidence measure associated with the crypto assets exchange quotient (e.g., 0.01 confidence interval at 95% confidence level), and the exchange quotient fidelity is verified if the confidence measure satisfies a confidence measure threshold rule (e.g., the confidence interval is not excessively large (e.g., less than 3%) against the crypto assets exchange quotient (e.g., the price value)). In another implementation, the CAEQC component may specify whether the exchange quotient fidelity is verified.

If the exchange quotient fidelity associated with the crypto assets exchange quotient is verified, transaction execution may be denied at 629. In one implementation, a message indicating that execution of the decentralized exchange liquidity redemption transaction was denied may be generated (e.g., via emitting an event).

If the liquidity redemption interval rule check was satisfied or if the exchange quotient fidelity associated with the crypto assets exchange quotient is not verified, a CALT datastructure associated with the decentralized exchange liquidity redemption transaction may be determined at 633. In one implementation, the decentralized exchange liquidity redemption transaction may be parsed (e.g., using Solidity commands) to determine the CALT datastructure associated with the decentralized exchange liquidity redemption transaction (e.g., based on the value of the liquidity_tranche_datastructure_identifier field). For example, a CALT datastructure with identifier ID_liquidity_tranche_datastructure_1 (e.g., corresponding to tranche 1) may be specified for the decentralized exchange liquidity redemption transaction.

The number of CALT datastructure fungible tokens to redeem specified for the decentralized exchange liquidity redemption transaction may be determined at 637. In one implementation, the decentralized exchange liquidity redemption transaction may be parsed (e.g., using Solidity commands) to determine the number of fungible tokens specific to the CALT datastructure associated with the decentralized exchange liquidity redemption transaction (e.g., based on the value of the amount_of_tokens_to_redeem field). For example, the user may desire to redeem 400 units of fungible tokens specific to the CALT datastructure with identifier ID_liquidity_tranche_datastructure_1.

Amounts of crypto assets corresponding to the determined number of CALT datastructure fungible tokens to redeem may be calculated at 641. In one embodiment, the liquidity provider may redeem locked crypto assets (e.g., crypto assets crypto_asset_A and/or crypto assets crypto_asset_B) from a CALT datastructure by burning the corresponding fungible token specific to the CALT datastructure. In one implementation, given L existing CALT datastructure tokens, and Q_{A} and Q_{B} locked in crypto assets in the CALT datastructure, a redemption of R CALT datastructure fungible tokens would receive RQ_{A}/L tokens of crypto assets crypto_asset_A, and RQ_{B}/L tokens of crypto assets crypto_asset_B. In one embodiment, if the liquidity provider wishes to obtain a different proportion of crypto assets, the liquidity provider may combine the decentralized exchange liquidity redemption transaction with an imbalance reducing liquidity taking transaction. For example, the calculation may indicate that the user should receive 242 units of crypto assets crypto_asset_A and 80 units of crypto assets crypto_asset_B.

The calculated amounts of crypto assets may be allocated from the CALT datastructure associated with the decentralized exchange liquidity redemption transaction to the transaction requestor (e.g., the user) at 645. In one implementation, the bidirectional decentralized exchange smart contract may transfer (e.g., via a Solidity transfer ( ) function) the calculated amounts of crypto assets (e.g., 242 units of crypto assets crypto_asset_A and 80 units of crypto assets crypto_asset_B) from the CALT datastructure associated with the decentralized exchange liquidity redemption transaction (the CALT datastructure with identifier ID_liquidity_tranche_datastructure_1) to a blockchain address of the user. In one implementation, the decentralized exchange liquidity redemption transaction may be parsed (e.g., using Solidity commands) to determine the blockchain address of the user (e.g., based on the value of the to_address field).

Crypto assets balances for the CALT datastructure associated with the decentralized exchange liquidity redemption transaction may be updated at 649. In one embodiment, the crypto assets balances for the CALT datastructure may be updated to reflect the redemption of units of crypto_asset_A and/or of units of crypto_asset_B. In one implementation, internal variables of the CALT datastructure may be updated to reflect the updated crypto assets balances. For example, a variable of the CALT datastructure that tracks the number of crypto assets crypto_asset_A may be decreased by 242 units, and a variable of the CALT datastructure that tracks the number of crypto assets crypto_asset_B may be decreased by 80 units.

The redeemed CALT datastructure fungible tokens may be burned at 653. In one embodiment, burning the redeemed fungible tokens specific to the CALT datastructure associated with the decentralized exchange liquidity redemption transaction may comprise removing these tokens from circulation (e.g., destroying the redeemed tokens, returning the redeemed tokens to a fixed supply).

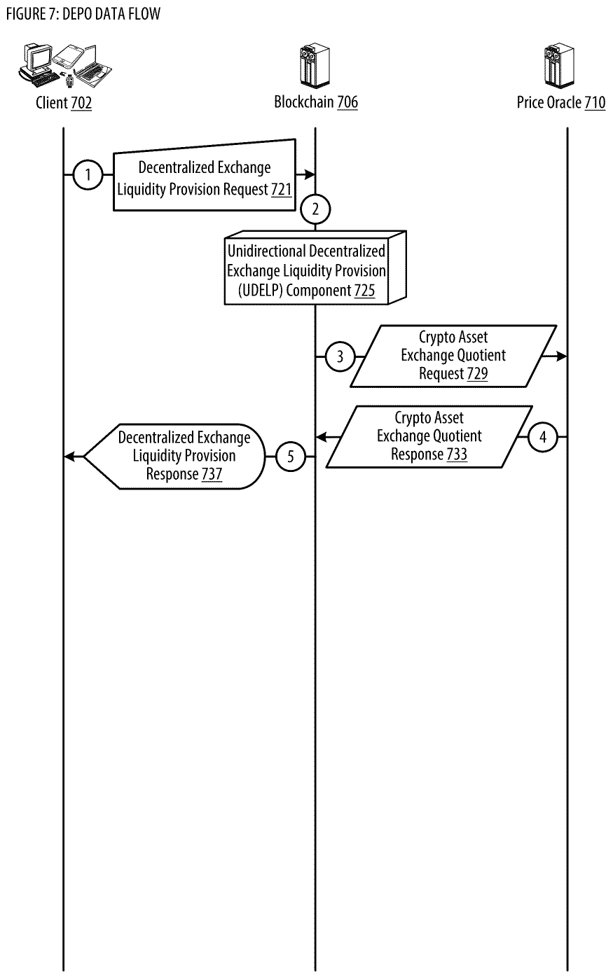

FIG. 7 shows non-limiting, example embodiments of a datagraph illustrating data flow(s) for the DEPO. In FIG. 7, a client 702 (e.g., of a user) may send a decentralized exchange liquidity provision request 721 to a unidirectional decentralized exchange smart contract deployed on a blockchain (e.g., Ethereum, Solana) 706 to provide liquidity for a decentralized exchange by contributing source crypto assets (e.g., crypto assets crypto_asset_A) to be exchanged for target crypto assets (e.g., crypto assets crypto_asset_B) at a specified limit crypto assets exchange quotient. For example, the client may be a desktop, a laptop, a tablet, a smartphone, a smartwatch, and/or the like that is executing a client application. It is to be understood that, in various implementations, the client may send the decentralized exchange liquidity provision request directly to the blockchain or via an intermediary server (e.g., providing a cryptographic wallet service to the user). In one implementation, the decentralized exchange liquidity provision request may include data such as a request identifier, a smart contract address, function call details, and/or the like. In one embodiment, the client may provide the following example decentralized exchange liquidity provision request, substantially in the form of a HTTP(S) POST message including XML-formatted data, as provided below:

```
POST /decentralized_exchange_liquidity_provision_request.php HTTP/1.1
Host: www.server.com
Content-Type: Application/XML
Content-Length: 667
<?XML version = “1.0” encoding = “UTF-8”?>
<decentralized_exchange_liquidity_provision_request>
  <request_identifier>ID_request_31</request_identifier>
  <smart_contract_address>
    address of the unidirectional decentralized exchange smart contract
  </smart_contract_address>
  <function_call_details>
    <function_name>provide</function_name>
    <crypto_asset_types>
      <source_crypto_asset_type>crypto_asset_A</source_crypto_asset_type>
      <target_crypto_asset_type>crypto_asset_B</target_crypto_asset_type>
    </crypto_asset_types>
    <liquidity_tranche_datastructure_identifier>
      ID_liquidity_tranche_datastructure_0
    </liquidity_tranche_datastructure_identifier>
    <contribution>
      <crypto_asset_type>crypto_asset_A</crypto_asset_type>
      <amount>231 units</amount>
      <limit_crypto_assets_exchange_quotient>
        2.1
      </limit_crypto_assets_exchange_quotient>
    </contribution>
    <contact>URI of API to alert the user on NFT event</contact>
    <to_address>
      blockchain address associated with the user with which to
      associate an NFT
    </to_address>
    <transaction_signature>
      signature of the user
    </transaction_signature>
  </function_call_details>
</decentralized_exchange_liquidity_provision_request>
```

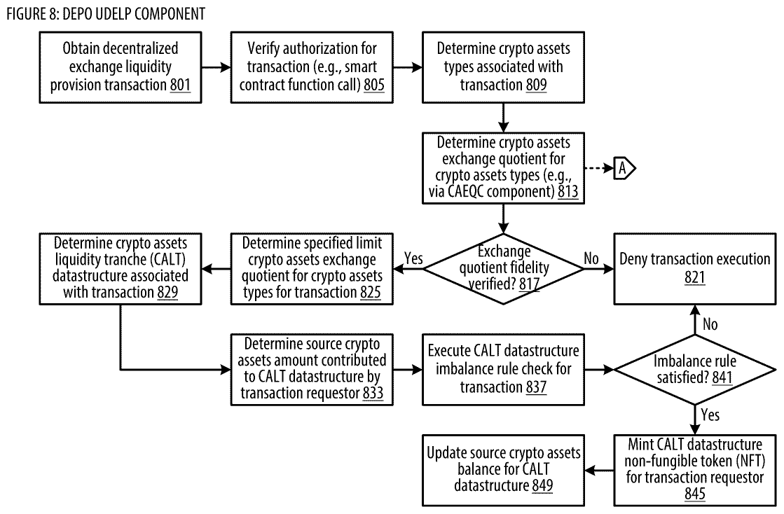

A unidirectional decentralized exchange liquidity provision (UDELP) component 725 (e.g., implemented via the unidirectional decentralized exchange smart contract) may utilize data provided in the decentralized exchange liquidity provision request to facilitate liquidity provision for the decentralized exchange. See FIG. 8 for additional details regarding the UDELP component.

The unidirectional decentralized exchange smart contract deployed on the blockchain 706 may send a crypto asset exchange quotient request 729 to a price oracle 710 (e.g., an on-chain price oracle such as Pyth) to determine a crypto assets exchange quotient (e.g., price for exchanging crypto asset A to crypto asset B) for crypto asset types associated with the decentralized exchange liquidity provision request. In one implementation, the crypto asset exchange quotient request may include data such as a request identifier, a from crypto asset type, a to crypto asset type, and/or the like. In one embodiment, the unidirectional decentralized exchange smart contract deployed on the blockchain may provide the following example crypto asset exchange quotient request, substantially in the form of a HTTP(S) POST message including XML-formatted data, as provided below:

```
POST /crypto_asset_exchange_quotient_request.php HTTP/1.1
Host: www.server.com
Content-Type: Application/XML
Content-Length: 667
<?XML version = “1.0” encoding = “UTF-8”?>
<crypto_asset_exchange_quotient_request>
  <request_identifier>ID_request_32</request_identifier>
  <from_crypto_asset_type>crypto_asset_A</from_crypto_asset_type>
  <to_crypto_asset_type>crypto_asset_B</to_crypto_asset_type>
</crypto_asset_exchange_quotient_request>
```

The price oracle 710 may send a crypto asset exchange quotient response 733 to the unidirectional decentralized exchange smart contract deployed on the blockchain 706 with the requested crypto assets exchange quotient data. In one implementation, the crypto asset exchange quotient response may include data such as a response identifier, the requested crypto assets exchange quotient data, and/or the like. In one embodiment, the price oracle may provide the following example crypto asset exchange quotient response, substantially in the form of a HTTP(S) POST message including XML-formatted data, as provided below:

```
POST /crypto_asset_exchange_quotient_response.php HTTP/1.1
Host: www.server.com
Content-Type: Application/XML
Content-Length: 667
<?XML version = “1.0” encoding = “UTF-8”?>
<crypto_asset_exchange_quotient_response>
  <response_identifier>ID_response_32</response_identifier>
    <crypto_assets_exchange_quotient>2.2</crypto_assets_exchange_quotient>
    <confidence_interval>0.01 at 95% confidence level</confidence_interval>
    <timestamp>2024-01-02 12:00:01</timestamp>
</crypto_asset_exchange_quotient_response>
```

The unidirectional decentralized exchange smart contract deployed on the blockchain 706 may send (e.g., via emitting an event) a decentralized exchange liquidity provision response 737 to the client 702 to inform the user whether the decentralized exchange liquidity provision request was processed successfully. In one implementation, the decentralized exchange liquidity provision response may include data such as a response identifier, a status, and/or the like. In one embodiment, the unidirectional decentralized exchange smart contract deployed on the blockchain may provide the following example decentralized exchange liquidity provision response, substantially in the form of a HTTP(S) POST message including XML-formatted data, as provided below:

```
POST /decentralized_exchange_liquidity_provision_response.php
HTTP/1.1
Host: www.server.com
Content-Type: Application/XML
Content-Length: 667
<?XML version = “1.0” encoding = “UTF-8”?>
<decentralized_exchange_liquidity_provision_response>
  <response_identifier>ID_response_31</response_identifier>
  <status>OK</status>
</decentralized_exchange_liquidity_provision_response>
```

FIG. 8 shows non-limiting, example embodiments of a logic flow illustrating a unidirectional decentralized exchange liquidity provision (UDELP) component for the DEPO. In FIG. 8, a decentralized exchange liquidity provision transaction may be obtained at 801. For example, the decentralized exchange liquidity provision transaction may be obtained as a result of a function call to a function (e.g., provide) implemented by a unidirectional decentralized exchange smart contract from a user (e.g., a liquidity provider) to provide liquidity for a decentralized exchange by contributing source crypto assets to be exchanged for target crypto assets at a specified limit crypto assets exchange quotient.

In some embodiments, instead of providing liquidity for either swap direction, the liquidity provider may wish to provide liquidity for a swap from a source crypto asset type (e.g., crypto asset type crypto_asset_A) to a target crypto asset type (e.g., crypto asset type crypto_asset_B), but not in the reverse direction. In some embodiments, the liquidity provider may wish to specify a limit crypto assets exchange quotient (e.g., a limit price) at which liquidity (e.g., the source crypto assets) may be provided. Accordingly, the liquidity provider may utilize the unidirectional decentralized exchange smart contract. It is to be understood that, in some implementations, the unidirectional decentralized exchange smart contract may be an extension of the bidirectional decentralized exchange smart contract providing additional features (e.g., implementing utilization of unidirectional liquidity (e.g., including limit crypto assets exchange quotient specification) in addition to implementing utilization of bidirectional liquidity).

Authorization for the decentralized exchange liquidity provision transaction (e.g., smart contract function call) may be verified at 805. In one embodiment, verification may be performed to ensure that the decentralized exchange liquidity provision transaction was submitted by an authorized entity (e.g., the user). In one implementation, authorization for the decentralized exchange liquidity provision transaction may be verified via Solidity commands (e.g., via a require ( ) statement) that implement access control (e.g., ownable access control, role-based access control) for the functions implemented by the unidirectional decentralized exchange smart contract.

Crypto assets types associated with the decentralized exchange liquidity provision transaction may be determined at 809. In one implementation, the unidirectional decentralized exchange smart contract may be structured as specifying the (e.g., two) crypto asset types that may be swapped via the unidirectional decentralized exchange smart contract (e.g., crypto asset types crypto_asset_A and crypto_asset_B). In another implementation, the decentralized exchange liquidity provision transaction may be parsed (e.g., using Solidity commands) to determine the associated crypto asset types (e.g., based on the value of the crypto_asset_types field).

A crypto assets exchange quotient for the associated crypto assets types may be determined at 813. For example, a crypto assets exchange quotient of 2.2 would indicate that 2.2 units of crypto assets crypto_asset_A would be exchanged for 1 unit of crypto assets crypto_asset_B (e.g., 231 units of crypto assets crypto_asset_A would be exchanged for 105 units of crypto assets crypto_asset_B). In one implementation, a price oracle may be queried (e.g., via a crypto asset exchange quotient request) to determine the crypto assets exchange quotient for the associated crypto assets types. In another implementation, the crypto assets exchange quotient for the associated crypto assets types may be determined via the CAEQC component.

A determination may be made at 817 whether exchange quotient fidelity associated with the crypto assets exchange quotient may be verified. In one implementation, the price oracle may specify a confidence measure associated with the crypto assets exchange quotient (e.g., 0.01 confidence interval at 95% confidence level), and the exchange quotient fidelity is verified if the confidence measure satisfies a confidence measure threshold rule (e.g., the confidence interval is not excessively large (e.g., less than 3%) against the crypto assets exchange quotient (e.g., the price value)). In another implementation, the CAEQC component may specify whether the exchange quotient fidelity is verified.

If the exchange quotient fidelity associated with the crypto assets exchange quotient is not verified, transaction execution may be denied at 821. In one implementation, a message indicating that execution of the decentralized exchange liquidity provision transaction was denied may be generated (e.g., via emitting an event).

If the exchange quotient fidelity associated with the crypto assets exchange quotient is verified, a specified limit crypto assets exchange quotient for the associated crypto assets types for the decentralized exchange liquidity provision transaction may be determined at 825. In one implementation, the decentralized exchange liquidity provision transaction may be parsed (e.g., using Solidity commands) to determine the specified limit crypto assets exchange quotient (e.g., based on the value of the limit_crypto_assets_exchange_quotient field). For example, the specified limit crypto assets exchange quotient may be 2.1 indicating that the user is willing to provide 2.1 units of crypto assets crypto_asset_A to obtain 1 unit of crypto assets crypto_asset_B (e.g., 231 units of crypto assets crypto_asset_A would be exchanged for 110 units of crypto assets crypto_asset_B).

A CALT datastructure associated with the decentralized exchange liquidity provision transaction may be determined at 829. In one embodiment, a liquidity pool comprising multiple CALT datastructures each corresponding to a different liquidity tranche may be utilized by the DEPO. In one implementation, NFTs may be issued by the DEPO to keep track of unidirectional liquidity (e.g., a limit order corresponding to the decentralized exchange liquidity provision transaction) in different liquidity tranches.

In one implementation, the decentralized exchange liquidity provision transaction may be parsed (e.g., using Solidity commands) to determine the CALT datastructure associated with the decentralized exchange liquidity provision transaction (e.g., based on the value of the liquidity_tranche_datastructure_identifier field). For example, a CALT datastructure with identifier ID_liquidity_tranche_datastructure_0 (e.g., corresponding to tranche 0) may utilize an atomic liquidity utilization measure multiple of 0.

Amount of source crypto assets contributed to the CALT datastructure by the transaction requestor (e.g., the user) may be determined at 833. In one embodiment, the user may contribute a source crypto asset type that may be utilized to provide liquidity via the decentralized exchange. For example, the user may contribute source crypto assets crypto_asset_A. In one implementation, the decentralized exchange liquidity provision transaction may be parsed (e.g., using Solidity commands) to determine the type and/or amount of crypto assets contributed to the CALT datastructure by the user (e.g., based on the value of the contribution field). For example, the user may contribute 231 units of crypto_asset_A.

An imbalance rule check for the CALT datastructure for the decentralized exchange liquidity provision transaction may be executed at 837. In one embodiment, the imbalance rule check may be performed to ensure that the additional source crypto assets contribution associated with the decentralized exchange liquidity provision transaction does not create additional imbalance for the CALT datastructure. In one implementation, the imbalance rule may be checked as discussed with regard to FIG. 2 at 233.

A determination may be made at 841 whether the imbalance rule was satisfied. If the imbalance rule check was not satisfied, transaction execution may be denied at 821.

If the imbalance rule check was satisfied, an NFT specific to the CALT datastructure may be minted for the transaction requestor (e.g., the user) at 845. For example, ERC-721, ERC-1155, and/or the like NFT may be minted. In one implementation, the NFT may comprise NFT metadata (e.g., in JSON format) structured as specifying a set of data fields that describe properties of the NFT similar to the following:
Limit Crypto Assets Exchange Quotient (e.g., Limit Price)
Side: Allow swapping of Source crypto assets to Target crypto assets
Time: Creation Time
Contact: API to alert NFT holders on event (e.g., a URI)
Displayed Liquidity: Non-Encrypted quantity to show amount of Source crypto assets available (e.g., to provide liquidity for the CALT datastructure)
Nonce: A unique one-time use random value for encryption of non-display liquidity. This value may be updated each time the NFT state is updated.

Non-Displayed Liquidity: In some embodiments, the liquidity provider who submits the limit order may not want others to read the total amount of liquidity the liquidity provider provides. Non-Displayed Liquidity may be used to specify encrypted quantity for additional Source crypto assets available (e.g., to obscure the total amount of liquidity). For example, to the public, the non-displayed quantity is encrypted, and one cannot infer the unencrypted quantity by reading the content of the contract. In one implementation, a numerical value to show crypto assets available may be combined with Nonce. In one implementation, zero may be used if there is no non-displayed liquidity. Use of zero may help improve block evaluation time.
Executed Quantity: Number of Target crypto assets custodied in contract (e.g., via the NFT)
Maximum instantaneous swap capacity
Maximum long-term swap capacity
Imbalance reducing only: If set to false, imbalance creating fee may be paid if limit order interacts with liquidity pool
Last Execution Time
Execution Cool Off time: After an execution, number of blocks a limit order would cool off before supplying liquidity again.

In one embodiment, minting the NFT specific to the CALT datastructure for the transaction requestor may comprise associating an NFT identifier (e.g., ID_NFT_1) of the NFT with a blockchain address of the user. In one implementation, the decentralized exchange liquidity provision transaction may be parsed (e.g., using Solidity commands) to determine the blockchain address of the user (e.g., based on the value of the to_address field).

Source crypto assets balance for the CALT datastructure may be updated at 849. In one embodiment, the source crypto assets balance for the CALT datastructure may be updated to reflect the newly contributed units (e.g., of crypto_asset_A). In one implementation, an internal variable of the CALT datastructure may be updated to reflect the updated source crypto assets balance. For example, a variable of the CALT datastructure that tracks the number of crypto assets crypto_asset_A may be increased by 231 units.

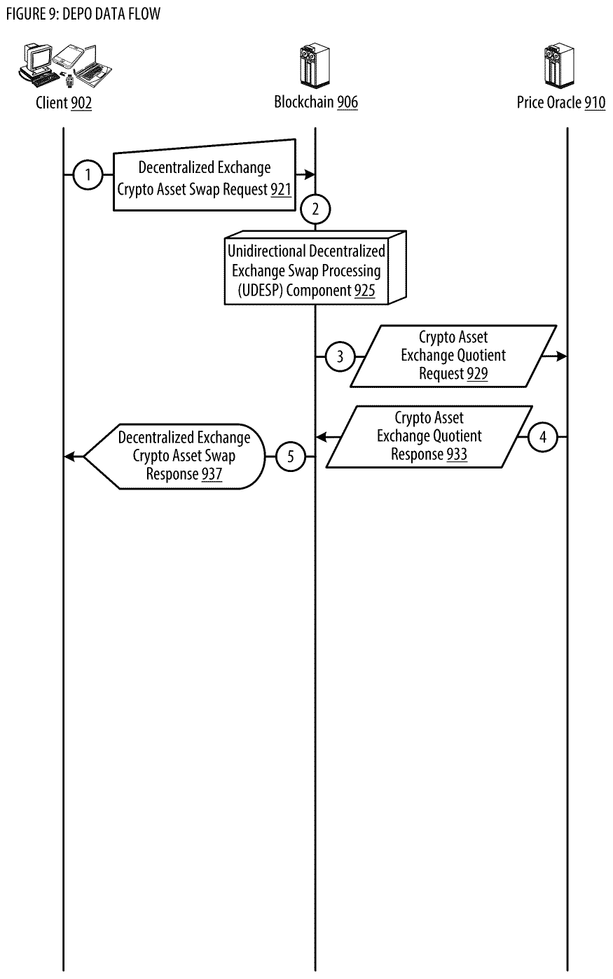

FIG. 9 shows non-limiting, example embodiments of a datagraph illustrating data flow(s) for the DEPO. In FIG. 9, a client 902 (e.g., of a user (e.g., a liquidity taker)) may send a decentralized exchange crypto asset swap request 921 to a unidirectional decentralized exchange smart contract deployed on a blockchain (e.g., Ethereum, Solana) 906 to swap one type of crypto assets (e.g., user provided crypto assets crypto_asset_B) for another type of crypto assets (e.g., user desired crypto assets crypto_asset_A). For example, the client may be a desktop, a laptop, a tablet, a smartphone, a smartwatch, and/or the like that is executing a client application. It is to be understood that, in various implementations, the client may send the decentralized exchange liquidity provision request directly to the blockchain or via an intermediary server (e.g., providing a cryptographic wallet service to the user). In one implementation, the decentralized exchange crypto asset swap request may include data such as a request identifier, a smart contract address, function call details, and/or the like. In one embodiment, the client may provide the following example decentralized exchange crypto asset swap request, substantially in the form of a HTTP(S) POST message including XML-formatted data, as provided below:

```
POST /decentralized_exchange_crypto_asset_swap_request.php
HTTP/1.1
Host: www.server.com
Content-Type: Application/XML
Content-Length: 667
<?XML version = “1.0” encoding = “UTF-8”?>
<decentralized_exchange_crypto_asset_swap_request>
  <request_identifier>ID_request_41</request_identifier>
  <smart_contract_address>
    address of the unidirectional decentralized exchange smart contract
  </smart_contract_address>
  <function_call_details>
    <function_name>swap</function_name>
    <crypto_asset_types>
      crypto_asset_A, crypto_asset_B
    </crypto_asset_types>
    <provided_crypto_assets>
      <crypto_asset_type>crypto_asset_B</crypto_asset_type>
      <maximum_amount_to_spend>12
      units</maximum_amount_to_spend>
    </provided_crypto_assets>
    <desired_crypto_assets>
      <crypto_asset_type>crypto_asset_A</crypto_asset_type>
      <amount>21 units</amount>
    </desired_crypto_assets>
    <to_address>
      blockchain address associated with the user to which to transfer
      desired crypto assets
    </to_address>
    <transaction_signature>
      signature of the user
    </transaction_signature>
  </function_call_details>
</decentralized_exchange_crypto_asset_swap_request>
```

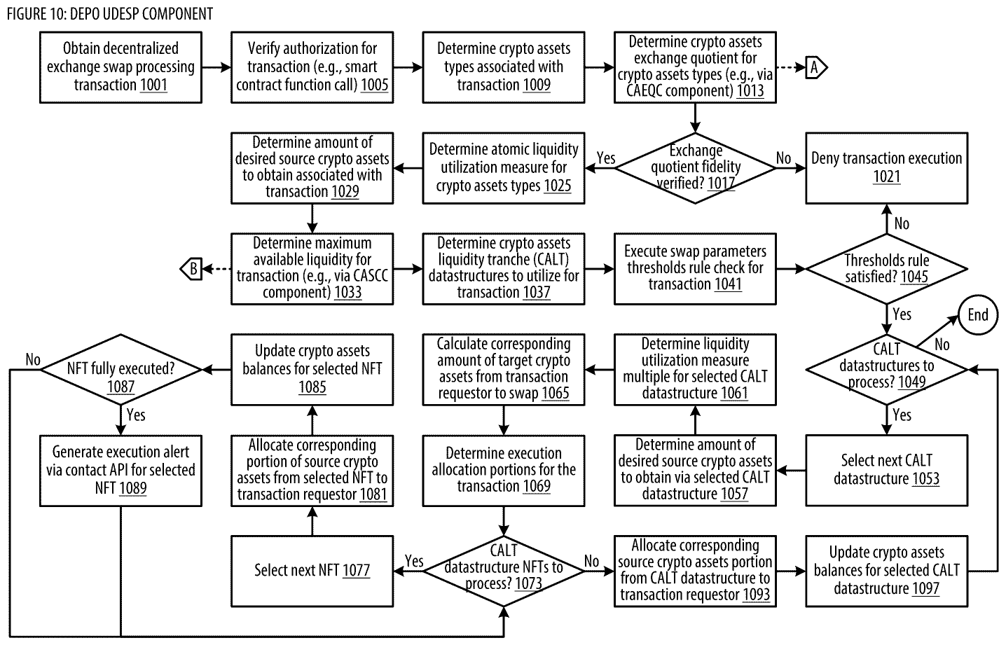

A unidirectional decentralized exchange swap processing (UDESP) component 925 (e.g., implemented via the unidirectional decentralized exchange smart contract) may utilize data provided in the decentralized exchange crypto asset swap request to facilitate swapping of crypto assets. See FIG. 10 for additional details regarding the UDESP component.

The unidirectional decentralized exchange smart contract deployed on the blockchain 906 may send a crypto asset exchange quotient request 929 to a price oracle 910 (e.g., an on-chain price oracle such as Pyth) to determine a crypto assets exchange quotient (e.g., price for exchanging crypto asset A to crypto asset B) for crypto asset types associated with the decentralized exchange crypto asset swap request. In one implementation, the crypto asset exchange quotient request may include data such as a request identifier, a from crypto asset type, a to crypto asset type, and/or the like. In one embodiment, the unidirectional decentralized exchange smart contract deployed on the blockchain may provide the following example crypto asset exchange quotient request, substantially in the form of a HTTP(S) POST message including XML-formatted data, as provided below:

```
POST /crypto_asset_exchange_quotient_request.php HTTP/1.1
Host: www.server.com
Content-Type: Application/XML
Content-Length: 667
<?XML version = “1.0” encoding = “UTF-8”?>
<crypto_asset_exchange_quotient_request>
  <request_identifier>ID_request_42</request_identifier>
  <from_crypto_asset_type>crypto_asset_A</from_crypto_asset_type>
  <to_crypto_asset_type>crypto_asset_B</to_crypto_asset_type>
</crypto_asset_exchange_quotient_request>
```

The price oracle 910 may send a crypto asset exchange quotient response 933 to the unidirectional decentralized exchange smart contract deployed on the blockchain 906 with the requested crypto assets exchange quotient data. In one implementation, the crypto asset exchange quotient response may include data such as a response identifier, the requested crypto assets exchange quotient data, and/or the like. In one embodiment, the price oracle may provide the following example crypto asset exchange quotient response, substantially in the form of a HTTP(S) POST message including XML-formatted data, as provided below:

```
POST /crypto_asset_exchange_quotient_response.php HTTP/1.1
Host: www.server.com
Content-Type: Application/XML
Content-Length: 667
<?XML version = “1.0” encoding = “UTF-8”?>
<crypto_asset_exchange_quotient_response>
  <response_identifier>ID_response_42</response_identifier>
  <crypto_assets_exchange_quotient_data>
    <crypto_assets_exchange_quotient>2.1</crypto_assets_exchange_quotient>
    <confidence_interval>0.01 at 95% confidence level</confidence_interval>
    <timestamp>2024-01-02 12:20:01</timestamp>
  </crypto_assets_exchange_quotient_data>
</crypto_asset_exchange_quotient_response>
```

The unidirectional decentralized exchange smart contract deployed on the blockchain 906 may send a decentralized exchange crypto asset swap response 937 to the client 902 to inform the user whether the decentralized exchange crypto asset swap request was processed successfully. In one implementation, the decentralized exchange crypto asset swap response may include data such as a response identifier, a status, and/or the like. In one embodiment, the unidirectional decentralized exchange smart contract deployed on the blockchain may provide the following example decentralized exchange crypto asset swap response, substantially in the form of a HTTP(S) POST message including XML-formatted data, as provided below:

```
POST /decentralized_exchange_crypto_asset_swap_response.php
HTTP/1.1
Host: www.server.com
Content-Type: Application/XML
Content-Length: 667
<?XML version = “1.0” encoding = “UTF-8”?>
<decentralized_exchange_crypto_asset_swap_response>
  <response_identifier>ID_response_41</response_identifier>
  <status>OK</status>
</decentralized_exchange_crypto_asset_swap_response>
```

FIG. 10 shows non-limiting, example embodiments of a logic flow illustrating a unidirectional decentralized exchange swap processing (UDESP) component for the DEPO. In FIG. 10, a decentralized exchange swap processing transaction may be obtained at 1001. For example, the decentralized exchange swap processing transaction may be obtained as a result of a function call to a function (e.g., swap) implemented by a unidirectional decentralized exchange smart contract from a user (e.g., a liquidity taker) to swap one type of crypto assets (e.g., user provided crypto assets crypto_asset_B) for another type of crypto assets (e.g., user desired crypto assets crypto_asset_A).

Authorization for the decentralized exchange swap processing transaction (e.g., smart contract function call) may be verified at 1005. In one embodiment, verification may be performed to ensure that the decentralized exchange swap processing transaction was submitted by an authorized entity (e.g., the user). In one implementation, authorization for the decentralized exchange swap processing transaction may be verified via Solidity commands (e.g., via a require ( ) statement) that implement access control (e.g., ownable access control, role-based access control) for the functions implemented by the unidirectional decentralized exchange smart contract.

Crypto assets types associated with the decentralized exchange swap processing transaction may be determined at 1009. In one implementation, the unidirectional decentralized exchange smart contract may be structured as specifying the (e.g., two) crypto asset types that may be swapped via the unidirectional decentralized exchange smart contract (e.g., crypto asset types crypto_asset_A and crypto_asset_B). In another implementation, the decentralized exchange swap processing transaction may be parsed (e.g., using Solidity commands) to determine the associated crypto asset types (e.g., based on the value of the crypto_asset_types field).

A crypto assets exchange quotient for the associated crypto assets types may be determined at 1013. For example, a crypto assets exchange quotient of 2.1 would indicate that 2.1 units of crypto assets crypto_asset_A would be exchanged for 1 unit of crypto assets crypto_asset_B (e.g., via a liquidity tranche datastructure utilizing an atomic liquidity utilization measure multiple of 0 (e.g., no additional spread or fee)). In one implementation, a price oracle may be queried (e.g., via a crypto asset exchange quotient request) to determine the crypto assets exchange quotient for the associated crypto assets types. In another implementation, the crypto assets exchange quotient for the associated crypto assets types may be determined via the CAEQC component.

A determination may be made at 1017 whether exchange quotient fidelity associated with the crypto assets exchange quotient may be verified. In one implementation, the price oracle may specify a confidence measure associated with the crypto assets exchange quotient (e.g., 0.01 confidence interval at 95% confidence level), and the exchange quotient fidelity is verified if the confidence measure satisfies a confidence measure threshold rule (e.g., the confidence interval is not excessively large (e.g., less than 3%) against the crypto assets exchange quotient (e.g., the price value)). In another implementation, the CAEQC component may specify whether the exchange quotient fidelity is verified.

If the exchange quotient fidelity associated with the crypto assets exchange quotient is not verified, transaction execution may be denied at 1021. In one implementation, a message indicating that execution of the decentralized exchange swap processing transaction was denied may be generated (e.g., via emitting an event).

If the exchange quotient fidelity associated with the crypto assets exchange quotient is verified, an atomic liquidity utilization measure for the associated crypto assets types may be determined at 1025. In various implementations, the atomic liquidity utilization measure may be determined in a variety of ways as discussed with regard to FIG. 2 at 225. For example, an internal variable of the unidirectional decentralized exchange smart contract may be queried to determine the atomic liquidity utilization measure for the associated crypto assets types.

An amount of user desired crypto assets units to obtain associated with the decentralized exchange swap processing transaction may be determined at 1029. In one embodiment, the user may specify the type and/or the number of units of desired crypto assets to obtain (e.g., and a maximum amount of provided crypto assets units to spend on obtaining the desired crypto assets units). In an alternative embodiment, the user may specify the type and/or the number of units of provided crypto assets (e.g., to obtain as many desired crypto assets units as possible using the provided crypto assets units). In one implementation, the decentralized exchange swap processing transaction may be parsed (e.g., using Solidity commands) to determine the type and/or the number of units of crypto assets to obtain (e.g., based on the value of the desired_crypto_assets field). For example, the user may desire to obtain 21 units of crypto assets crypto_asset_A.

Maximum available liquidity for the decentralized exchange swap processing transaction may be determined at 1033. In one embodiment, the unidirectional decentralized exchange smart contract may specify a maximum amount (e.g., for each crypto assets type) that liquidity takers may obtain via each CALT datastructure during a time period (e.g., within the current block, within a set of recent blocks). Accordingly, the decentralized exchange swap processing transaction (e.g., for a large order) may be processed via multiple CALT datastructures depending on the maximum available liquidity of each CALT datastructure for the decentralized exchange swap processing transaction. In one implementation, the maximum available liquidity for the decentralized exchange swap processing transaction may be determined via the CASCC component. For example, the CASCC component may specify which CALT datastructures to utilize (e.g., ID_liquidity_tranche_datastructure_0) and/or how many units of desired crypto assets to obtain from each utilized CALT datastructure (e.g., 21 units of crypto assets crypto_asset_A from ID_liquidity_tranche_datastructure_0).

CALT datastructures to utilize for the decentralized exchange swap processing transaction may be determined at 1037. In one implementation, the CALT datastructures to utilize for the decentralized exchange swap processing transaction may be determined via the CASCC component. For example, the CASCC component may specify that the decentralized exchange swap processing transaction should utilize CALT datastructure with identifier ID_liquidity_tranche_datastructure_0 (e.g., corresponding to tranche 0).

A swap parameters thresholds rule check for the decentralized exchange swap processing transaction may be executed at 1041. In one embodiment, the swap parameters thresholds rule check may be performed to ensure that the determined crypto assets exchange quotient, CALT datastructures to utilize, fees, and/or the like determined values satisfy swap parameters thresholds specified by the user. In one implementation, the determined values may be checked to verify compliance with the swap parameters thresholds. For example, the swap parameters thresholds specified by the user may indicate whether to utilize imbalance reducing quantities (e.g., to swap up to quantities that reduce imbalance), the worst crypto assets exchange quotient that the decentralized exchange swap processing transaction is allowed to utilize, the worst tranche that the decentralized exchange swap processing transaction is allowed to utilize, whether the decentralized exchange swap processing transaction is allowed to incur a transaction fee (e.g., as discussed with regard to FIG. 4 at 441), and/or the like.

A determination may be made at 1045 whether the swap parameters thresholds rule was satisfied. If the swap parameters thresholds rule check was not satisfied, transaction execution may be denied at 1021.

If the swap parameters thresholds rule check was satisfied, a determination may be made at 1049 whether there remain CALT datastructures to process. In one implementation, each of the CALT datastructures to utilize for the decentralized exchange swap processing transaction may be processed. If there remain CALT datastructures to process, the next CALT datastructure to utilize may be selected for processing at 1053.

An amount of user desired crypto assets units to obtain via the selected CALT datastructure may be determined at 1057. In one implementation, the number of user desired crypto assets units to obtain via the selected CALT datastructure may be determined via the CASCC component. For example, the CASCC component may specify that the decentralized exchange swap processing transaction should obtain 21 units of crypto assets crypto_asset_A via the CALT datastructure with identifier ID_liquidity_tranche_datastructure_0.

An atomic liquidity utilization measure multiple for the selected CALT datastructure may be determined at 1061. In one implementation, an internal variable of the selected CALT datastructure may be queried to determine the atomic liquidity utilization measure multiple for the selected CALT datastructure. For example, the CALT datastructure with identifier ID_liquidity_tranche_datastructure_0 (e.g., corresponding to tranche 0) may utilize an atomic liquidity utilization measure multiple of 0.

A corresponding amount of provided crypto assets from the transaction requestor (e.g., target crypto assets for the liquidity provider who provided unidirectional liquidity (e.g., limit order)) to swap may be calculated at 1065. In one implementation, the corresponding amount of provided crypto assets may be determined via a calculation as discussed with regard to FIG. 2 at 225. For example, the corresponding amount of provided crypto assets from the transaction requestor to swap may be calculated as follows:

Price for one B to A=P_{AB}−S_{AB} (atomic liquidity utilization measure multiple)
For tranche 0:
atomic liquidity utilization measure multiple=0
# of A= # of B*(2.1−S_{AB}*0)
21= # of B*(2.1-0.1*0)
# of B=10
Accordingly, 10 units of crypto assets crypto_asset_B for the CALT datastructure with identifier ID_liquidity_tranche_datastructure_0 may be calculated as the corresponding amount (e.g., out of a maximum of 12 units specified by the user).

Execution allocation portions for the decentralized exchange swap processing transaction may be determined at 1069. For example, different liquidity provisions (e.g., bidiretional and/or unidirectional) may have different execution priorities that determine execution allocation portions. In one embodiment, swap transaction executions that reduce CALT datastructure imbalance for the selected CALT datastructure may have a higher execution priority. Within imbalance reducing swap transaction executions, a variety of possible ways for execution allocation may be utilized. In one implementation, limit orders and imbalance reducing liquidity receives pro-rata execution allocation. In another implementation, non-limit order imbalance reducing liquidity receives execution allocation first. After that, execution allocation goes first to NFT with the oldest last execution time timestamp. In some implementations, non-displayed quantity may have lower priority of execution allocation compared to other limit orders, or liquidity in imbalance-reducing tranche. For example, time priority may be used to allocate swaps to non-displayed liquidity. In some implementations, a limit order (e.g., with a satisfied limit crypto assets exchange quotient) with “Imbalance reducing only” set to true would receive an execution allocation if the resulting swap transaction execution reduces CALT datastructure imbalance for the selected CALT datastructure. For example, an NFT specific to the selected CALT datastructure with NFT identifier ID_NFT_1 may be determined to have an execution allocation portion of 21 units of crypto assets crypto_asset_A (e.g., 100% execution allocation portion).

A determination may be made at 1073 whether there remain NFTs specific to the selected CALT datastructure to process. In one implementation, each of the NFTs specific to the selected CALT datastructure with an execution allocation portion may be processed. If there remain NFTs specific to the selected CALT datastructure to process, the next NFT specific to the selected CALT datastructure may be selected for processing at 1077.

A corresponding execution allocation portion of the user desired crypto assets units to obtain (e.g., source crypto assets for the liquidity provider who provided unidirectional liquidity (e.g., limit order)) may be allocated from the selected NFT specific to the selected CALT datastructure to the transaction requestor (e.g., the user) at 1081. In one implementation, the unidirectional decentralized exchange smart contract may transfer the corresponding execution allocation portion (e.g., 21 units of crypto assets crypto_asset_A) from the selected NFT specific to the selected CALT datastructure to a blockchain address of the user. In one implementation, the decentralized exchange swap processing transaction may be parsed (e.g., using Solidity commands) to determine the blockchain address of the user (e.g., based on the value of the to_address field).

Crypto assets balances for the selected NFT specific to the selected CALT datastructure may be updated at 1085. In one embodiment, the crypto assets balances for the selected NFT specific to the selected CALT datastructure may be updated to reflect the new balances of source crypto assets and/or of target crypto assets. In one implementation, metadata properties of the selected NFT specific to the selected CALT datastructure may be updated to reflect the updated crypto assets balances. For example, Displayed Liquidity and/or Non-Displayed Liquidity fields may be decreased by 21 units of crypto assets crypto_asset_A, and Executed Quantity field may be increased by 10 units of crypto assets crypto_asset_B.

A determination may be made at 1087 whether the selected NFT specific to the selected CALT datastructure is fully executed. In one implementation, an NFT may be considered fully executed if both Displayed Liquidity and Non-Displayed Liquidity are equal to zero. For example, the DEPO may routinely check for this condition (e.g., when crypto assets balances for an NFT are updated).

If the selected NFT specific to the selected CALT datastructure is fully executed, an execution alert may be generated for the selected NFT specific to the selected CALT datastructure via a contact API at 1089. For example, the execution alert may inform the user via the contact API that the selected NFT specific to the selected CALT datastructure is fully executed. In one implementation, metadata properties of the selected NFT specific to the selected CALT datastructure may be parsed (e.g., using Solidity commands) to determine the contact API (e.g., based on the value of the Contact field). For example, the contact API may be a URI to call (e.g., this may be done off-chain). In one embodiment, it is a responsibility of an NFT holder to update the Contact field if an NFT is transferred to a third party.

A corresponding execution allocation portion of the user desired crypto assets units to obtain may be allocated from the selected CALT datastructure (e.g., from non-limit order liquidity) to the transaction requestor (e.g., the user) at 1093. In one implementation, the unidirectional decentralized exchange smart contract may transfer (e.g., via a Solidity transfer ( ) function) the corresponding execution allocation portion from the selected CALT datastructure (e.g., 0 units of crypto assets crypto_asset_A in this example since the NFT with NFT identifier ID_NFT_1 was allocated 100% execution allocation portion) to the blockchain address of the user.

Crypto assets balances for the selected CALT datastructure may be updated at 1097. In one embodiment, the crypto assets balances for the selected CALT datastructure may be updated to reflect the new balances of crypto assets crypto_asset_A and/or of crypto assets crypto_asset_B. In one implementation, internal variables of the selected CALT datastructure may be updated to reflect the updated crypto assets balances. For example, a variable of the selected CALT datastructure that tracks the number of crypto assets crypto_asset_A may be decreased by 21 units (e.g., reflecting the reduction of liquidity provided by the NFT with NFT identifier ID_NFT_1 by 21 units), and a variable of the CALT datastructure that tracks the number of crypto assets crypto_asset_B may be unchanged (e.g., reflecting the unidirectional nature of liquidity provided by the NFT with NFT identifier ID_NFT_1, as the 10 units allocated to the NFT do not provide liquidity).

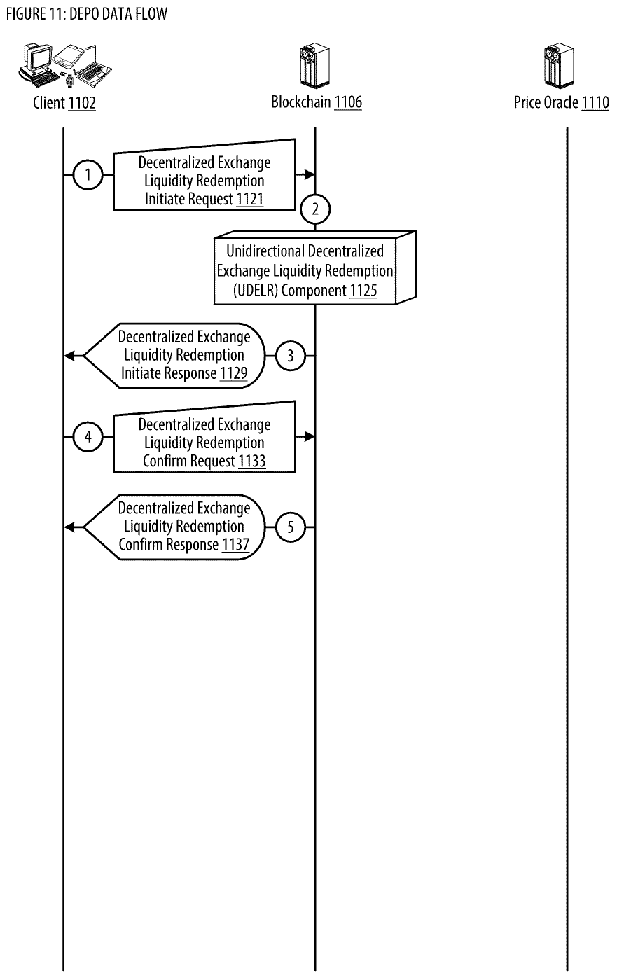

FIG. 11 shows non-limiting, example embodiments of a datagraph illustrating data flow(s) for the DEPO. In FIG. 11, a client 1102 (e.g., of a user (e.g., a liquidity provider)) may send a decentralized exchange liquidity redemption initiate request 1121 to a unidirectional decentralized exchange smart contract deployed on a blockchain (e.g., Ethereum, Solana) 1106 to initiate redemption of an NFT specific to a CALT datastructure for source crypto assets (e.g., crypto assets crypto_asset_A). For example, the client may be a desktop, a laptop, a tablet, a smartphone, a smartwatch, and/or the like that is executing a client application. It is to be understood that, in various implementations, the client may send the decentralized exchange liquidity redemption initiate request directly to the blockchain or via an intermediary server (e.g., providing a cryptographic wallet service to the user). In one implementation, the decentralized exchange liquidity redemption initiate request may include data such as a request identifier, a smart contract address, a timestamp, function call details, and/or the like. In one embodiment, the client may provide the following example decentralized exchange liquidity redemption initiate request, substantially in the form of a HTTP(S) POST message including XML-formatted data, as provided below:

```
POST /decentralized_exchange_liquidity_redemption_initiate_request.php HTTP/1.1
Host: www.server.com
Content-Type: Application/XML
Content-Length: 667
<?XML version = “1.0” encoding = “UTF-8”?>
<decentralized_exchange_liquidity_redemption_initiate_request>
  <request_identifier>ID_request_51</request_identifier>
  <smart_contract_address>
    address of the unidirectional decentralized exchange smart contract
  </smart_contract_address>
  <timestamp>2024-01-02 12:40:01</timestamp>
  <function_call_details>
    <function_name>redeem_initiate</function_name>
    <crypto_asset_types>
      crypto_asset_A, crypto_asset_B
    </crypto_asset_types>
    <liquidity_tranche_datastructure_identifier>
      ID_liquidity_tranche_datastructure_0
    </liquidity_tranche_datastructure_identifier>
    <NFT_identifier>ID_NFT_1</NFT_identifier>
    <redemption>
      <source_crypto_asset_type>crypto_asset_A</source_crypto_asset_type>
      <amount>210 units</amount>
    </redemption>
    <to_address>
      blockchain address associated with the user to which to transfer
      redeemed crypto assets
    </to_address>
    <transaction_signature>
      signature of the user
    </transaction_signature>
  </function_call_details>
</decentralized_exchange_liquidity_redemption_initiate_request>
```

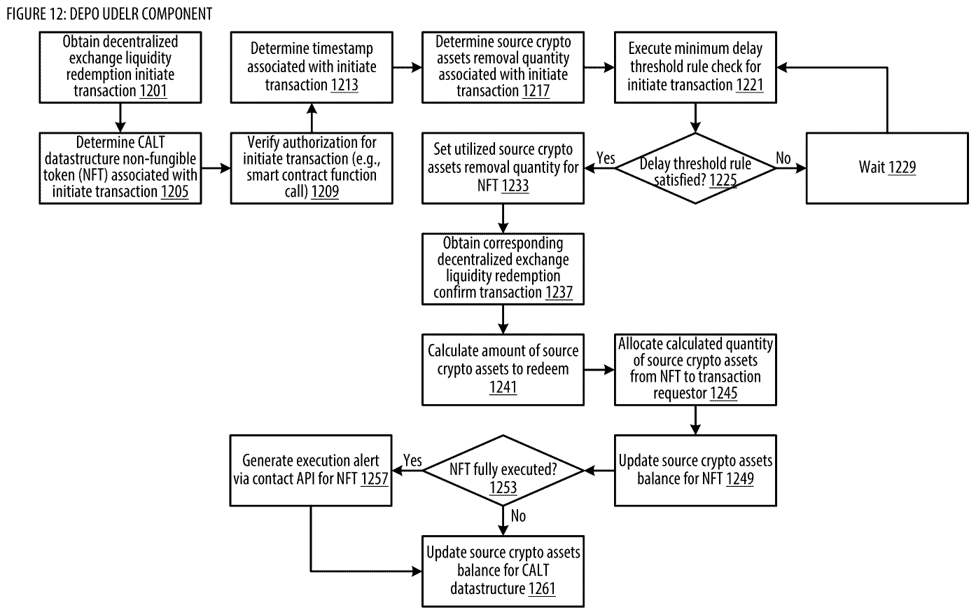

A unidirectional decentralized exchange liquidity redemption (UDELR) component 1125 may utilize data provided in the decentralized exchange liquidity redemption initiate request and/or in a corresponding decentralized exchange liquidity redemption confirm request to facilitate liquidity redemption. See FIG. 12 for additional details regarding the UDELR component.

The unidirectional decentralized exchange smart contract deployed on the blockchain 1106 may send a decentralized exchange liquidity redemption initiate response 1129 to the client 1102 to inform the user whether the decentralized exchange liquidity redemption initiate request was processed successfully. In one implementation, the decentralized exchange liquidity redemption initiate response may include data such as a response identifier, a status, and/or the like. In one embodiment, the unidirectional decentralized exchange smart contract deployed on the blockchain may provide the following example decentralized exchange liquidity redemption initiate response, substantially in the form of a HTTP(S) POST message including XML-formatted data, as provided below:

```
POST
/decentralized_exchange_liquidity_redemption_initiate_response.php
HTTP/1.1
Host: www.server.com
Content-Type: Application/XML
Content-Length: 667
<?XML version = “1.0” encoding = “UTF-8”?>
<decentralized_exchange_liquidity_redemption_initiate_response>
  <response_identifier>ID_response_51</response_identifier>
  <status>OK</status>
</decentralized_exchange_liquidity_redemption_initiate_response>
```

The client 1102 may send a decentralized exchange liquidity redemption confirm request 1133 to the blockchain 1106 to confirm redemption of the NFT specific to the CALT datastructure for source crypto assets. It is to be understood that, in various implementations, the client may send the decentralized exchange liquidity redemption confirm request directly to the blockchain or via an intermediary server (e.g., providing a cryptographic wallet service to the user). In one implementation, the decentralized exchange liquidity redemption confirm request may include data such as a request identifier, a smart contract address, a timestamp, function call details, and/or the like. In one embodiment, the client may provide the following example decentralized exchange liquidity redemption confirm request, substantially in the form of a HTTP(S) POST message including XML-formatted data, as provided below:

```
POST /decentralized_exchange_liquidity_redemption_confirm_request.php HTTP/1.1
Host: www.server.com
Content-Type: Application/XML
Content-Length: 667
<?XML version = “1.0” encoding = “UTF-8”?>
<decentralized_exchange_liquidity_redemption_confirm_request>
  <request_identifier>ID_request_52</request_identifier>
  <smart_contract_address>
    address of the unidirectional decentralized exchange smart contract
  </smart_contract_address>
  <timestamp>2024-01-02 12:45:01</timestamp>
  <function_call_details>
    <function_name>redeem_confirm</function_name>
    <crypto_asset_types>
      crypto_asset_A, crypto_asset_B
    </crypto_asset_types>
    <liquidity_tranche_datastructure_identifier>
      ID_liquidity_tranche_datastructure_0
    </liquidity_tranche_datastructure_identifier>
    <NFT_identifier>ID_NFT_1</NFT_identifier>
    <redemption>
      <source_crypto_asset_type>crypto_asset_A</source_crypto_asset_type>
      <amount>210 units</amount>
    </redemption>
    <to_address>
      blockchain address associated with the user to which to transfer
      redeemed crypto assets
    </to_address>
    <transaction_signature>
      signature of the user
    </transaction_signature>
  </function_call_details>
</decentralized_exchange_liquidity_redemption_confirm_request>
```

The unidirectional decentralized exchange smart contract deployed on the blockchain 1106 may send a decentralized exchange liquidity redemption confirm response 1137 to the client 1102 to inform the user whether the decentralized exchange liquidity redemption confirm request was processed successfully. In one implementation, the decentralized exchange liquidity redemption confirm response may include data such as a response identifier, a status, amount of redeemed source crypto assets, and/or the like. In one embodiment, the unidirectional decentralized exchange smart contract deployed on the blockchain may provide the following example decentralized exchange liquidity redemption confirm response, substantially in the form of a HTTP(S) POST message including XML-formatted data, as provided below:

```
POST /decentralized_exchange_liquidity_redemption_confirm_response.php HTTP/1.1
Host: www.server.com
Content-Type: Application/XML
Content-Length: 667
<?XML version = “1.0” encoding = “UTF-8”?>
<decentralized_exchange_liquidity_redemption_confirm_response>
  <response_identifier>ID_response_52</response_identifier>
  <status>OK</status>
  <redeemed>
    <source_crypto_asset_type>crypto_asset_A</source_crypto_asset_type>
    <amount>210 units</amount>
  </redeemed>
</decentralized_exchange_liquidity_redemption_confirm_response>
```

FIG. 12 shows non-limiting, example embodiments of a logic flow illustrating a unidirectional decentralized exchange liquidity redemption (UDELR) component for the DEPO. In FIG. 12, a decentralized exchange liquidity redemption initiate transaction may be obtained at 1201. For example, the decentralized exchange liquidity redemption initiate transaction may be obtained as a result of a function call to a function (e.g., redeem_initiate) implemented by a unidirectional decentralized exchange smart contract from a user (e.g., a liquidity provider) to initiate redemption of an NFT specific to a CALT datastructure for source crypto assets (e.g., crypto assets crypto_asset_A).

An NFT specific to a CALT datastructure associated with the decentralized exchange liquidity redemption initiate transaction may be determined at 1205. In one implementation, the decentralized exchange liquidity redemption initiate transaction may be parsed (e.g., using Solidity commands) to determine the CALT datastructure associated with the decentralized exchange liquidity redemption initiate transaction (e.g., based on the value of the liquidity_tranche_datastructure_identifier field) and/or to determine the NFT specific to the CALT datastructure associated with the decentralized exchange liquidity redemption initiate transaction (e.g., based on the value of the NFT_identifier field). For example, a CALT datastructure with identifier ID_liquidity_tranche_datastructure_0 and an NFT specific to the CALT datastructure with NFT identifier ID_NFT_1 may be determined.

Authorization for the decentralized exchange liquidity redemption initiate transaction (e.g., smart contract function call) may be verified at 1209. In one embodiment, verification may be performed to ensure that the decentralized exchange liquidity redemption initiate transaction was submitted by an authorized entity (e.g., the user). In one implementation, authorization for the decentralized exchange liquidity redemption initiate transaction may be verified via Solidity commands (e.g., via a require ( ) statement) that implement access control (e.g., ownable access control, role-based access control) for the functions implemented by the unidirectional decentralized exchange smart contract.

A timestamp associated with the decentralized exchange liquidity redemption initiate transaction may be determined at 1213. In one implementation, the decentralized exchange liquidity redemption initiate transaction may be parsed (e.g., using Solidity commands) to determine the timestamp associated with the decentralized exchange liquidity redemption initiate transaction (e.g., based on the value of the timestamp field). In another implementation, current time (e.g., when the decentralized exchange liquidity redemption initiate transaction is received) may be utilized as the timestamp associated with the decentralized exchange liquidity redemption initiate transaction.

A source crypto assets removal quantity associated with the decentralized exchange liquidity redemption initiate transaction may be determined at 1217. For example, the user may choose to redeem source crypto assets associated with the NFT specific to the CALT datastructure in whole or in part. In one implementation, the decentralized exchange liquidity redemption initiate transaction may be parsed (e.g., using Solidity commands) to determine the source crypto assets removal quantity associated with the decentralized exchange liquidity redemption initiate transaction (e.g., based on the value of the redemption field). For example, the user may wish to redeem 210 units of crypto assets crypto_asset_A. It is to be understood that the user may choose to redeem displayed liquidity and/or non-displayed liquidity.

A minimum delay threshold rule check for the decentralized exchange liquidity redemption initiate transaction may be executed at 1221. In one embodiment, the risk of adverse selection may lead a liquidity provider to redeem an NFT just prior to a large liquidity event. Such high-speed cancel action may be harmful to DEPO operation and/or harmful to liquidity takers. In a blockchain, a liquidity provider may read transactions that liquidity takers place in the queue, prior to block creation by validators. If that liquidity provider detects that liquidity takers are willing to pay a higher price for a swap, that liquidity provider may create a cancel transaction and pay higher gas fee to jump the queue.

In one embodiment, the DEPO protects against high-speed cancel by implementing a delayed liquidity removal feature on NFT redemption. In one implementation, the unidirectional decentralized exchange smart contract may utilize the following parameters:
Removal Request Time: Timestamp when the unidirectional decentralized exchange smart contract accepts the liquidity removal request
Displayed Removal Quantity: Amount of displayed liquidity to be removed
Non-Displayed Removal Quantity: Amount of non-displayed liquidity to be removed. This may be encrypted.

When the unidirectional decentralized exchange smart contract receives a liquidity redemption initiate transaction, it updates the Removal Request Time to current time, and sets Displayed Removal Quantity and Non-Displayed Removal Quantity. When these quantities are set, an NFT is in pending redemption status. For example, the parameters may be updated as follows:
Set Displayed Removal Quantity←max (0, new displayed removal quantity in latest liquidity redemption initiate transaction)
Set Non-Displayed Removal Quantity←max (0, new non-displayed removal quantity in latest liquidity redemption initiate transaction)
Set Removal Request Time←current time

In one implementation, the DEPO may set a minimum delay period (e.g., 5 minutes) during which an NFT remains in pending redemption status before liquidity is removed and no longer available for liquidity takers. While processing liquidity taking transactions (e.g., swap transactions), Displayed Removal Quantity and Non-Displayed Removal Quantity reduce available liquidity if current time of a liquidity taking transaction is larger than Removal Request Time+minimum delay period. Otherwise, Removal Quantity and Non-Displayed Removal Quantity are omitted, and entire Displayed Liquidity and Non-Displayed Liquidity are available for liquidity taking transactions.

In one implementation, if multiple liquidity redemption initiate transactions are received before the minimum delay period expires, the unidirectional decentralized exchange smart contract may update the parameters (e.g., Removal Request Time, Displayed Removal Quantity, Non-Displayed Removal Quantity) to the latest values, and the previous liquidity redemption initiate transactions may be considered void.

In one implementation, the minimum delay threshold rule check may be performed by verifying that current time is larger than (e.g., after) the timestamp associated with the decentralized exchange liquidity redemption initiate transaction+minimum delay period.

A determination may be made at 1225 whether the minimum delay threshold rule was satisfied. If the minimum delay threshold rule was not satisfied, the DEPO may wait at 1229. In one implementation, the DEPO may wait until current time is larger than (e.g., after) the timestamp associated with the decentralized exchange liquidity redemption initiate transaction+minimum delay period.

If the minimum delay threshold rule was satisfied, utilized source crypto assets removal quantity for the NFT specific to the CALT datastructure may be set at 1233. In one implementation, the unidirectional decentralized exchange smart contract may reduce available liquidity provided by the NFT specific to the CALT datastructure by the source crypto assets removal quantity.

A decentralized exchange liquidity redemption confirm transaction corresponding to the decentralized exchange liquidity redemption initiate transaction may be obtained at 1237. For example, the decentralized exchange liquidity redemption confirm transaction may be obtained as a result of a function call to a function (e.g., redeem_confirm) implemented by a unidirectional decentralized exchange smart contract from the user to confirm redemption of the NFT specific to the CALT datastructure for source crypto assets (e.g., crypto assets crypto_asset_A).

An amount of source crypto assets to redeem may be calculated at 1241. In one embodiment, to redeem liquidity, the liquidity provider may submit a corresponding liquidity redemption confirm transaction after Removal Request Time+minimum delay period. In this second transaction, the unidirectional decentralized exchange smart contract may check the available source crypto assets, and may compare with displayed/non-displayed removal quantities. In one implementation, the amount of source crypto assets to redeem may be calculated as follows:

If current time>Removal Request Time+minimum delay period
Liquidity provider redeems Min (Displayed Liquidity, Displayed Removal Quantity)+Min (Non-Displayed Liquidity, Non-Displayed Removal Quantity) of source crypto assets
Set Displayed Liquidity←max (0, Displayed Liquidity-Displayed Removal Quantity)
Set Non-Displayed Liquidity←max (0, Non-Displayed Liquidity-Non-Displayed Removal Quantity)
If both Displayed Liquidity and Non-Displayed Liquidity are zero, the NFT is fully executed (e.g., burned).

For example, the amount of source crypto assets to redeem may be calculated as 210 units of crypto assets crypto_asset_A (e.g., liquidity was not reduced by liquidity takers during the minimum delay period).

The calculated amount of source crypto assets may be allocated from the NFT specific to the CALT datastructure to the transaction requestor (e.g., the user) at 1245. In one implementation, the unidirectional decentralized exchange smart contract may transfer the calculated amount of source crypto assets (e.g., 210 units of crypto assets crypto_asset_A) from the NFT specific to the selected CALT datastructure (e.g., with NFT identifier ID_NFT_1) to a blockchain address of the user. In one implementation, the decentralized exchange liquidity redemption confirm transaction may be parsed (e.g., using Solidity commands) to determine the blockchain address of the user (e.g., based on the value of the to_address field).

Source crypto assets balance for the NFT specific to the CALT datastructure may be updated at 1249. In one embodiment, the source crypto assets balance for the NFT specific to the CALT datastructure may be updated to reflect the redemption of units of crypto_asset_A. In one implementation, metadata properties of the NFT specific to the CALT datastructure may be updated to reflect the updated source crypto assets balance. For example, Displayed Liquidity and/or Non-Displayed Liquidity fields may be decreased by 210 units of source crypto assets crypto_asset_A.

A determination may be made at 1253 whether the NFT specific to the CALT datastructure is fully executed. In one implementation, an NFT may be considered fully executed if both Displayed Liquidity and Non-Displayed Liquidity are equal to zero. For example, the DEPO may routinely check for this condition (e.g., when crypto assets balances for an NFT are updated).

If the NFT specific to the CALT datastructure is fully executed, an execution alert may be generated for the NFT specific to the CALT datastructure via a contact API at 1257. For example, the execution alert may inform the user via the contact API that the NFT specific to the CALT datastructure is fully executed. In one implementation, metadata properties of the NFT specific to the CALT datastructure may be parsed (e.g., using Solidity commands) to determine the contact API (e.g., based on the value of the Contact field). For example, the contact API may be a URI to call (e.g., this may be done off-chain). In one embodiment, it is a responsibility of an NFT holder to update the Contact field if an NFT is transferred to a third party.

It is to be understood that, in one implementation, target crypto assets associated with the NFT specific to the CALT datastructure (e.g., specified via the Executed Quantity field (e.g., 10 units of crypto assets crypto_asset_B) may be redeemed (e.g., in whole or in part) by the owner of the NFT specific to the CALT datastructure (e.g., the liquidity provider) using the owner's private key that corresponds to the owner blockchain address of the NFT specific to the CALT datastructure (e.g., at any time, such as after receiving an execution alert).

Source crypto assets balance for the CALT datastructure may be updated at 1261. In one embodiment, the source crypto assets balance for the CALT datastructure may be updated to reflect the new balance of source crypto assets crypto_asset_A. In one implementation, internal variables of the CALT datastructure may be updated to reflect the updated source crypto assets balance. For example, a variable of the CALT datastructure that tracks the number of source crypto assets crypto_asset_A may be decreased by 210 units (e.g., reflecting the reduction of liquidity provided by the NFT with NFT identifier ID_NFT_1 by 210 units).

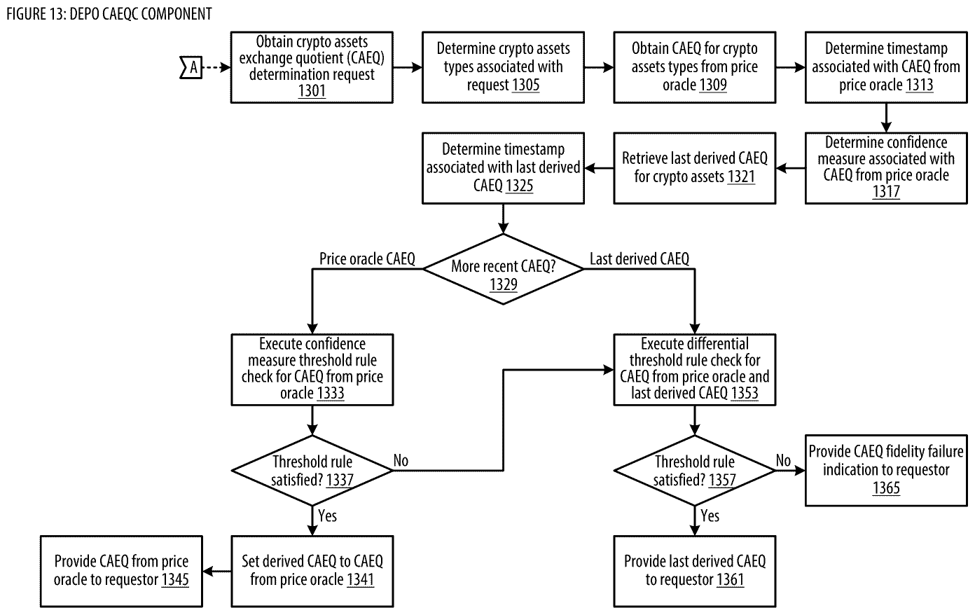

FIG. 13 shows non-limiting, example embodiments of a logic flow illustrating a crypto assets exchange quotient computation (CAEQC) component for the DEPO. In FIG. 13, a crypto assets exchange quotient (CAEQ) determination request may be obtained at 1301. For example, the CAEQ determination request may be obtained as a result of a request (e.g., a function call) from another component (e.g., a requestor) to determine a crypto assets exchange quotient.

Crypto assets types associated with the CAEQ determination request may be determined at 1305. In one implementation, the (e.g., two) crypto asset types associated with the CAEQ determination request may be provided as input parameters to the CAEQC component from the requestor. For example, crypto asset types crypto_asset_A and crypto_asset_B may be specified as input parameters of the function call.

In one embodiment, crypto assets exchange quotient data for the associated crypto assets types may be obtained from a price oracle. In one implementation, the price oracle may be queried (e.g., via a crypto asset exchange quotient request) to obtain the crypto assets exchange quotient data for the associated crypto assets types. In one implementation, the crypto assets exchange quotient data (e.g., obtained via a crypto asset exchange quotient response) may be parsed (e.g., using Solidity commands) to determine a CAEQ for the associated crypto assets types (e.g., based on the value of the crypto_assets_exchange_quotient field) at 1309. In one implementation, the crypto assets exchange quotient data may be parsed (e.g., using Solidity commands) to determine a timestamp associated with the CAEQ for the associated crypto assets types (e.g., based on the value of the timestamp field) at 1313. In one implementation, the crypto assets exchange quotient data may be parsed (e.g., using Solidity commands) to determine a confidence measure associated with the CAEQ for the associated crypto assets types (e.g., based on the value of the confidence_interval field) at 1317.

A last derived CAEQ for the associated crypto assets types may be retrieved at 1321. In one embodiment, a CAEQ from an oracle (e.g., oracle price) may be unreliable or unavailable during certain conditions. For example, when a confidence interval is deemed excessively large against the CAEQ (e.g., the price is volatile), the CAEQ from the oracle may not be accurate. In another example, during exchange closing hours or when an exchange has extremely low liquidity, the CAEQ from the oracle may not be accurate. While, in one embodiment, a decentralize exchange may guard against stale or potentially incorrect CAEQ by forbidding transactions, this may limit the usefulness of the decentralize exchange.

In another embodiment, an implicit CAEQ (e.g., an implicit price) may be computed by considering the mixture of the two crypto assets in a liquidity pool. In one implementation, the oracle price P_{AB} may be modified by effective DEPO protocol derived price (PDP) to be used when the oracle price is deemed inaccurate. In some implementations, the difference between the oracle price and PDP may also determine conditions when the DEPO would forbid transactions to safeguard liquidity providers. In one implementation, a derived CAEQ (e.g., PDP) for the associated crypto assets types may be updated as follows:
1. PDP is initialized to oracle price.
2. After each transaction (e.g., liquidity provision, swap, liquidity redemption), compute an effective midpoint price by the contra value weighting the best available tranche for the two crypto assets types. Consider a case where the best CALT datastructure for crypto assets crypto_asset_A is T_{A} with Q_{A} tokens, and the best CALT datastructure for crypto assets crypto_asset_B is T_{B} with Q_{B} tokens. The effective midpoint may be calculated as follows:

$$M = \frac{{Q}_{A} ( PDP + {T}_{A} {S}_{AB} ) + {Q}_{B} ( PDP - {T}_{B} {S}_{AB} )}{{Q}_{A} + {Q}_{B}}$$

3. After each transaction, compute absolute log imbalance (ALI) of tranche 0 (e.g., corresponding to CALT datastructure with identifier ID_liquidity_tranche_datastructure_0) as follows:

$$ALI = \vert ln \frac{{Q}_{A}}{{Q}_{B} PDP} \vert$$

4. If the ALI is greater than a threshold (e.g., 0.4), the DEPO may deem that tranche 0 has excessive imbalance, and the PDP may be updated to the effective midpoint M. Similarly, if in tranche 0, either Q_{A}=0 or Q_{B}=0, the PDP may be updated to the effective midpoint M. If the ALI is smaller than the threshold, the PDP may be set to the latest oracle price.

In one implementation, the last derived CAEQ (e.g., updated after the last transaction) for the associated crypto assets types may be retrieved from an internal variable of a bidirectional decentralized exchange smart contract or of a unidirectional decentralized exchange smart contract.

A timestamp (e.g., corresponding to the timestamp of the last transaction) associated with the last derived CAEQ for the associated crypto assets types may be determined at 1325. In one implementation, the timestamp associated with the last derived CAEQ for the associated crypto assets types may be retrieved from an internal variable of a bidirectional decentralized exchange smart contract or of a unidirectional decentralized exchange smart contract.

A determination may be made at 1329 whether the timestamp associated with the CAEQ from the price oracle or the timestamp associated with the last derived CAEQ is more recent.

If the timestamp associated with the CAEQ from the price oracle is more recent, a confidence measure threshold rule check for the CAEQ from the price oracle may be executed at 1333. In one embodiment, the confidence measure threshold rule check may be performed to ensure CAEQ fidelity. In one implementation, the confidence measure threshold rule check may be performed by verifying that the confidence measure associated with the CAEQ (e.g., 0.01 confidence interval at 95% confidence level) does not exceed a specified threshold (e.g., less than 3%) against the CAEQ (e.g., 2).

A determination may be made at 1337 whether the confidence measure threshold rule was satisfied. If the confidence measure threshold rule check was satisfied, the last derived CAEQ may be set to the CAEQ from the price oracle at 1341. In one implementation, an internal variable of a bidirectional decentralized exchange smart contract or of a unidirectional decentralized exchange smart contract may be updated to reflect the updated last derived CAEQ. The CAEQ from the price oracle may be provided (e.g., via a function output parameter) to the requestor as the CAEQ for the associated crypto assets types at 1345. In some implementations, CAEQ fidelity confirmation may also be provided.

If the confidence measure threshold rule check was not satisfied or if the timestamp associated with the last derived CAEQ is more recent, a differential threshold rule check for the CAEQ from price oracle and the last derived CAEQ may be executed at 1353. In one embodiment, the differential threshold rule check may be performed to ensure CAEQ fidelity. In one implementation, the differential threshold rule check may be performed by verifying that the absolute log ratio of the most recent CAEQ from the price oracle and the last derived CAEQ does not exceed a specified threshold (e.g., 0.1).

A determination may be made at 1357 whether the confidence measure threshold rule was satisfied. If the confidence measure threshold rule check was satisfied, the last derived CAEQ may be provided (e.g., via a function output parameter) to the requestor as the CAEQ for the associated crypto assets types at 1361. In some implementations, CAEQ fidelity confirmation may also be provided.

If the confidence measure threshold rule check was not satisfied, a CAEQ fidelity failure indication may be provided (e.g., via a function output parameter) to the requestor at 1365. In one embodiment, when the effective midpoint is drastically different from the oracle price, the DEPO may forbid transactions and effectively halt swap activities. During the halt, the DEPO may solicit price update votes from existing liquidity providers to refresh the PDP. To do so, in one implementation, the DEPO opens a voting window with duration determined by DEPO administrators. During the voting window, a liquidity provider submits a proposed price using its liquidity tokens. The DEPO may compute:
Weighted average of proposed price given value of liquidity tokens
Unweighted 40- and 60-percentile of proposed price
Total number of unique voters
Total value of liquidity tokens from voters

In one implementation, a new PDP may be established as a weighted average price if:
Weighted average proposed price is within the unweighted 40- and 60-percentile
Total number of unique voters is greater than a threshold determined by DEPO administrators
Total value of liquidity tokens from voters is above a percentage threshold of token value locked

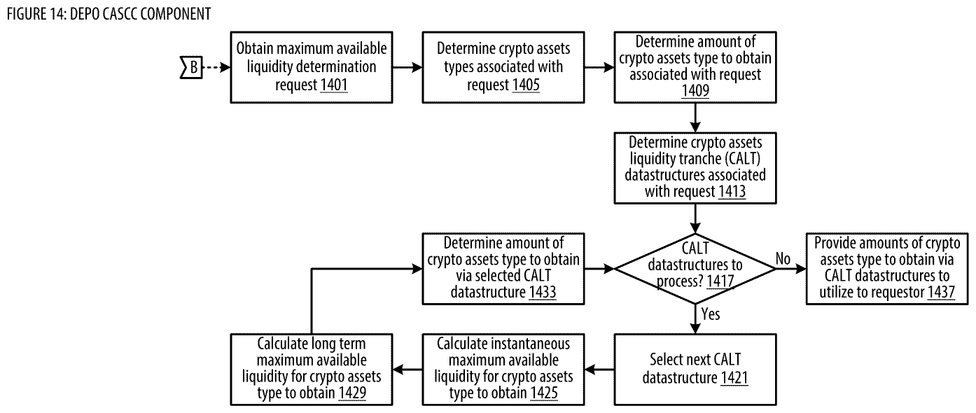

FIG. 14 shows non-limiting, example embodiments of a logic flow illustrating a crypto assets swap capacity computation (CASCC) component for the DEPO. In FIG. 14, a maximum available liquidity determination request may be obtained at 1401. For example, the maximum available liquidity determination request may be obtained as a result of a request (e.g., a function call) from another component (e.g., a requestor) to determine the maximum available liquidity of CALT datastructures for a swap transaction.

Crypto assets types associated with the maximum available liquidity determination request may be determined at 1405. In one implementation, the (e.g., two) crypto asset types associated with the maximum available liquidity determination request may be provided as input parameters to the CASCC component from the requestor. For example, crypto asset types crypto_asset_A and crypto_asset_B may be specified as input parameters of the function call.

An amount of crypto assets type to obtain associated with the maximum available liquidity determination request may be determined at 1409. In one implementation, the crypto assets type to obtain via the swap transaction and/or the number of units of the crypto assets type to obtain may be provided as input parameters to the CASCC component from the requestor. For example, 50 units of crypto assets crypto_asset_B to obtain may be specified as input parameters of the function call.

CALT datastructures associated with the maximum available liquidity determination request may be determined at 1413. In one embodiment, CALT datastructures in a liquidity pool for the crypto asset types associated with the maximum available liquidity determination request may be determined. In one implementation, the CALT datastructures in the liquidity pool may be specific to a bidirectional decentralized exchange smart contract or to a unidirectional decentralized exchange smart contract. In another implementation, identifiers of the CALT datastructures in the liquidity pool may be provided as input parameters to the CASCC component from the requestor.

A determination may be made at 1417 whether there remain CALT datastructures to process. In one implementation, each of the CALT datastructures in the liquidity pool may be processed (e.g., until CALT datastructures to utilize for the swap transaction have been determined). If there remain CALT datastructures to process, the next CALT datastructure may be selected for processing at 1421.

An instantaneous maximum available liquidity for the crypto assets type to obtain for the selected CALT datastructure may be calculated at 1425. For example, the instantaneous maximum available liquidity for the crypto assets type to obtain (e.g., crypto assets crypto_asset_B) may be determined as 30 units of crypto assets crypto_asset_B for a CALT datastructure corresponding to tranche 0, and 50 units of crypto assets crypto_asset_B for a CALT datastructure corresponding to tranche 1.

In one embodiment, when a price oracle is used, adverse selection may affect a liquidity provider receiving execution against a liquidity taker. Also, a sniffing attack may occur for a liquidity taker when a block sniffer takes out liquidity of lower tranches using a higher gas fee, and forces the liquidity taker to interact with CALT datastructures corresponding to higher tranches (e.g., with higher atomic liquidity utilization measure multiples). In one implementation, the DEPO may protect liquidity providers and/or liquidity takers by limiting the amount of liquidity that liquidity takers can receive within the current block. This can be further generalized to consider total liquidity taken in recent blocks.

In one embodiment, the DEPO may limit the amount of imbalance increase for each CALT datastructure due to a single swap transaction by imposing maximum available liquidity in a tranche for liquidity takers.

Let Ωᵢₙₛₜ be the maximum instantaneous swap capacity of a single transaction. If Q_{A}≥Q_{B}P_{AB}, to swap crypto assets crypto_asset_A to crypto assets crypto_asset_B, maximum available liquidity for crypto assets crypto_asset_B (ML_{B}) is

$${ML}_{B} \leq {Q}_{B} {Ω}_{inst}$$

To swap crypto assets crypto_asset_B to crypto assets crypto_asset_A via a CALT datastructure corresponding to tranche k, maximum available liquidity for crypto assets crypto_asset_A (ML_{A}) is

$${ML}_{A} \leq ( {Q}_{A} + \frac{{Q}_{A} - {Q}_{B} {P}_{AB}}{1 + {P}_{AB} - k {S}_{AB}} ) {Ω}_{inst}$$

The second term in bracket is the total amount of imbalance reducing liquidity that can be added to crypto assets crypto_asset_A via the CALT datastructure corresponding to tranche k.

Similarly, if Q_{A}≤Q_{B}P_{AB}, to swap crypto assets crypto_asset_B to crypto assets crypto_asset_A,

$${ML}_{A} \leq {Q}_{A} {Ω}_{inst}$$

And to swap crypto assets crypto_asset_A to crypto assets crypto_asset_B via the CALT datastructure corresponding to tranche k, maximum available liquidity for crypto assets crypto_asset_B (ML_{B}) is

$${ML}_{B} \leq ( {Q}_{B} + \frac{{Q}_{B} {P}_{AB} - {Q}_{A}}{1 + {P}_{AB} + k {S}_{AB}} ) {Ω}_{inst}$$

In one embodiment, impact for liquidity takers may be dynamic depending on the available liquidity in each CALT datastructure given imbalance constraint, and latest atomic liquidity utilization measure (e.g., spread). For illustrative purpose, consider stablecoin swaps where P_{AB}=1, instantaneous swap capacity Ωᵢₙₛₜ=0.5, atomic liquidity utilization measure is 0.001, and initial liquidity in the CALT datastructures is as follows:

| Liquidity Tranche | Q_{A} | Q_{B} |
|---|---|---|
| Tranche 0 | 500 | 1000 |
| Tranche 1 | 400 | 2000 |
| Tranche 2 | 3000 | 200 |

To swap crypto assets crypto_asset_B to crypto assets crypto_asset_A, since Q_{A} in tranche 0 has lower value than Q_{B}, the liquidity taker creates additional imbalance. In this case, the maximum liquidity in tranche 0 is 500×0.5=250 units of crypto assets crypto_asset_A. Similarly, maximum liquidity in tranche 1 is 400×0.5=200 units of crypto assets crypto_asset_A. In tranche 2, takers of crypto assets crypto_asset_A reduce imbalance for the tranche. Here,

$${ML}_{A} \leq ( {Q}_{A} + \frac{{Q}_{A} - {Q}_{B} {P}_{AB}}{1 + {P}_{AB} - k {S}_{AB}} ) {Ω}_{inst} = ( 3000 + \frac{3000 - 200}{1 + 1 - 2 \times 0.001} ) 0.5 = 2200.7$$

A liquidity taker may pay an imbalance generating fee at fair value (P_{AB}=1) to acquire up to 250 units of crypto assets crypto_asset_A, by interacting with tranche 1. If the liquidity taker wishes to acquire 250 to 450 units of crypto assets crypto_asset_A, the liquidity taker also interacts with tranche 2, and pays liquidity utilization measure cost and imbalance generating fee for the additional 200 shares. Additional impact and transaction costs may be summarized below:

| Step | Acquiring Token A | Liquidity Tranche | Imbalance Generating Fee | Price |
|---|---|---|---|---|
| A | 0-250 | 0 | Yes | P_{AB} = 1 |
| B | 250-450 | 1 | Yes | P_{AB} − S_{AB} = 0.999 |
| C | 450-1851.4 | 2 | No (reduce imbalance) | P_{AB} − 2S_{AB} = 0.998 |
| D | 1851.4-2200.7 | 2 | Yes | P_{AB} − 2S_{AB} = 0.998 |

In a special case where atomic spread cost is lower than imbalance generating fee, it is possible that execution with a CALT datastructure corresponding to imbalance reducing tranche 2 receives a better overall execution price than with a CALT datastructure corresponding to imbalance generating tranche 1. In this case, Step C above may interact with liquidity before Step B.

A long-term maximum available liquidity for the crypto assets type to obtain for the selected CALT datastructure may be calculated at 1429. For example, the long-term maximum available liquidity for the crypto assets type to obtain (e.g., crypto assets crypto_asset_B) may be determined as 30 units of crypto assets crypto_asset_B for a CALT datastructure corresponding to tranche 0, and 50 units of crypto assets crypto_asset_B for a CALT datastructure corresponding to tranche 1.

In one embodiment, beside instantaneous swap capacity, the DEPO may enforce long-term swap capacity by storing past instantaneous available liquidity Q_{B}-ML_{B} and Q_{A}-ML_{A} over the past transactions (e.g., in a circular buffer), and may further impose long-term swap capacity constraint for crypto assets crypto_asset_B as:

$${ML}_{B}^{longterm} \leq min ( {ML}_{B} , {min}_{i} {Q}_{B} - ( {Q}_{B}^{i} - {ML}_{B}^{i} ) )$$

where superscript denotes the lag quantity. An analogous constraint may be applied for crypto assets crypto_asset_A as:

$${ML}_{A}^{longterm} \leq min ( {ML}_{A} , {min}_{i} {Q}_{A} - ( {Q}_{A}^{i} - {ML}_{A}^{i} ) )$$

In the illustrative example discussed above with regard to 1425, if a large trade requires paying additional liquidity utilization measure (e.g., spread) cost, a liquidity taker may opt to break up a large trade into multiple smaller trades. If a liquidity taker wants to acquire 350 units, it is possible to first send a transaction for 250 units, and then send a subsequent transaction for 100 units in the same block. The liquidity taker may incentivize sequencing of these two blocks by paying a higher gas fee for the first transaction, and then a lower fee for the second transaction.

Without long-term swap capacity, the liquidity taker first pays an imbalance generating fee for 250 units at fair value P_{AB}=1. After the first transaction, a CALT datastructure corresponding to tranche 0 has Q_{A}=250 and Q_{B}=1250+fee. The maximum available liquidity for crypto assets crypto_asset_A is then 250×0.5=125. The second transaction would then pay imbalance generating fee for 100 units at fair value P_{AB}=1. This lowers transaction cost for the liquidity taker at the expense of liquidity providers.

In one embodiment, the DEPO may guard against this behavior by saving previously calculated instantaneous swap capacities. In this case, prior to the first transaction, Q_{A}-ML_{A}=500−250=250 is saved in a circular buffer. After the first transaction, the DEPO computes:

$${ML}_{A}^{longterm} \leq min ( {ML}_{A} , {min}_{i} {Q}_{A} - ( {Q}_{A}^{i} - {ML}_{A}^{i} ) ) = min ( 125 , 250 - 250 ) = 0$$

Hence, in the second transaction, taking of the additional 100 units of crypto assets crypto_asset_A may not interact with a CALT datastructure corresponding to tranche 0, and there is no benefit in breaking a large trade into multiple smaller trades.

In one implementation, the long-term swap capacity may be computed so that maximum available liquidity in a tranche is stable within 1-2 block transaction time. In one implementation, some memory elements in the circular buffer may be reset if a recent block has a low number of transactions.

An amount of crypto assets type to obtain via the selected CALT datastructure may be determined at 1433. In one implementation, the amount of crypto assets type to obtain via the selected CALT datastructure may be determined as the minimum of the maximum available liquidity (e.g., instantaneous maximum available liquidity and/or long-term maximum available liquidity) and the remaining number of units of the crypto assets type to obtain. For example, for a CALT datastructure corresponding to tranche 0, the amount of crypto assets type to obtain may be min (30, 50)=30 units of crypto assets crypto_asset_B, with 20 units of crypto assets crypto_asset_B to be obtained via other CALT datastructures, and for a CALT datastructure corresponding to tranche 1, the amount of crypto assets type to obtain may be min (50, 20)=20 units of crypto assets crypto_asset_B, with 0 units of crypto assets crypto_asset_B to be obtained via other CALT datastructures.

Amounts of the crypto assets type to obtain via the CALT datastructures to utilize may be provided to the requestor at 1437. In one embodiment, a datastructure that specifies the number of units of the crypto assets type to obtain via each CALT datastructure to utilize may be generated. In one implementation, an array of (CALT datastructure identifier, number of units to obtain) tuples may be provided.

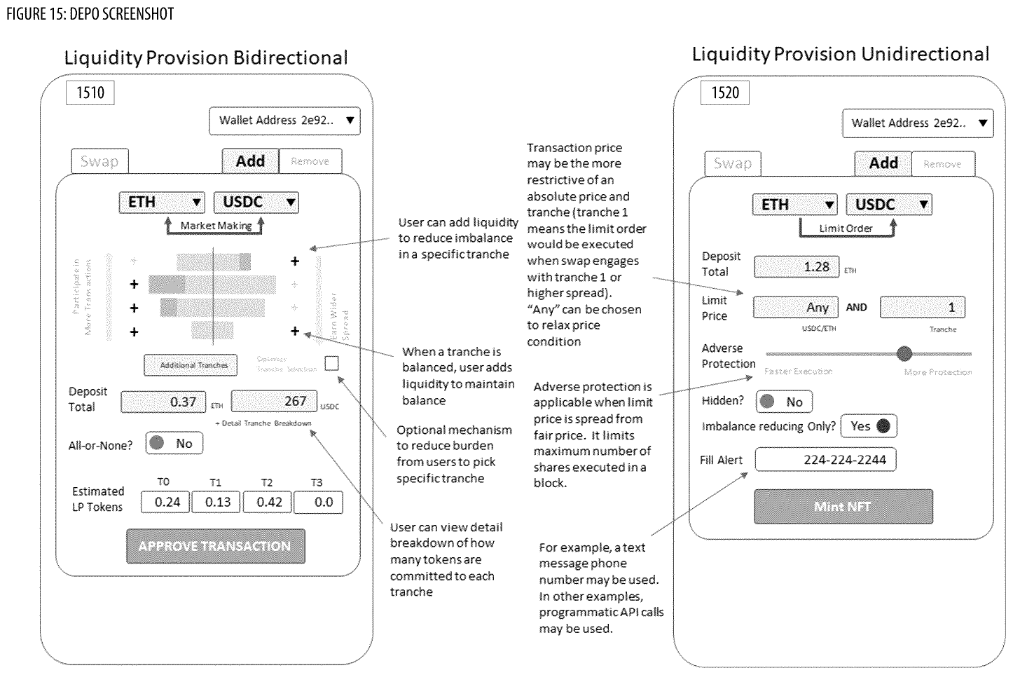

FIG. 15 shows non-limiting, example embodiments of a screenshot illustrating user interface(s) of the DEPO. In FIG. 15, exemplary user interfaces (e.g., for a mobile device, for a website) for interacting with a decentralized exchange are illustrated. Screen 1510 shows an exemplary user interface that a user may utilize to facilitate sending a decentralized exchange liquidity provision request to a bidirectional decentralized exchange smart contract. Screen 1520 shows an exemplary user interface that a user may utilize to facilitate sending a decentralized exchange liquidity provision request to a unidirectional decentralized exchange smart contract.

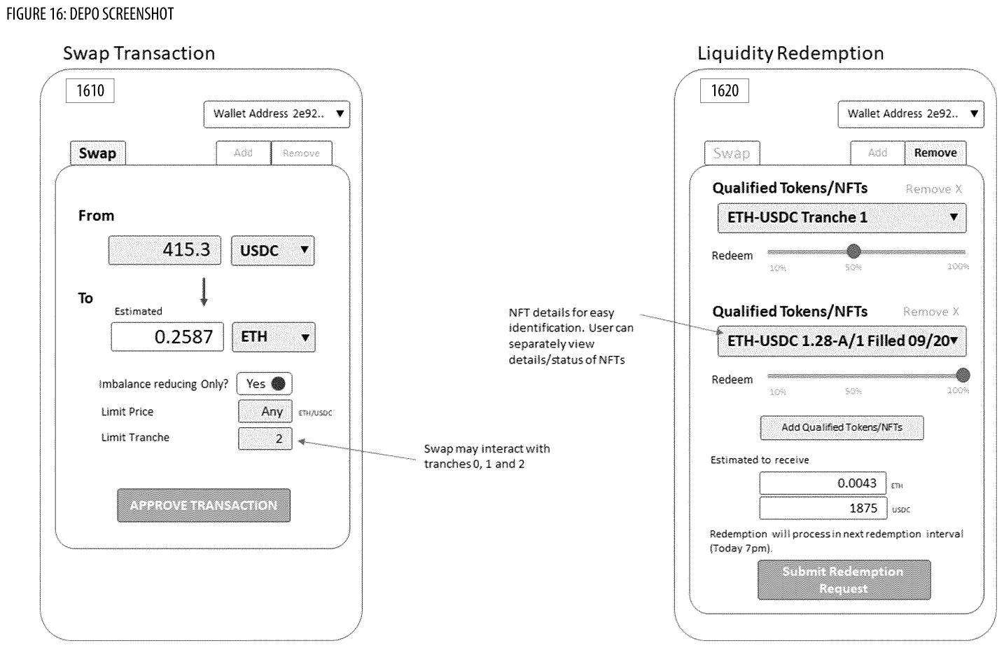

FIG. 16 shows non-limiting, example embodiments of a screenshot illustrating user interface(s) of the DEPO. In FIG. 16, exemplary user interfaces (e.g., for a mobile device, for a website) for interacting with a decentralized exchange are illustrated. Screen 1610 shows an exemplary user interface that a user may utilize to facilitate sending a decentralized exchange crypto asset swap request to a bidirectional decentralized exchange smart contract or to a unidirectional decentralized exchange smart contract. Screen 1620 shows an exemplary user interface that a user may utilize to facilitate sending a decentralized exchange liquidity redemption request to a bidirectional decentralized exchange smart contract, or to facilitate sending a decentralized exchange liquidity redemption initiate request or a decentralized exchange liquidity redemption confirm request to a unidirectional decentralized exchange smart contract.

### ADDITIONAL ALTERNATIVE EMBODIMENT EXAMPLES

The following alternative example embodiments provide a number of variations of some of the already discussed principles for expanded color on the abilities of the DEPO.

### Exemplary Liquidity Pool Operator Adjustments

In one embodiment, a pool operator associated with the DEPO may retain a portion of the transacted value as operator fee. The operator fee in the form of crypto assets (e.g., crypto_asset_A and/or crypto_asset_B) may be custodied within a decentralized exchange smart contract. The pool operator may redeem the operator fee with its private key.

### Exemplary Variables Stored in a Decentralized Exchange Smart Contract

Exemplary variables that the DEPO may store in a smart contract are listed below:
Atomic Liquidity Utilization Measure.
Exponential Moving Average Decay Parameter of Oracle Price
Exponential Moving Average of Oracle Price
Exponential Moving Average of Square of Oracle Price
Exponential Moving Average Decay Parameter for transaction values at different CALT datastructures
Exponential Moving Average of transaction values at different CALT datastructures.
Linear Decrease Parameter
Minimum Spread for Linear Decrease
Multiplicative Increase Parameter
Total Minted Tokens for different CALT datastructures.
Locked in crypto assets crypto_asset_A for different CALT datastructures
Locked in crypto assets crypto_asset_B for different CALT datastructures
Unclaimed Operator Fee in the form of crypto assets crypto_asset_A and/or crypto assets crypto_asset_B
Epoch Interval
Epoch Offset
Redemption Interval
Instantaneous Swap Capacity
Past instantaneous available liquidities for crypto assets crypto_asset_A
Past instantaneous available liquidities for crypto assets crypto_asset_B.
DEPO Derived Crypto Assets Exchange Quotient

### Exemplary Variables Used in a Liquidity Provider Transaction

In one embodiment, a liquidity provider may add liquidity to the liquidity pool by sending two types of tokens with the following transaction:
Tranche ID: the CALT datastructure to which new liquidity will be committed
All-Or-None: If set to true, if imbalance constraint fails with the new quantities, the transaction is considered failed and provided tokens are returned to the liquidity provider. If set to false, the DEPO takes the maximum possible tokens that satisfy imbalance constraint and return the residual to the liquidity provider.

A liquidity provider removes liquidity from the liquidity pool by sending a burn message along with their liquidity provider tokens within a redemption interval.

### Exemplary Variables Used in a Liquidity Taker Transaction

In one embodiment, a liquidity taker may initiate a swap transaction by sending provided crypto assets with the following transaction:
Reduce Imbalance Only: If set to true, only swap quantities that reduce imbalance
Limit Price: Absolute worst crypto assets exchange quotient a swap is allowed to transact.
Limit Tranche: Absolute worst CALT datastructure a swap is allowed to transact

Additional embodiments may include:

1. A bidirectional decentralized exchange apparatus, comprising:
at least one memory;
a component collection stored in the at least one memory;
at least one processor disposed in communication with the at least one memory, the at least one processor executing processor-executable instructions from the component collection, the component collection storage structured with processor-executable instructions, comprising:
   obtain, via at least one processor, via a bidirectional decentralized exchange smart contract deployed on a blockchain, a decentralized exchange liquidity provision transaction structured as specifying:
      a crypto assets liquidity tranche datastructure from a plurality of crypto assets liquidity tranche datastructures that constitute a liquidity pool associated with the bidirectional decentralized exchange smart contract,
      a first contribution amount associated with a first crypto asset type,
      a second contribution amount associated with a second crypto asset type, and
      a provision blockchain address controlled by a sender of the decentralized exchange liquidity provision transaction;
   determine, via at least one processor, a crypto assets exchange quotient for exchanging the first crypto asset type and the second crypto asset type;
   calculate, via at least one processor, a quantity of fungible tokens specific to the crypto assets liquidity tranche datastructure to generate via a calculation involving:
      the first contribution amount associated with the first crypto asset type,
      the second contribution amount associated with the second crypto asset type,
      the crypto assets exchange quotient,
      a quantity of previously issued fungible tokens specific to the crypto assets liquidity tranche datastructure, and
      a total value locked in the crypto assets liquidity tranche datastructure; and
   transfer, via at least one processor, the calculated quantity of fungible tokens specific to the crypto assets liquidity tranche datastructure to the provision blockchain address controlled by the sender of the decentralized exchange liquidity provision transaction.

2. The apparatus of embodiment 1, in which the component collection storage is further structured with processor-executable instructions, comprising:
update, via at least one processor, crypto assets balances for the crypto assets liquidity tranche datastructure to reflect contributions of the first contribution amount associated with the first crypto asset type and of the second contribution amount associated with the second crypto asset type.

3. The apparatus of embodiment 1, in which the instructions to determine the crypto assets exchange quotient are structured as instructions to query a price oracle.

4. The apparatus of embodiment 3, in which the component collection storage is further structured with processor-executable instructions, comprising:
verify, via at least one processor, exchange quotient fidelity associated with the crypto assets exchange quotient by checking compliance of a confidence measure provided by the price oracle with a confidence measure threshold rule.

5. The apparatus of embodiment 3, in which the instructions to determine the crypto assets exchange quotient are structured as instructions to utilize a derived crypto assets exchange quotient upon determining that a timestamp associated with the derived crypto assets exchange quotient is more recent than a timestamp associated with a crypto assets exchange quotient from the price oracle.

6. The apparatus of embodiment 1, in which each of the plurality of crypto assets liquidity tranche datastructures that constitute the liquidity pool associated with the bidirectional decentralized exchange smart contract utilizes a different type of fungible tokens specific to the respective crypto assets liquidity tranche datastructure.

7. The apparatus of embodiment 1, in which the component collection storage is further structured with processor-executable instructions, comprising:
obtain, via at least one processor, via the bidirectional decentralized exchange smart contract deployed on the blockchain, a decentralized exchange liquidity redemption transaction structured as specifying:
   the crypto assets liquidity tranche datastructure,
   a first redemption quantity associated with the fungible tokens specific to the crypto assets liquidity tranche datastructure, and
   a redemption blockchain address controlled by a sender of the decentralized exchange liquidity redemption transaction;
calculate, via at least one processor, a first redemption amount associated with the first crypto asset type via a calculation involving:
   the first redemption quantity associated with the fungible tokens specific to the crypto assets liquidity tranche datastructure,
   a quantity of currently issued fungible tokens specific to the crypto assets liquidity tranche datastructure, and
   a total amount of crypto assets of the first crypto asset type locked in the crypto assets liquidity tranche datastructure;
calculate, via at least one processor, a second redemption amount associated with the second crypto asset type via a calculation involving:
   the first redemption quantity associated with the fungible tokens specific to the crypto assets liquidity tranche datastructure,
   the quantity of currently issued fungible tokens specific to the crypto assets liquidity tranche datastructure, and
   a total amount of crypto assets of the second crypto asset type locked in the crypto assets liquidity tranche datastructure; and
transfer, via at least one processor, the calculated first redemption amount of crypto assets of the first crypto asset type and the calculated second redemption amount of crypto assets of the second crypto asset type to the provision blockchain address controlled by the sender of the decentralized exchange liquidity redemption transaction.

8. The apparatus of embodiment 7, in which the component collection storage is further structured with processor-executable instructions, comprising:
update, via at least one processor, crypto assets balances for the crypto assets liquidity tranche datastructure to reflect redemption of the first redemption amount associated with the first crypto asset type and of the second redemption amount associated with the second crypto asset type.

9. The apparatus of embodiment 7, in which the component collection storage is further structured with processor-executable instructions, comprising:
verify, via at least one processor, that a timestamp associated with the decentralized exchange liquidity redemption transaction is within an allowed redemption time.

10. The apparatus of embodiment 7, in which the component collection storage is further structured with processor-executable instructions, comprising:
determine, via at least one processor, that a timestamp associated with the decentralized exchange liquidity redemption transaction is outside an allowed redemption time;
determine, via at least one processor, an updated crypto assets exchange quotient for exchanging the first crypto asset type and the second crypto asset type; and
allow, via at least one processor, execution of the decentralized exchange liquidity redemption transaction upon determining that exchange quotient fidelity associated with the updated crypto assets exchange quotient is not verified.

11. The apparatus of embodiment 7, in which the component collection storage is further structured with processor-executable instructions, comprising:
determine, via at least one processor, that a timestamp associated with the decentralized exchange liquidity redemption transaction is outside an allowed redemption time;
determine, via at least one processor, an updated crypto assets exchange quotient for exchanging the first crypto asset type and the second crypto asset type; and
deny, via at least one processor, execution of the decentralized exchange liquidity redemption transaction upon determining that exchange quotient fidelity associated with the updated crypto assets exchange quotient is verified.

12. The apparatus of embodiment 7, in which the component collection storage is further structured with processor-executable instructions, comprising:
remove, via at least one processor, the first redemption quantity of fungible tokens specific to the crypto assets liquidity tranche datastructure from circulation.

13. The apparatus of embodiment 12, in which a fungible token is removed from circulation by destroying the fungible token.

14. The apparatus of embodiment 12, in which a fungible token is removed from circulation by returning the fungible token to a fixed supply.

15. The apparatus of embodiment 7, in which the component collection storage is further structured with processor-executable instructions, comprising:
update, via at least one processor, a derived crypto assets exchange quotient for exchanging the first crypto asset type and the second crypto asset type upon execution of the decentralized exchange liquidity provision transaction; and
update, via at least one processor, the derived crypto assets exchange quotient for exchanging the first crypto asset type and the second crypto asset type upon execution of the decentralized exchange liquidity redemption transaction.

16. A bidirectional decentralized exchange processor-readable, non-transient medium, the medium storing a component collection, the component collection storage structured with processor-executable instructions comprising:
obtain, via at least one processor, via a bidirectional decentralized exchange smart contract deployed on a blockchain, a decentralized exchange liquidity provision transaction structured as specifying:
   a crypto assets liquidity tranche datastructure from a plurality of crypto assets liquidity tranche datastructures that constitute a liquidity pool associated with the bidirectional decentralized exchange smart contract,
   a first contribution amount associated with a first crypto asset type,
   a second contribution amount associated with a second crypto asset type, and
   a provision blockchain address controlled by a sender of the decentralized exchange liquidity provision transaction;
determine, via at least one processor, a crypto assets exchange quotient for exchanging the first crypto asset type and the second crypto asset type;
calculate, via at least one processor, a quantity of fungible tokens specific to the crypto assets liquidity tranche datastructure to generate via a calculation involving:
   the first contribution amount associated with the first crypto asset type,
   the second contribution amount associated with the second crypto asset type,
   the crypto assets exchange quotient,
   a quantity of previously issued fungible tokens specific to the crypto assets liquidity tranche datastructure, and
   a total value locked in the crypto assets liquidity tranche datastructure; and
transfer, via at least one processor, the calculated quantity of fungible tokens specific to the crypto assets liquidity tranche datastructure to the provision blockchain address controlled by the sender of the decentralized exchange liquidity provision transaction.

17. The medium of embodiment 16, in which the component collection storage is further structured with processor-executable instructions, comprising:
update, via at least one processor, crypto assets balances for the crypto assets liquidity tranche datastructure to reflect contributions of the first contribution amount associated with the first crypto asset type and of the second contribution amount associated with the second crypto asset type.

18. The medium of embodiment 16, in which the instructions to determine the crypto assets exchange quotient are structured as instructions to query a price oracle.

19. The medium of embodiment 18, in which the component collection storage is further structured with processor-executable instructions, comprising:
verify, via at least one processor, exchange quotient fidelity associated with the crypto assets exchange quotient by checking compliance of a confidence measure provided by the price oracle with a confidence measure threshold rule.

20. The medium of embodiment 18, in which the instructions to determine the crypto assets exchange quotient are structured as instructions to utilize a derived crypto assets exchange quotient upon determining that a timestamp associated with the derived crypto assets exchange quotient is more recent than a timestamp associated with a crypto assets exchange quotient from the price oracle.

21. The medium of embodiment 16, in which each of the plurality of crypto assets liquidity tranche datastructures that constitute the liquidity pool associated with the bidirectional decentralized exchange smart contract utilizes a different type of fungible tokens specific to the respective crypto assets liquidity tranche datastructure.

22. The medium of embodiment 16, in which the component collection storage is further structured with processor-executable instructions, comprising:
obtain, via at least one processor, via the bidirectional decentralized exchange smart contract deployed on the blockchain, a decentralized exchange liquidity redemption transaction structured as specifying:
   the crypto assets liquidity tranche datastructure,
   a first redemption quantity associated with the fungible tokens specific to the crypto assets liquidity tranche datastructure, and
   a redemption blockchain address controlled by a sender of the decentralized exchange liquidity redemption transaction;
calculate, via at least one processor, a first redemption amount associated with the first crypto asset type via a calculation involving:
   the first redemption quantity associated with the fungible tokens specific to the crypto assets liquidity tranche datastructure,
   a quantity of currently issued fungible tokens specific to the crypto assets liquidity tranche datastructure, and
   a total amount of crypto assets of the first crypto asset type locked in the crypto assets liquidity tranche datastructure;
calculate, via at least one processor, a second redemption amount associated with the second crypto asset type via a calculation involving:
   the first redemption quantity associated with the fungible tokens specific to the crypto assets liquidity tranche datastructure,
   the quantity of currently issued fungible tokens specific to the crypto assets liquidity tranche datastructure, and
   a total amount of crypto assets of the second crypto asset type locked in the crypto assets liquidity tranche datastructure; and
transfer, via at least one processor, the calculated first redemption amount of crypto assets of the first crypto asset type and the calculated second redemption amount of crypto assets of the second crypto asset type to the provision blockchain address controlled by the sender of the decentralized exchange liquidity redemption transaction.

23. The medium of embodiment 22, in which the component collection storage is further structured with processor-executable instructions, comprising:
update, via at least one processor, crypto assets balances for the crypto assets liquidity tranche datastructure to reflect redemption of the first redemption amount associated with the first crypto asset type and of the second redemption amount associated with the second crypto asset type.

24. The medium of embodiment 22, in which the component collection storage is further structured with processor-executable instructions, comprising:
verify, via at least one processor, that a timestamp associated with the decentralized exchange liquidity redemption transaction is within an allowed redemption time.

25. The medium of embodiment 22, in which the component collection storage is further structured with processor-executable instructions, comprising:
determine, via at least one processor, that a timestamp associated with the decentralized exchange liquidity redemption transaction is outside an allowed redemption time;
determine, via at least one processor, an updated crypto assets exchange quotient for exchanging the first crypto asset type and the second crypto asset type; and
allow, via at least one processor, execution of the decentralized exchange liquidity redemption transaction upon determining that exchange quotient fidelity associated with the updated crypto assets exchange quotient is not verified.

26. The medium of embodiment 22, in which the component collection storage is further structured with processor-executable instructions, comprising:
determine, via at least one processor, that a timestamp associated with the decentralized exchange liquidity redemption transaction is outside an allowed redemption time;
determine, via at least one processor, an updated crypto assets exchange quotient for exchanging the first crypto asset type and the second crypto asset type; and
deny, via at least one processor, execution of the decentralized exchange liquidity redemption transaction upon determining that exchange quotient fidelity associated with the updated crypto assets exchange quotient is verified.

27. The medium of embodiment 22, in which the component collection storage is further structured with processor-executable instructions, comprising:
remove, via at least one processor, the first redemption quantity of fungible tokens specific to the crypto assets liquidity tranche datastructure from circulation.

28. The medium of embodiment 27, in which a fungible token is removed from circulation by destroying the fungible token.

29. The medium of embodiment 27, in which a fungible token is removed from circulation by returning the fungible token to a fixed supply.

30. The medium of embodiment 22, in which the component collection storage is further structured with processor-executable instructions, comprising:
update, via at least one processor, a derived crypto assets exchange quotient for exchanging the first crypto asset type and the second crypto asset type upon execution of the decentralized exchange liquidity provision transaction; and
update, via at least one processor, the derived crypto assets exchange quotient for exchanging the first crypto asset type and the second crypto asset type upon execution of the decentralized exchange liquidity redemption transaction.

31. A bidirectional decentralized exchange processor-implemented system, comprising:
means to store a component collection;
means to process processor-executable instructions from the component collection, the component collection storage structured with processor-executable instructions including:
   obtain, via at least one processor, via a bidirectional decentralized exchange smart contract deployed on a blockchain, a decentralized exchange liquidity provision transaction structured as specifying:
      a crypto assets liquidity tranche datastructure from a plurality of crypto assets liquidity tranche datastructures that constitute a liquidity pool associated with the bidirectional decentralized exchange smart contract,
      a first contribution amount associated with a first crypto asset type,
      a second contribution amount associated with a second crypto asset type, and
      a provision blockchain address controlled by a sender of the decentralized exchange liquidity provision transaction;
   determine, via at least one processor, a crypto assets exchange quotient for exchanging the first crypto asset type and the second crypto asset type;
   calculate, via at least one processor, a quantity of fungible tokens specific to the crypto assets liquidity tranche datastructure to generate via a calculation involving:
      the first contribution amount associated with the first crypto asset type,
      the second contribution amount associated with the second crypto asset type,
      the crypto assets exchange quotient,
      a quantity of previously issued fungible tokens specific to the crypto assets liquidity tranche datastructure, and
      a total value locked in the crypto assets liquidity tranche datastructure; and
   transfer, via at least one processor, the calculated quantity of fungible tokens specific to the crypto assets liquidity tranche datastructure to the provision blockchain address controlled by the sender of the decentralized exchange liquidity provision transaction.

32. The system of embodiment 31, in which the component collection storage is further structured with processor-executable instructions, comprising:
update, via at least one processor, crypto assets balances for the crypto assets liquidity tranche datastructure to reflect contributions of the first contribution amount associated with the first crypto asset type and of the second contribution amount associated with the second crypto asset type.

33. The system of embodiment 31, in which the instructions to determine the crypto assets exchange quotient are structured as instructions to query a price oracle.

34. The system of embodiment 33, in which the component collection storage is further structured with processor-executable instructions, comprising:
verify, via at least one processor, exchange quotient fidelity associated with the crypto assets exchange quotient by checking compliance of a confidence measure provided by the price oracle with a confidence measure threshold rule.

35. The system of embodiment 33, in which the instructions to determine the crypto assets exchange quotient are structured as instructions to utilize a derived crypto assets exchange quotient upon determining that a timestamp associated with the derived crypto assets exchange quotient is more recent than a timestamp associated with a crypto assets exchange quotient from the price oracle.

36. The system of embodiment 31, in which each of the plurality of crypto assets liquidity tranche datastructures that constitute the liquidity pool associated with the bidirectional decentralized exchange smart contract utilizes a different type of fungible tokens specific to the respective crypto assets liquidity tranche datastructure.

37. The system of embodiment 31, in which the component collection storage is further structured with processor-executable instructions, comprising:
obtain, via at least one processor, via the bidirectional decentralized exchange smart contract deployed on the blockchain, a decentralized exchange liquidity redemption transaction structured as specifying:
   the crypto assets liquidity tranche datastructure,
   a first redemption quantity associated with the fungible tokens specific to the crypto assets liquidity tranche datastructure, and
   a redemption blockchain address controlled by a sender of the decentralized exchange liquidity redemption transaction;
calculate, via at least one processor, a first redemption amount associated with the first crypto asset type via a calculation involving:
   the first redemption quantity associated with the fungible tokens specific to the crypto assets liquidity tranche datastructure,
   a quantity of currently issued fungible tokens specific to the crypto assets liquidity tranche datastructure, and
   a total amount of crypto assets of the first crypto asset type locked in the crypto assets liquidity tranche datastructure;
calculate, via at least one processor, a second redemption amount associated with the second crypto asset type via a calculation involving:
   the first redemption quantity associated with the fungible tokens specific to the crypto assets liquidity tranche datastructure,
   the quantity of currently issued fungible tokens specific to the crypto assets liquidity tranche datastructure, and
   a total amount of crypto assets of the second crypto asset type locked in the crypto assets liquidity tranche datastructure; and
transfer, via at least one processor, the calculated first redemption amount of crypto assets of the first crypto asset type and the calculated second redemption amount of crypto assets of the second crypto asset type to the provision blockchain address controlled by the sender of the decentralized exchange liquidity redemption transaction.

38. The system of embodiment 37, in which the component collection storage is further structured with processor-executable instructions, comprising:
update, via at least one processor, crypto assets balances for the crypto assets liquidity tranche datastructure to reflect redemption of the first redemption amount associated with the first crypto asset type and of the second redemption amount associated with the second crypto asset type.

39. The system of embodiment 37, in which the component collection storage is further structured with processor-executable instructions, comprising:
verify, via at least one processor, that a timestamp associated with the decentralized exchange liquidity redemption transaction is within an allowed redemption time.

40. The system of embodiment 37, in which the component collection storage is further structured with processor-executable instructions, comprising:
determine, via at least one processor, that a timestamp associated with the decentralized exchange liquidity redemption transaction is outside an allowed redemption time;
determine, via at least one processor, an updated crypto assets exchange quotient for exchanging the first crypto asset type and the second crypto asset type; and
allow, via at least one processor, execution of the decentralized exchange liquidity redemption transaction upon determining that exchange quotient fidelity associated with the updated crypto assets exchange quotient is not verified.

41. The system of embodiment 37, in which the component collection storage is further structured with processor-executable instructions, comprising:
determine, via at least one processor, that a timestamp associated with the decentralized exchange liquidity redemption transaction is outside an allowed redemption time;
determine, via at least one processor, an updated crypto assets exchange quotient for exchanging the first crypto asset type and the second crypto asset type; and
deny, via at least one processor, execution of the decentralized exchange liquidity redemption transaction upon determining that exchange quotient fidelity associated with the updated crypto assets exchange quotient is verified.

42. The system of embodiment 37, in which the component collection storage is further structured with processor-executable instructions, comprising:
remove, via at least one processor, the first redemption quantity of fungible tokens specific to the crypto assets liquidity tranche datastructure from circulation.

43. The system of embodiment 42, in which a fungible token is removed from circulation by destroying the fungible token.

44. The system of embodiment 42, in which a fungible token is removed from circulation by returning the fungible token to a fixed supply.

45. The system of embodiment 37, in which the component collection storage is further structured with processor-executable instructions, comprising:
update, via at least one processor, a derived crypto assets exchange quotient for exchanging the first crypto asset type and the second crypto asset type upon execution of the decentralized exchange liquidity provision transaction; and
update, via at least one processor, the derived crypto assets exchange quotient for exchanging the first crypto asset type and the second crypto asset type upon execution of the decentralized exchange liquidity redemption transaction.

46. A bidirectional decentralized exchange processor-implemented process, including processing processor-executable instructions via at least one processor from a component collection stored in at least one memory, the component collection storage structured with processor-executable instructions comprising:
obtain, via at least one processor, via a bidirectional decentralized exchange smart contract deployed on a blockchain, a decentralized exchange liquidity provision transaction structured as specifying:
   a crypto assets liquidity tranche datastructure from a plurality of crypto assets liquidity tranche datastructures that constitute a liquidity pool associated with the bidirectional decentralized exchange smart contract,
   a first contribution amount associated with a first crypto asset type,
   a second contribution amount associated with a second crypto asset type, and
   a provision blockchain address controlled by a sender of the decentralized exchange liquidity provision transaction;
determine, via at least one processor, a crypto assets exchange quotient for exchanging the first crypto asset type and the second crypto asset type;
calculate, via at least one processor, a quantity of fungible tokens specific to the crypto assets liquidity tranche datastructure to generate via a calculation involving:
   the first contribution amount associated with the first crypto asset type,
   the second contribution amount associated with the second crypto asset type,
   the crypto assets exchange quotient,
   a quantity of previously issued fungible tokens specific to the crypto assets liquidity tranche datastructure, and
   a total value locked in the crypto assets liquidity tranche datastructure; and
transfer, via at least one processor, the calculated quantity of fungible tokens specific to the crypto assets liquidity tranche datastructure to the provision blockchain address controlled by the sender of the decentralized exchange liquidity provision transaction.

47. The process of embodiment 46, in which the component collection storage is further structured with processor-executable instructions, comprising:
update, via at least one processor, crypto assets balances for the crypto assets liquidity tranche datastructure to reflect contributions of the first contribution amount associated with the first crypto asset type and of the second contribution amount associated with the second crypto asset type.

48. The process of embodiment 46, in which the instructions to determine the crypto assets exchange quotient are structured as instructions to query a price oracle.

49. The process of embodiment 48, in which the component collection storage is further structured with processor-executable instructions, comprising:
verify, via at least one processor, exchange quotient fidelity associated with the crypto assets exchange quotient by checking compliance of a confidence measure provided by the price oracle with a confidence measure threshold rule.

50. The process of embodiment 48, in which the instructions to determine the crypto assets exchange quotient are structured as instructions to utilize a derived crypto assets exchange quotient upon determining that a timestamp associated with the derived crypto assets exchange quotient is more recent than a timestamp associated with a crypto assets exchange quotient from the price oracle.

51. The process of embodiment 46, in which each of the plurality of crypto assets liquidity tranche datastructures that constitute the liquidity pool associated with the bidirectional decentralized exchange smart contract utilizes a different type of fungible tokens specific to the respective crypto assets liquidity tranche datastructure.

52. The process of embodiment 46, in which the component collection storage is further structured with processor-executable instructions, comprising:
obtain, via at least one processor, via the bidirectional decentralized exchange smart contract deployed on the blockchain, a decentralized exchange liquidity redemption transaction structured as specifying:
   the crypto assets liquidity tranche datastructure,
   a first redemption quantity associated with the fungible tokens specific to the crypto assets liquidity tranche datastructure, and
   a redemption blockchain address controlled by a sender of the decentralized exchange liquidity redemption transaction;
calculate, via at least one processor, a first redemption amount associated with the first crypto asset type via a calculation involving:
   the first redemption quantity associated with the fungible tokens specific to the crypto assets liquidity tranche datastructure,
   a quantity of currently issued fungible tokens specific to the crypto assets liquidity tranche datastructure, and
   a total amount of crypto assets of the first crypto asset type locked in the crypto assets liquidity tranche datastructure;
calculate, via at least one processor, a second redemption amount associated with the second crypto asset type via a calculation involving:
   the first redemption quantity associated with the fungible tokens specific to the crypto assets liquidity tranche datastructure,
   the quantity of currently issued fungible tokens specific to the crypto assets liquidity tranche datastructure, and
   a total amount of crypto assets of the second crypto asset type locked in the crypto assets liquidity tranche datastructure; and
transfer, via at least one processor, the calculated first redemption amount of crypto assets of the first crypto asset type and the calculated second redemption amount of crypto assets of the second crypto asset type to the provision blockchain address controlled by the sender of the decentralized exchange liquidity redemption transaction.

53. The process of embodiment 52, in which the component collection storage is further structured with processor-executable instructions, comprising:
update, via at least one processor, crypto assets balances for the crypto assets liquidity tranche datastructure to reflect redemption of the first redemption amount associated with the first crypto asset type and of the second redemption amount associated with the second crypto asset type.

54. The process of embodiment 52, in which the component collection storage is further structured with processor-executable instructions, comprising:
verify, via at least one processor, that a timestamp associated with the decentralized exchange liquidity redemption transaction is within an allowed redemption time.

55. The process of embodiment 52, in which the component collection storage is further structured with processor-executable instructions, comprising:
determine, via at least one processor, that a timestamp associated with the decentralized exchange liquidity redemption transaction is outside an allowed redemption time;
determine, via at least one processor, an updated crypto assets exchange quotient for exchanging the first crypto asset type and the second crypto asset type; and
allow, via at least one processor, execution of the decentralized exchange liquidity redemption transaction upon determining that exchange quotient fidelity associated with the updated crypto assets exchange quotient is not verified.

56. The process of embodiment 52, in which the component collection storage is further structured with processor-executable instructions, comprising:
determine, via at least one processor, that a timestamp associated with the decentralized exchange liquidity redemption transaction is outside an allowed redemption time;
determine, via at least one processor, an updated crypto assets exchange quotient for exchanging the first crypto asset type and the second crypto asset type; and
deny, via at least one processor, execution of the decentralized exchange liquidity redemption transaction upon determining that exchange quotient fidelity associated with the updated crypto assets exchange quotient is verified.

57. The process of embodiment 52, in which the component collection storage is further structured with processor-executable instructions, comprising:
remove, via at least one processor, the first redemption quantity of fungible tokens specific to the crypto assets liquidity tranche datastructure from circulation.

58. The process of embodiment 57, in which a fungible token is removed from circulation by destroying the fungible token.

59. The process of embodiment 57, in which a fungible token is removed from circulation by returning the fungible token to a fixed supply.

60. The process of embodiment 52, in which the component collection storage is further structured with processor-executable instructions, comprising:
update, via at least one processor, a derived crypto assets exchange quotient for exchanging the first crypto asset type and the second crypto asset type upon execution of the decentralized exchange liquidity provision transaction; and
update, via at least one processor, the derived crypto assets exchange quotient for exchanging the first crypto asset type and the second crypto asset type upon execution of the decentralized exchange liquidity redemption transaction.

101. A unidirectional decentralized exchange apparatus, comprising:
at least one memory;
a component collection stored in the at least one memory;
at least one processor disposed in communication with the at least one memory, the at least one processor executing processor-executable instructions from the component collection, the component collection storage structured with processor-executable instructions, comprising:
   obtain, via at least one processor, via a unidirectional decentralized exchange smart contract deployed on a blockchain, a decentralized exchange liquidity provision transaction structured as specifying:
      a crypto assets liquidity tranche datastructure from a plurality of crypto assets liquidity tranche datastructures that constitute a liquidity pool associated with the unidirectional decentralized exchange smart contract,
      a first contribution amount associated with a source crypto asset type,
      a target crypto asset type,
      a limit crypto assets exchange quotient for exchanging the source crypto asset type and the target crypto asset type, and
      a provision blockchain address controlled by a sender of the decentralized exchange liquidity provision transaction;
   determine, via at least one processor, a crypto assets exchange quotient for exchanging the source crypto asset type and the target crypto asset type;
   execute, via at least one processor, an imbalance rule check for the crypto assets liquidity tranche datastructure, in which the imbalance rule check is executed via a calculation involving:
      a first total amount of crypto assets of the source crypto asset type locked in the crypto assets liquidity tranche datastructure;
      a second total amount of crypto assets of the target crypto asset type locked in the crypto assets liquidity tranche datastructure;
      the crypto assets exchange quotient, and
      the first contribution amount associated with the source crypto asset type; and
   mint, via at least one processor, a non-fungible token specific to the crypto assets liquidity tranche datastructure, in which the non-fungible token is associated with the provision blockchain address controlled by the sender of the decentralized exchange liquidity provision transaction, and in which the non-fungible token comprises metadata structured as specifying:
      an available liquidity amount associated with the source crypto asset type, in which the available liquidity amount is initialized to the first contribution amount associated with the source crypto asset type,
      an executed quantity associated with the target crypto asset type, and
      the limit crypto assets exchange quotient for exchanging the source crypto asset type and the target crypto asset type.

102. The apparatus of embodiment 101, in which the component collection storage is further structured with processor-executable instructions, comprising:
update, via at least one processor, source crypto assets balance for the crypto assets liquidity tranche datastructure to reflect contribution of the first contribution amount associated with the source crypto asset type.

103. The apparatus of embodiment 101, in which the instructions to determine the crypto assets exchange quotient are structured as instructions to query a price oracle.

104. The apparatus of embodiment 103, in which the component collection storage is further structured with processor-executable instructions, comprising:
verify, via at least one processor, exchange quotient fidelity associated with the crypto assets exchange quotient by checking compliance of a confidence measure provided by the price oracle with a confidence measure threshold rule.

105. The apparatus of embodiment 103, in which the instructions to determine the crypto assets exchange quotient are structured as instructions to utilize a derived crypto assets exchange quotient upon determining that a timestamp associated with the derived crypto assets exchange quotient is more recent than a timestamp associated with a crypto assets exchange quotient from the price oracle.

106. The apparatus of embodiment 101, in which the non-fungible token comprises metadata further structured as specifying an event notification alert API.

107. The apparatus of embodiment 101, in which the non-fungible token comprises metadata further structured as specifying the available liquidity amount associated with the source crypto asset type via a displayed liquidity amount and a non-displayed liquidity amount, in which the non-displayed liquidity amount is encrypted.

108. The apparatus of embodiment 101, in which the component collection storage is further structured with processor-executable instructions, comprising:
obtain, via at least one processor, via the unidirectional decentralized exchange smart contract deployed on the blockchain, a decentralized exchange liquidity redemption initiate transaction structured as specifying:
   the crypto assets liquidity tranche datastructure,
   an identifier of the non-fungible token specific to the crypto assets liquidity tranche datastructure,
   a first redemption amount associated with the source crypto asset type, and
   a redemption blockchain address controlled by a sender of the decentralized exchange liquidity redemption initiate transaction;
determine, via at least one processor, a timestamp associated with the decentralized exchange liquidity redemption initiate transaction;
adjust, via at least one processor, the available liquidity amount associated with the source crypto asset type via a calculation involving the first redemption amount upon determining that a minimum delay threshold rule associated with the decentralized exchange liquidity redemption initiate transaction is satisfied by checking the timestamp associated with the decentralized exchange liquidity redemption initiate transaction with regard to a minimum delay period;
obtain, via at least one processor, via the unidirectional decentralized exchange smart contract deployed on the blockchain, a decentralized exchange liquidity redemption confirm transaction corresponding to the decentralized exchange liquidity redemption initiate transaction;
calculate, via at least one processor, a second redemption amount associated with the source crypto asset type via a calculation involving:
   the first redemption amount associated with the source crypto asset type, and
   the available liquidity amount associated with the source crypto asset type, in which the available liquidity amount specifies a remaining liquidity amount associated with the non-fungible token; and
transfer, via at least one processor, the calculated second redemption amount of crypto assets of the source crypto asset type to the provision blockchain address controlled by the sender of the decentralized exchange liquidity redemption initiate transaction.

109. The apparatus of embodiment 108, in which the component collection storage is further structured with processor-executable instructions, comprising:
update, via at least one processor, crypto assets balances for the crypto assets liquidity tranche datastructure to reflect redemption of the second redemption amount associated with the source crypto asset type.

110. The apparatus of embodiment 108, in which the first redemption amount is structured as specifying a displayed liquidity redemption amount and a non-displayed liquidity redemption amount.

111. The apparatus of embodiment 108, in which the component collection storage is further structured with processor-executable instructions, comprising:
obtain, via at least one processor, via the unidirectional decentralized exchange smart contract deployed on the blockchain, a second decentralized exchange liquidity redemption initiate transaction; and
update, via at least one processor, the first redemption amount associated with the source crypto asset type to a value specified via the second decentralized exchange liquidity redemption initiate transaction upon determining that a minimum delay threshold rule associated with the decentralized exchange liquidity redemption initiate transaction is not satisfied.

112. The apparatus of embodiment 108, in which the component collection storage is further structured with processor-executable instructions, comprising:
determine, via at least one processor, that the non-fungible token is fully executed upon determining that the available liquidity amount associated with the source crypto asset type is zero.

113. The apparatus of embodiment 112, in which the component collection storage is further structured with processor-executable instructions, comprising:
generate, via at least one processor, an execution alert associated with the non-fungible token via an event notification alert API specified via the non-fungible token.

114. The apparatus of embodiment 113, in which the event notification alert API is accessed off-chain.

115. The apparatus of embodiment 108, in which the component collection storage is further structured with processor-executable instructions, comprising:
update, via at least one processor, a derived crypto assets exchange quotient for exchanging the source crypto asset type and the target crypto asset type upon execution of the decentralized exchange liquidity provision transaction; and
update, via at least one processor, the derived crypto assets exchange quotient for exchanging the source crypto asset type and the target crypto asset type upon execution of the decentralized exchange liquidity redemption confirm transaction.

116. A unidirectional decentralized exchange processor-readable, non-transient medium, the medium storing a component collection, the component collection storage structured with processor-executable instructions comprising:
obtain, via at least one processor, via a unidirectional decentralized exchange smart contract deployed on a blockchain, a decentralized exchange liquidity provision transaction structured as specifying:
   a crypto assets liquidity tranche datastructure from a plurality of crypto assets liquidity tranche datastructures that constitute a liquidity pool associated with the unidirectional decentralized exchange smart contract,
   a first contribution amount associated with a source crypto asset type,
   a target crypto asset type,
   a limit crypto assets exchange quotient for exchanging the source crypto asset type and the target crypto asset type, and
   a provision blockchain address controlled by a sender of the decentralized exchange liquidity provision transaction;
determine, via at least one processor, a crypto assets exchange quotient for exchanging the source crypto asset type and the target crypto asset type;
execute, via at least one processor, an imbalance rule check for the crypto assets liquidity tranche datastructure, in which the imbalance rule check is executed via a calculation involving:
   a first total amount of crypto assets of the source crypto asset type locked in the crypto assets liquidity tranche datastructure;
   a second total amount of crypto assets of the target crypto asset type locked in the crypto assets liquidity tranche datastructure;
   the crypto assets exchange quotient, and
   the first contribution amount associated with the source crypto asset type; and
mint, via at least one processor, a non-fungible token specific to the crypto assets liquidity tranche datastructure, in which the non-fungible token is associated with the provision blockchain address controlled by the sender of the decentralized exchange liquidity provision transaction, and in which the non-fungible token comprises metadata structured as specifying:
   an available liquidity amount associated with the source crypto asset type, in which the available liquidity amount is initialized to the first contribution amount associated with the source crypto asset type,
   an executed quantity associated with the target crypto asset type, and
   the limit crypto assets exchange quotient for exchanging the source crypto asset type and the target crypto asset type.

117. The medium of embodiment 116, in which the component collection storage is further structured with processor-executable instructions, comprising:
update, via at least one processor, source crypto assets balance for the crypto assets liquidity tranche datastructure to reflect contribution of the first contribution amount associated with the source crypto asset type.

118. The medium of embodiment 116, in which the instructions to determine the crypto assets exchange quotient are structured as instructions to query a price oracle.

119. The medium of embodiment 118, in which the component collection storage is further structured with processor-executable instructions, comprising:
verify, via at least one processor, exchange quotient fidelity associated with the crypto assets exchange quotient by checking compliance of a confidence measure provided by the price oracle with a confidence measure threshold rule.

120. The medium of embodiment 118, in which the instructions to determine the crypto assets exchange quotient are structured as instructions to utilize a derived crypto assets exchange quotient upon determining that a timestamp associated with the derived crypto assets exchange quotient is more recent than a timestamp associated with a crypto assets exchange quotient from the price oracle.

121. The medium of embodiment 116, in which the non-fungible token comprises metadata further structured as specifying an event notification alert API.

122. The medium of embodiment 116, in which the non-fungible token comprises metadata further structured as specifying the available liquidity amount associated with the source crypto asset type via a displayed liquidity amount and a non-displayed liquidity amount, in which the non-displayed liquidity amount is encrypted.

123. The medium of embodiment 116, in which the component collection storage is further structured with processor-executable instructions, comprising:
obtain, via at least one processor, via the unidirectional decentralized exchange smart contract deployed on the blockchain, a decentralized exchange liquidity redemption initiate transaction structured as specifying:
   the crypto assets liquidity tranche datastructure,
   an identifier of the non-fungible token specific to the crypto assets liquidity tranche datastructure,
   a first redemption amount associated with the source crypto asset type, and
   a redemption blockchain address controlled by a sender of the decentralized exchange liquidity redemption initiate transaction;
determine, via at least one processor, a timestamp associated with the decentralized exchange liquidity redemption initiate transaction;
adjust, via at least one processor, the available liquidity amount associated with the source crypto asset type via a calculation involving the first redemption amount upon determining that a minimum delay threshold rule associated with the decentralized exchange liquidity redemption initiate transaction is satisfied by checking the timestamp associated with the decentralized exchange liquidity redemption initiate transaction with regard to a minimum delay period;
obtain, via at least one processor, via the unidirectional decentralized exchange smart contract deployed on the blockchain, a decentralized exchange liquidity redemption confirm transaction corresponding to the decentralized exchange liquidity redemption initiate transaction;
calculate, via at least one processor, a second redemption amount associated with the source crypto asset type via a calculation involving:
   the first redemption amount associated with the source crypto asset type, and
   the available liquidity amount associated with the source crypto asset type, in which the available liquidity amount specifies a remaining liquidity amount associated with the non-fungible token; and
transfer, via at least one processor, the calculated second redemption amount of crypto assets of the source crypto asset type to the provision blockchain address controlled by the sender of the decentralized exchange liquidity redemption initiate transaction.

124. The medium of embodiment 123, in which the component collection storage is further structured with processor-executable instructions, comprising:
update, via at least one processor, crypto assets balances for the crypto assets liquidity tranche datastructure to reflect redemption of the second redemption amount associated with the source crypto asset type.

125. The medium of embodiment 123, in which the first redemption amount is structured as specifying a displayed liquidity redemption amount and a non-displayed liquidity redemption amount.

126. The medium of embodiment 123, in which the component collection storage is further structured with processor-executable instructions, comprising:
obtain, via at least one processor, via the unidirectional decentralized exchange smart contract deployed on the blockchain, a second decentralized exchange liquidity redemption initiate transaction; and
update, via at least one processor, the first redemption amount associated with the source crypto asset type to a value specified via the second decentralized exchange liquidity redemption initiate transaction upon determining that a minimum delay threshold rule associated with the decentralized exchange liquidity redemption initiate transaction is not satisfied.

127. The medium of embodiment 123, in which the component collection storage is further structured with processor-executable instructions, comprising:
determine, via at least one processor, that the non-fungible token is fully executed upon determining that the available liquidity amount associated with the source crypto asset type is zero.

128. The medium of embodiment 127, in which the component collection storage is further structured with processor-executable instructions, comprising:
generate, via at least one processor, an execution alert associated with the non-fungible token via an event notification alert API specified via the non-fungible token.

129. The medium of embodiment 128, in which the event notification alert API is accessed off-chain.

130. The medium of embodiment 123, in which the component collection storage is further structured with processor-executable instructions, comprising:
update, via at least one processor, a derived crypto assets exchange quotient for exchanging the source crypto asset type and the target crypto asset type upon execution of the decentralized exchange liquidity provision transaction; and
update, via at least one processor, the derived crypto assets exchange quotient for exchanging the source crypto asset type and the target crypto asset type upon execution of the decentralized exchange liquidity redemption confirm transaction.

131. A unidirectional decentralized exchange processor-implemented system, comprising:
means to store a component collection;
means to process processor-executable instructions from the component collection, the component collection storage structured with processor-executable instructions including:
   obtain, via at least one processor, via a unidirectional decentralized exchange smart contract deployed on a blockchain, a decentralized exchange liquidity provision transaction structured as specifying:
      a crypto assets liquidity tranche datastructure from a plurality of crypto assets liquidity tranche datastructures that constitute a liquidity pool associated with the unidirectional decentralized exchange smart contract,
      a first contribution amount associated with a source crypto asset type,
      a target crypto asset type,
      a limit crypto assets exchange quotient for exchanging the source crypto asset type and the target crypto asset type, and
      a provision blockchain address controlled by a sender of the decentralized exchange liquidity provision transaction;
   determine, via at least one processor, a crypto assets exchange quotient for exchanging the source crypto asset type and the target crypto asset type;
   execute, via at least one processor, an imbalance rule check for the crypto assets liquidity tranche datastructure, in which the imbalance rule check is executed via a calculation involving:
      a first total amount of crypto assets of the source crypto asset type locked in the crypto assets liquidity tranche datastructure;
      a second total amount of crypto assets of the target crypto asset type locked in the crypto assets liquidity tranche datastructure;
      the crypto assets exchange quotient, and
      the first contribution amount associated with the source crypto asset type; and
   mint, via at least one processor, a non-fungible token specific to the crypto assets liquidity tranche datastructure, in which the non-fungible token is associated with the provision blockchain address controlled by the sender of the decentralized exchange liquidity provision transaction, and in which the non-fungible token comprises metadata structured as specifying:
      an available liquidity amount associated with the source crypto asset type, in which the available liquidity amount is initialized to the first contribution amount associated with the source crypto asset type,
      an executed quantity associated with the target crypto asset type, and
      the limit crypto assets exchange quotient for exchanging the source crypto asset type and the target crypto asset type.

132. The system of embodiment 131, in which the component collection storage is further structured with processor-executable instructions, comprising:
update, via at least one processor, source crypto assets balance for the crypto assets liquidity tranche datastructure to reflect contribution of the first contribution amount associated with the source crypto asset type.

133. The system of embodiment 131, in which the instructions to determine the crypto assets exchange quotient are structured as instructions to query a price oracle.

134. The system of embodiment 133, in which the component collection storage is further structured with processor-executable instructions, comprising:
verify, via at least one processor, exchange quotient fidelity associated with the crypto assets exchange quotient by checking compliance of a confidence measure provided by the price oracle with a confidence measure threshold rule.

135. The system of embodiment 133, in which the instructions to determine the crypto assets exchange quotient are structured as instructions to utilize a derived crypto assets exchange quotient upon determining that a timestamp associated with the derived crypto assets exchange quotient is more recent than a timestamp associated with a crypto assets exchange quotient from the price oracle.

136. The system of embodiment 131, in which the non-fungible token comprises metadata further structured as specifying an event notification alert API.

137. The system of embodiment 131, in which the non-fungible token comprises metadata further structured as specifying the available liquidity amount associated with the source crypto asset type via a displayed liquidity amount and a non-displayed liquidity amount, in which the non-displayed liquidity amount is encrypted.

138. The system of embodiment 131, in which the component collection storage is further structured with processor-executable instructions, comprising:
obtain, via at least one processor, via the unidirectional decentralized exchange smart contract deployed on the blockchain, a decentralized exchange liquidity redemption initiate transaction structured as specifying:
   the crypto assets liquidity tranche datastructure,
   an identifier of the non-fungible token specific to the crypto assets liquidity tranche datastructure,
   a first redemption amount associated with the source crypto asset type, and
   a redemption blockchain address controlled by a sender of the decentralized exchange liquidity redemption initiate transaction;
determine, via at least one processor, a timestamp associated with the decentralized exchange liquidity redemption initiate transaction;
adjust, via at least one processor, the available liquidity amount associated with the source crypto asset type via a calculation involving the first redemption amount upon determining that a minimum delay threshold rule associated with the decentralized exchange liquidity redemption initiate transaction is satisfied by checking the timestamp associated with the decentralized exchange liquidity redemption initiate transaction with regard to a minimum delay period;
obtain, via at least one processor, via the unidirectional decentralized exchange smart contract deployed on the blockchain, a decentralized exchange liquidity redemption confirm transaction corresponding to the decentralized exchange liquidity redemption initiate transaction;
calculate, via at least one processor, a second redemption amount associated with the source crypto asset type via a calculation involving:
   the first redemption amount associated with the source crypto asset type, and
   the available liquidity amount associated with the source crypto asset type, in which the available liquidity amount specifies a remaining liquidity amount associated with the non-fungible token; and
transfer, via at least one processor, the calculated second redemption amount of crypto assets of the source crypto asset type to the provision blockchain address controlled by the sender of the decentralized exchange liquidity redemption initiate transaction.

139. The system of embodiment 138, in which the component collection storage is further structured with processor-executable instructions, comprising:
update, via at least one processor, crypto assets balances for the crypto assets liquidity tranche datastructure to reflect redemption of the second redemption amount associated with the source crypto asset type.

140. The system of embodiment 138, in which the first redemption amount is structured as specifying a displayed liquidity redemption amount and a non-displayed liquidity redemption amount.

141. The system of embodiment 138, in which the component collection storage is further structured with processor-executable instructions, comprising:
obtain, via at least one processor, via the unidirectional decentralized exchange smart contract deployed on the blockchain, a second decentralized exchange liquidity redemption initiate transaction; and
update, via at least one processor, the first redemption amount associated with the source crypto asset type to a value specified via the second decentralized exchange liquidity redemption initiate transaction upon determining that a minimum delay threshold rule associated with the decentralized exchange liquidity redemption initiate transaction is not satisfied.

142. The system of embodiment 138, in which the component collection storage is further structured with processor-executable instructions, comprising:
determine, via at least one processor, that the non-fungible token is fully executed upon determining that the available liquidity amount associated with the source crypto asset type is zero.

143. The system of embodiment 142, in which the component collection storage is further structured with processor-executable instructions, comprising:
generate, via at least one processor, an execution alert associated with the non-fungible token via an event notification alert API specified via the non-fungible token.

144. The system of embodiment 143, in which the event notification alert API is accessed off-chain.

145. The system of embodiment 138, in which the component collection storage is further structured with processor-executable instructions, comprising:
update, via at least one processor, a derived crypto assets exchange quotient for exchanging the source crypto asset type and the target crypto asset type upon execution of the decentralized exchange liquidity provision transaction; and
update, via at least one processor, the derived crypto assets exchange quotient for exchanging the source crypto asset type and the target crypto asset type upon execution of the decentralized exchange liquidity redemption confirm transaction.

146. A unidirectional decentralized exchange processor-implemented process, including processing processor-executable instructions via at least one processor from a component collection stored in at least one memory, the component collection storage structured with processor-executable instructions comprising:
obtain, via at least one processor, via a unidirectional decentralized exchange smart contract deployed on a blockchain, a decentralized exchange liquidity provision transaction structured as specifying:
   a crypto assets liquidity tranche datastructure from a plurality of crypto assets liquidity tranche datastructures that constitute a liquidity pool associated with the unidirectional decentralized exchange smart contract,
   a first contribution amount associated with a source crypto asset type,
   a target crypto asset type,
   a limit crypto assets exchange quotient for exchanging the source crypto asset type and the target crypto asset type, and
   a provision blockchain address controlled by a sender of the decentralized exchange liquidity provision transaction;
determine, via at least one processor, a crypto assets exchange quotient for exchanging the source crypto asset type and the target crypto asset type;
execute, via at least one processor, an imbalance rule check for the crypto assets liquidity tranche datastructure, in which the imbalance rule check is executed via a calculation involving:
   a first total amount of crypto assets of the source crypto asset type locked in the crypto assets liquidity tranche datastructure;
   a second total amount of crypto assets of the target crypto asset type locked in the crypto assets liquidity tranche datastructure;
   the crypto assets exchange quotient, and
   the first contribution amount associated with the source crypto asset type; and
mint, via at least one processor, a non-fungible token specific to the crypto assets liquidity tranche datastructure, in which the non-fungible token is associated with the provision blockchain address controlled by the sender of the decentralized exchange liquidity provision transaction, and in which the non-fungible token comprises metadata structured as specifying:
   an available liquidity amount associated with the source crypto asset type, in which the available liquidity amount is initialized to the first contribution amount associated with the source crypto asset type,
   an executed quantity associated with the target crypto asset type, and
   the limit crypto assets exchange quotient for exchanging the source crypto asset type and the target crypto asset type.

147. The process of embodiment 146, in which the component collection storage is further structured with processor-executable instructions, comprising:
update, via at least one processor, source crypto assets balance for the crypto assets liquidity tranche datastructure to reflect contribution of the first contribution amount associated with the source crypto asset type.

148. The process of embodiment 146, in which the instructions to determine the crypto assets exchange quotient are structured as instructions to query a price oracle.

149. The process of embodiment 148, in which the component collection storage is further structured with processor-executable instructions, comprising:
verify, via at least one processor, exchange quotient fidelity associated with the crypto assets exchange quotient by checking compliance of a confidence measure provided by the price oracle with a confidence measure threshold rule.

150. The process of embodiment 148, in which the instructions to determine the crypto assets exchange quotient are structured as instructions to utilize a derived crypto assets exchange quotient upon determining that a timestamp associated with the derived crypto assets exchange quotient is more recent than a timestamp associated with a crypto assets exchange quotient from the price oracle.

151. The process of embodiment 146, in which the non-fungible token comprises metadata further structured as specifying an event notification alert API.

152. The process of embodiment 146, in which the non-fungible token comprises metadata further structured as specifying the available liquidity amount associated with the source crypto asset type via a displayed liquidity amount and a non-displayed liquidity amount, in which the non-displayed liquidity amount is encrypted.

153. The process of embodiment 146, in which the component collection storage is further structured with processor-executable instructions, comprising:
obtain, via at least one processor, via the unidirectional decentralized exchange smart contract deployed on the blockchain, a decentralized exchange liquidity redemption initiate transaction structured as specifying:
   the crypto assets liquidity tranche datastructure,
   an identifier of the non-fungible token specific to the crypto assets liquidity tranche datastructure,
   a first redemption amount associated with the source crypto asset type, and
   a redemption blockchain address controlled by a sender of the decentralized exchange liquidity redemption initiate transaction;
determine, via at least one processor, a timestamp associated with the decentralized exchange liquidity redemption initiate transaction;
adjust, via at least one processor, the available liquidity amount associated with the source crypto asset type via a calculation involving the first redemption amount upon determining that a minimum delay threshold rule associated with the decentralized exchange liquidity redemption initiate transaction is satisfied by checking the timestamp associated with the decentralized exchange liquidity redemption initiate transaction with regard to a minimum delay period;
obtain, via at least one processor, via the unidirectional decentralized exchange smart contract deployed on the blockchain, a decentralized exchange liquidity redemption confirm transaction corresponding to the decentralized exchange liquidity redemption initiate transaction;
calculate, via at least one processor, a second redemption amount associated with the source crypto asset type via a calculation involving:
   the first redemption amount associated with the source crypto asset type, and
   the available liquidity amount associated with the source crypto asset type, in which the available liquidity amount specifies a remaining liquidity amount associated with the non-fungible token; and
transfer, via at least one processor, the calculated second redemption amount of crypto assets of the source crypto asset type to the provision blockchain address controlled by the sender of the decentralized exchange liquidity redemption initiate transaction.

154. The process of embodiment 153, in which the component collection storage is further structured with processor-executable instructions, comprising:
update, via at least one processor, crypto assets balances for the crypto assets liquidity tranche datastructure to reflect redemption of the second redemption amount associated with the source crypto asset type.

155. The process of embodiment 153, in which the first redemption amount is structured as specifying a displayed liquidity redemption amount and a non-displayed liquidity redemption amount.

156. The process of embodiment 153, in which the component collection storage is further structured with processor-executable instructions, comprising:
obtain, via at least one processor, via the unidirectional decentralized exchange smart contract deployed on the blockchain, a second decentralized exchange liquidity redemption initiate transaction; and
update, via at least one processor, the first redemption amount associated with the source crypto asset type to a value specified via the second decentralized exchange liquidity redemption initiate transaction upon determining that a minimum delay threshold rule associated with the decentralized exchange liquidity redemption initiate transaction is not satisfied.

157. The process of embodiment 153, in which the component collection storage is further structured with processor-executable instructions, comprising:
determine, via at least one processor, that the non-fungible token is fully executed upon determining that the available liquidity amount associated with the source crypto asset type is zero.

158. The process of embodiment 157, in which the component collection storage is further structured with processor-executable instructions, comprising:
generate, via at least one processor, an execution alert associated with the non-fungible token via an event notification alert API specified via the non-fungible token.

159. The process of embodiment 158, in which the event notification alert API is accessed off-chain.

160. The process of embodiment 153, in which the component collection storage is further structured with processor-executable instructions, comprising:
update, via at least one processor, a derived crypto assets exchange quotient for exchanging the source crypto asset type and the target crypto asset type upon execution of the decentralized exchange liquidity provision transaction; and
update, via at least one processor, the derived crypto assets exchange quotient for exchanging the source crypto asset type and the target crypto asset type upon execution of the decentralized exchange liquidity redemption confirm transaction.

### DEPO Controller

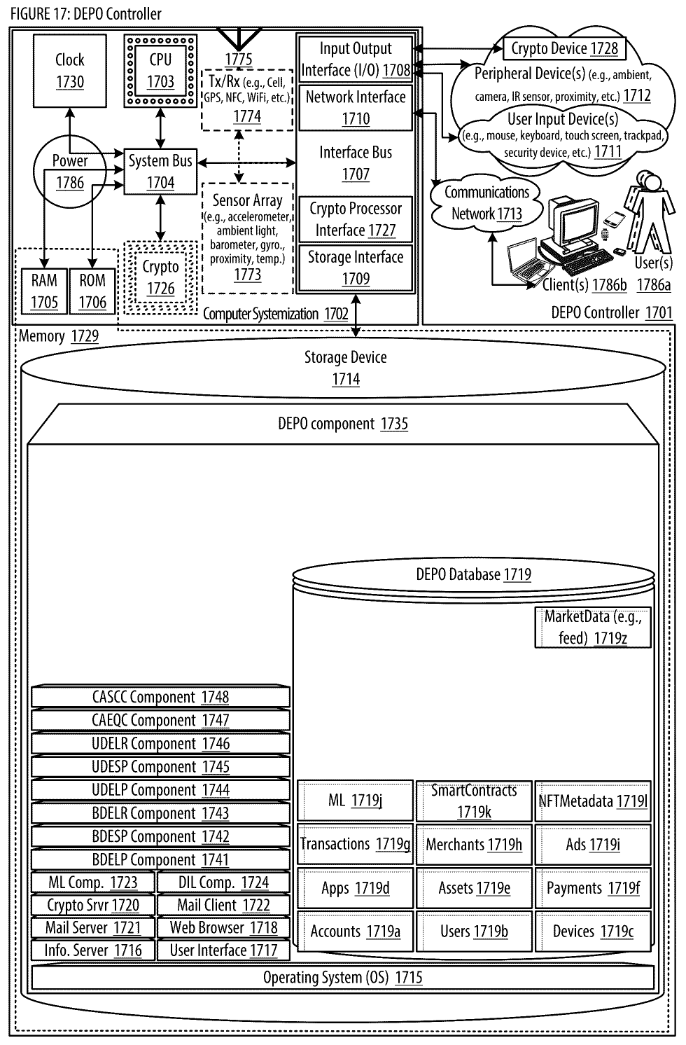

FIG. 17 shows a block diagram illustrating non-limiting, example embodiments of a DEPO controller. In this embodiment, the DEPO controller 1701 may serve to aggregate, process, store, search, serve, identify, instruct, generate, match, and/or facilitate interactions with a computer through information technology technologies, and/or other related data.

Users, which may be people and/or other systems, may engage information technology systems (e.g., computers) to facilitate information processing. In turn, computers employ processors to process information; such processors 1703 may be referred to as central processing units (CPU). One form of processor is referred to as a microprocessor. CPUs use communicative circuits to pass binary encoded signals acting as instructions to allow various operations. These instructions may be operational and/or data instructions containing and/or referencing other instructions and data in various processor accessible and operable areas of memory 1729 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the DEPO controller 1701 may be connected to and/or communicate with entities such as, but not limited to: one or more users from peripheral devices 1712 (e.g., user input devices 1711); an optional cryptographic processor device 1728; and/or a communications network 1713.

Networks comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is referred to as a “node.” Networks are generally thought to facilitate the transfer of information from source points to destinations. A node specifically tasked with furthering the passage of information from a source to a destination is called a “router.” There are many forms of networks such as Local Area Networks (LANs), Pico networks, Wide Area Networks (WANs), Wireless Networks (WLANs), etc. For example, the Internet is, generally, an interconnection of a multitude of networks whereby remote clients and servers may access and interoperate with one another.

The DEPO controller 1701 may be based on computer systems that may comprise, but are not limited to, components such as: a computer systemization 1702 connected to memory 1729.

### Computer Systemization

A computer systemization 1702 may comprise a clock 1730, central processing unit (“CPU(s)” and/or “processor(s)” (these terms are used interchangeably throughout the disclosure unless noted to the contrary)) 1703, a memory 1729 (e.g., a read only memory (ROM) 1706, a random access memory (RAM) 1705, etc.), and/or an interface bus 1707, and most frequently, although not necessarily, are all interconnected and/or communicating through a system bus 1704 on one or more (mother)board(s) 1702 having conductive and/or otherwise transportive circuit pathways through which instructions (e.g., binary encoded signals) may travel to effectuate communications, operations, storage, etc. The computer systemization may be connected to a power source 1786; e.g., optionally the power source may be internal. Optionally, a cryptographic processor 1726 may be connected to the system bus.

In another embodiment, the cryptographic processor, transceivers (e.g., ICs) 1774, and/or sensor array (e.g., accelerometer, altimeter, ambient light, barometer, global positioning system (GPS) (thereby allowing DEPO controller to determine its location), gyroscope, magnetometer, pedometer, proximity, ultra-violet sensor, etc.) 1773 may be connected as either internal and/or external peripheral devices 1712 via the interface bus I/O 1708 (not pictured) and/or directly via the interface bus 1707. In turn, the transceivers may be connected to antenna(s) 1775, thereby effectuating wireless transmission and reception of various communication and/or sensor protocols; for example the antenna(s) may connect to various transceiver chipsets (depending on deployment needs), including: Broadcom® BCM4329FKUBG transceiver chip (e.g., providing 802.11n, Bluetooth® 2.1+EDR, FM, etc.); a Broadcom® BCM4752 GPS receiver with accelerometer, altimeter, GPS, gyroscope, magnetometer; a Broadcom® BCM4335 transceiver chip (e.g., providing 2G, 3G, and 4G long-term evolution (LTE) cellular communications; 802.11ac, Bluetooth® 4.0 low energy (LE) (e.g., beacon features)); a Broadcom® BCM43341 transceiver chip (e.g., providing 2G, 3G and 4G LTE cellular communications; 802.11g/, Bluetooth® 4.0, near field communication (NFC), FM radio); an Infineon Technologies® X-Gold 618-PMB9800 transceiver chip (e.g., providing 2G/3G HSDPA/HSUPA communications); a MediaTek® MT6620 transceiver chip (e.g., providing 802.11a/ac/b/g/n (also known as WiFi® in numerous iterations), Bluetooth® 4.0 LE, FM, GPS; a Lapis Semiconductor® ML8511 UV sensor; a Maxim Integrated® MAX44000 ambient light and infrared proximity sensor; a Texas Instruments® WiLink® WL1283 transceiver chip (e.g., providing 802.11n, Bluetooth® 3.0, FM, GPS); and/or the like. The system clock may have a crystal oscillator and generates a base signal through the computer systemization's circuit pathways. The clock may be coupled to the system bus and various clock multipliers that may increase or decrease the base operating frequency for other components interconnected in the computer systemization. The clock and various components in a computer systemization drive signals embodying information throughout the system. Such transmission and reception of instructions embodying information throughout a computer systemization may be referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU is often packaged in a number of formats varying from large supercomputer(s) and mainframe(s) computers, down to mini computers, servers, desktop computers, laptops, thin clients (e.g., Chromebooks®), netbooks, tablets (e.g., Android®, iPads®, and Windows® tablets, etc.), mobile smartphones (e.g., Android®, iPhones®, Nokia®, Palm® and Windows® phones, etc.), wearable device(s) (e.g., headsets (e.g., Apple AirPods (Pro)®, glasses, goggles (e.g., Google Glass®), watches, etc.), and/or the like. Often, the processors themselves may incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 1729 beyond the processor itself; internal memory may include, but is not limited to: fast registers, various levels of cache memory (e.g., level 1, 2, 3, etc.), (dynamic/static) RAM, solid state memory, etc. The processor may access this memory through the use of a memory address space that is accessible via instruction address, which the processor can construct and decode allowing it to access a circuit path to a specific memory address space having a memory state. The CPU may be a microprocessor such as: AMD's® Athlon®, Duron® and/or Opteron®; Apple's® A, M, S, U series of processors (e.g., A5, A6, A7, A8 . . . M1, M2..S1, S2 . . . U1 . . . etc.); ARM's® application, embedded and secure processors; IBM® and/or Motorola's DragonBall® and PowerPC®; IBM's® and Sony's® Cell processor; Intel's® 80X86 series (e.g., 80386, 80486), Pentium®, Celeron®, Core (2) Duo®, i series (e.g., i3, i5, i7, i9, etc.), Itanium®, Xeon®, and/or XScale®; Motorola's® 680X0 series (e.g., 68020, 68030, 68040, etc.); and/or the like processor(s). The CPU interacts with memory through instruction passing through conductive and/or transportive conduits (e.g., (printed) electronic and/or optic circuits) to execute stored instructions (i.e., program code), e.g., via load/read address commands; e.g., the CPU may read processor issuable instructions from memory (e.g., reading it from a component collection (e.g., an interpreted and/or compiled program application/library including allowing the processor to execute instructions from the application/library) stored in the memory). Such instruction passing facilitates communication within the DEPO controller and beyond through various interfaces. Should processing requirements dictate a greater amount speed and/or capacity, distributed processors (e.g., see Distributed DEPO below), mainframe, multi-core, parallel, and/or super-computer architectures may similarly be employed. Alternatively, should deployment requirements dictate greater portability, smaller mobile devices (e.g., Personal Digital Assistants (PDAs)) may be employed.

Depending on the particular implementation, features of the DEPO may be achieved by implementing a microcontroller such as CAST's® R8051XC2 microcontroller; Diligent's® Basys 3 Artix-7, Nexys A7-100T, U192015125IT, etc.; Intel's® MCS 51 (i.e., 8051 microcontroller); and/or the like. Also, to implement certain features of the DEPO, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the DEPO component collection (distributed or otherwise) and/or features may be implemented via the microprocessor and/or via embedded components; e.g., via ASIC, coprocessor, DSP, FPGA, and/or the like. Alternately, some implementations of the DEPO may be implemented with embedded components that are configured and used to achieve a variety of features or signal processing.

Depending on the particular implementation, the embedded components may include software solutions, hardware solutions, and/or some combination of both hardware/software solutions. For example, DEPO features discussed herein may be achieved through implementing FPGAs, which are a semiconductor devices containing programmable logic components called “logic blocks”, and programmable interconnects, such as the high performance FPGA Virtex® series and/or the low cost Spartan® series manufactured by Xilinx®. Logic blocks and interconnects can be programmed by the customer or designer, after the FPGA is manufactured, to implement any of the DEPO features. A hierarchy of programmable interconnects allow logic blocks to be interconnected as needed by the DEPO system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the DEPO may be developed on FPGAs and then migrated into a fixed version that more resembles ASIC implementations. Alternate or coordinating implementations may migrate DEPO controller features to a final ASIC instead of or in addition to FPGAs. Depending on the implementation all of the aforementioned embedded components and microprocessors may be considered the “CPU” and/or “processor” for the DEPO.

### Power Source

The power source 1786 may be of any various form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1786 is connected to at least one of the interconnected subsequent components of the DEPO thereby providing an electric current to all subsequent components. In one example, the power source 1786 is connected to the system bus component 1704. In an alternative embodiment, an outside power source 1786 is provided through a connection across the I/O 1708 interface. For example, Ethernet (with power on Ethernet), IEEE 1394, USB and/or the like connections carry both data and power across the connection and is therefore a suitable source of power.

### Interface Adapters

Interface bus(ses) 1707 may accept, connect, and/or communicate to a number of interface adapters, variously although not necessarily in the form of adapter cards, such as but not limited to: input output interfaces (I/O) 1708, storage interfaces 1709, network interfaces 1710, and/or the like. Optionally, cryptographic processor interfaces 1727 similarly may be connected to the interface bus. The interface bus provides for the communications of interface adapters with one another as well as with other components of the computer systemization. Interface adapters are adapted for a compatible interface bus. Interface adapters variously connect to the interface bus via a slot architecture. Various slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1709 may accept, communicate, and/or connect to a number of storage devices such as, but not limited to: (removable) storage devices 1714, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE®) 1394, fiber channel, Non-Volatile Memory (NVM) Express (NVMe), Small Computer Systems Interface (SCSI), Thunderbolt, Universal Serial Bus (USB), and/or the like.

Network interfaces 1710 may accept, communicate, and/or connect to a communications network 1713. Through a communications network 1713, the DEPO controller is accessible through remote clients 1733b (e.g., computers with web browsers) by users 1733a. Network interfaces may employ connection protocols such as, but not limited to: direct connect, Ethernet (thick, thin, twisted pair 10/100/1000/10000 Base T, and/or the like), Token Ring, wireless connection such as IEEE 802.11a-x, and/or the like. Should processing requirements dictate a greater amount speed and/or capacity, distributed network controllers (e.g., see Distributed DEPO below), architectures may similarly be employed to pool, load balance, and/or otherwise decrease/increase the communicative bandwidth required by the DEPO controller. A communications network may be any one and/or the combination of the following: a direct interconnection; the Internet; Interplanetary Internet (e.g., Coherent File Distribution Protocol (CFDP), Space Communications Protocol Specifications (SCPS), etc.); a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a cellular, WiFi®, Wireless Application Protocol (WAP), I-mode, and/or the like); and/or the like. A network interface may be regarded as a specialized form of an input output interface. Further, multiple network interfaces 1710 may be used to engage with various communications network types 1713. For example, multiple network interfaces may be employed to allow for the communication over broadcast, multicast, and/or unicast networks.

Input Output interfaces (I/O) 1708 may accept, communicate, and/or connect to user, peripheral devices 1712 (e.g., input devices 1711), cryptographic processor devices 1728, and/or the like. I/O may employ connection protocols such as, but not limited to: audio: analog, digital, monaural, RCA, stereo, and/or the like; data: Apple Desktop Bus (ADB)®, IEEE 1394a-b, serial, universal serial bus (USB); infrared; joystick; keyboard; midi; optical; PC AT; PS/2; parallel; radio; touch interfaces: capacitive, optical, resistive, etc. displays; video interface: Apple Desktop Connector (ADC), BNC, coaxial, component, composite, digital, Digital Visual Interface (DVI), (mini) displayport, high-definition multimedia interface (HDMI), RCA, RF antennae, S-Video, Thunderbolt®/USB-C, VGA, and/or the like; wireless transceivers: 802.11a/ac/b/g/n/x; Bluetooth®; cellular (e.g., code division multiple access (CDMA), high speed packet access (HSPA(+)), high-speed downlink packet access (HSDPA), global system for mobile communications (GSM), long term evolution (LTE), WiMax®, etc.); and/or the like. One output device may include a video display, which may comprise a Cathode Ray Tube (CRT), Liquid Crystal Display (LCD), Light-Emitting Diode (LED), Organic Light-Emitting Diode (OLED), and/or the like based monitor with an interface (e.g., HDMI circuitry and cable) that accepts signals from a video interface, may be used. The video interface composites information generated by a computer systemization and generates video signals based on the composited information in a video memory frame. Another output device is a television set, which accepts signals from a video interface. The video interface provides the composited video information through a video connection interface that accepts a video display interface (e.g., an RCA composite video connector accepting an RCA composite video cable; a DVI connector accepting a DVI display cable, etc.).

Peripheral devices 1712 may be connected and/or communicate to I/O and/or other facilities of the like such as network interfaces, storage interfaces, directly to the interface bus, system bus, the CPU, and/or the like. Peripheral devices may be external, internal and/or part of the DEPO controller. Peripheral devices may include: antenna, audio devices (e.g., line-in, line-out, microphone input, speakers, etc.), cameras (e.g., gesture (e.g., Microsoft Kinect®) detection, motion detection, still, video, webcam, etc.), dongles (e.g., for copy protection ensuring secure transactions with a digital signature, as connection/format adaptors, and/or the like), external processors (for added capabilities; e.g., crypto devices 528), force-feedback devices (e.g., vibrating motors), infrared (IR) transceiver, network interfaces, printers, scanners, sensors/sensor arrays and peripheral extensions (e.g., ambient light, GPS, gyroscopes, proximity, temperature, etc.), storage devices, transceivers (e.g., cellular, GPS, etc.), video devices (e.g., goggles, monitors, etc.), video sources, visors, and/or the like. Peripheral devices often include types of input devices (e.g., cameras).

User input devices 1711 often are a type of peripheral device 512 (see above) and may include: accelerometers, cameras, card readers, dongles, finger print readers, gloves, graphics tablets, joysticks, keyboards, microphones, mouse (mice), remote controls, security/biometric devices (e.g., facial identifiers, fingerprint reader, iris reader, retina reader, etc.), styluses, touch screens (e.g., capacitive, resistive, etc.), trackballs, trackpads, watches, and/or the like.

It should be noted that although user input devices and peripheral devices may be employed, the DEPO controller may be embodied as an embedded, dedicated, and/or monitor-less (i.e., headless) device, and access may be provided over a network interface connection.

Cryptographic units such as, but not limited to, microcontrollers, processors 1726, interfaces 1727, and/or devices 1728 may be attached, and/or communicate with the DEPO controller. A MC68HC16 microcontroller, manufactured by Motorola, Inc.®, may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions.

Cryptographic units may also be configured as part of the CPU. Equivalent microcontrollers and/or processors may also be used. Other specialized cryptographic processors include: Broadcom's® CryptoNetX and other Security Processors; nCipher's® nShield; SafeNet's® Luna PCI (e.g., 7100) series; Semaphore Communications'®40 MHz Roadrunner 184; Sun's® Cryptographic Accelerators (e.g., Accelerator 6000 PCIe Board, Accelerator 500 Daughtercard); Via Nano® Processor (e.g., L2100, L2200, U2400) line, which is capable of performing 500+MB/s of cryptographic instructions; VLSI Technology's®33 MHz 6868; and/or the like.

### Memory

Generally, any mechanization and/or embodiment allowing a processor to affect the storage and/or retrieval of information is regarded as memory 1729. The storing of information in memory may result in a physical alteration of the memory to have a different physical state that makes the memory a (e.g., physical) structure with a unique encoding of the memory stored therein. While memory is often physical and/or non-transitory, short term transitory memories may also be employed in various contexts, e.g., network communication may also be employed to send data as signals acting as transitory as well, for applications not requiring more long-term storage. Often, memory is a fungible technology and resource, thus, any number of memory embodiments may be employed in lieu of or in concert with one another. It is to be understood that the DEPO controller and/or a computer systemization may employ various forms of memory 1729. For example, a computer systemization may be configured to have the operation of on-chip CPU memory (e.g., registers), RAM, ROM, and any other storage devices performed by a paper punch tape or paper punch card mechanism; however, such an embodiment would result in an extremely slow rate of operation. In one configuration, memory 1729 may include ROM 1706, RAM 1705, and a storage device 1714. A storage device 1714 may be any various computer system storage. Storage devices may include: an array of devices (e.g., Redundant Array of Independent Disks (RAID)); a cache memory, a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); RAM drives; register memory (e.g., in a CPU), solid state memory devices (USB memory, solid state drives (SSD), etc.); other processor-readable storage mediums; and/or other devices of the like. Thus, a computer systemization generally employs and makes use of memory.

### Component Collection

The memory 1729 may contain a collection of processor-executable application/library/program and/or database components (e.g., including processor-executable instructions) and/or data such as, but not limited to: operating system component(s) 1715 (operating system); information server component(s) 1716 (information server); user interface component(s) 1717 (user interface); Web browser component(s) 1718 (Web browser); database(s) 1719; mail server component(s) 1721; mail client component(s) 1722; cryptographic server component(s) 1720 (cryptographic server); machine learning component 1723; distributed immutable ledger component 1724; the DEPO component(s) 1735 (e.g., which may include BDELP, BDESP, BDELR, UDELP, UDESP, UDELR, CAEQC, CASCC 1741-1748, and/or the like components); and/or the like (i.e., collectively referred to throughout as a “component collection”). These components may be stored and accessed from the storage devices and/or from storage devices accessible through an interface bus. Although unconventional program components such as those in the component collection may be stored in a local storage device 1714, they may also be loaded and/or stored in memory such as: cache, peripheral devices, processor registers, RAM, remote storage facilities through a communications network, ROM, various forms of memory, and/or the like.

### Operating System

The operating system component 1715 is an executable program component facilitating the operation of the DEPO controller. The operating system may facilitate access of I/O, network interfaces, peripheral devices, storage devices, and/or the like. The operating system may be a highly fault tolerant, scalable, and secure system such as: Apple's Macintosh OS X® (Server) and macOS®; AT&T® Plan 9®; Be OS®; Blackberry's QNX®; Google's Chrome®; Microsoft's Windows® 7/8/10; Unix and Unix-like system distributions (such as AT&T's® UNIX®; Berkley Software Distribution (BSD)® variations such as FreeBSD®, NetBSD®, OpenBSD®, and/or the like; Linux® distributions such as Red Hat®, Ubuntu®, and/or the like); and/or the like operating systems. However, more limited and/or less secure operating systems also may be employed such as Apple Macintosh OS® (i.e., versions 1-9), IBM OS/2®, Microsoft DOS®, Microsoft Windows® 2000/2003/3.1/95/98/CE/Millennium/Mobile/NT/Vista/XP/7/X (Server)®, Palm OS®, and/or the like. Additionally, for robust mobile deployment applications, mobile operating systems may be used, such as: Apple's iOS®; China Operating System COS®; Google's Android®; Microsoft® Windows® RT/Phone®; Palm's WebOS®; Samsung®/Intel's Tizen®; and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may facilitate the interaction with communications networks, data, I/O, peripheral devices, program components, memory, user input devices, and/or the like. The operating system may provide communications protocols that allow the DEPO controller to communicate with other entities through a communications network 1713. Various communication protocols may be used by the DEPO controller as a subcarrier transport mechanism for interaction, such as, but not limited to: multicast, TCP/IP, UDP, unicast, and/or the like.

### Information Server

An information server component 1716 is a stored program component that is executed by a CPU. The information server may be an Internet information server such as, but not limited to Apache Software Foundation's Apache®, Microsoft's Internet Information Server®, and/or the like. The information server may allow for the execution of program components through facilities such as Active Server Page (ASP), ActiveX, (ANSI) (Objective-) C (++), C# and/or .NET®, Common Gateway Interface (CGI) scripts, dynamic (D) hypertext markup language (HTML), FLASH®, Java®, JavaScript®, Practical Extraction Report Language (PERL)®, Hypertext Pre-Processor (PHP), pipes, Python®, Ruby, wireless application protocol (WAP), WebObjects®, and/or the like. The information server may support secure communications protocols such as, but not limited to, File Transfer Protocol (FTP(S)); HyperText Transfer Protocol (HTTP); Secure Hypertext Transfer Protocol (HTTPS), Secure Socket Layer (SSL) Transport Layer Security (TLS), messaging protocols (e.g., America Online (AOL®) Instant Messenger (AIM)®, Application Exchange (APEX), ICQ, Internet Relay Chat (IRC), Microsoft Network (MSN) Messenger® Service, Presence and Instant Messaging Protocol (PRIM), Internet Engineering Task Force's® (IETF's) Session Initiation Protocol (SIP), SIP for Instant Messaging and Presence Leveraging Extensions (SIMPLE), Slack®, open XML-based Extensible Messaging and Presence Protocol (XMPP) (i.e., Jabber® or Open Mobile Alliance's (OMA's) Instant Messaging and Presence Service (IMPS)), Yahoo!Instant Messenger® Service, and/or the like). The information server may provide results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the DEPO controller based on the remainder of the HTTP request. For example, a request such as http://followed by the address, e.g., 123.124.125.126/mylnformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the DEPO database 1719, operating systems, other program components, user interfaces, Web browsers, and/or the like.

Access to the DEPO database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the DEPO. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in SQL by instantiating a search string with the proper join/select commands based on the tagged text entries, and the resulting command is provided over the bridge mechanism to the DEPO as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as buttons, check boxes, cursors, graphical views, menus, scrollers, text fields, and windows (collectively referred to as widgets) similarly facilitate the access, capabilities, operation, and display of data and computer hardware and operating system resources, and status. Operation interfaces are called user interfaces. Graphical user interfaces (GUIs) such as the Apple's iOS®, Macintosh Operating System's Aqua®; IBM's OS/2®; Google's Chrome® (e.g., and other webbrowser/cloud based client OSs); Microsoft's Windows® 2000/2003/3.1/95/98/CE/Millennium/Mobile/NT/Vista/XP/7/X (Server)®(i.e., Aero, Surface, etc.); Unix's X-Windows (e.g., which may include additional Unix graphic interface libraries and layers such as K Desktop Environment (KDE)®, mythTV and GNU Network Object Model Environment (GNOME))®, web interface libraries (e.g., ActiveX®, AJAX, (D)HTML, FLASH®, Java®, JavaScript®, etc. interface libraries such as, but not limited to, Dojo, jQuery(UI), MooTools, Prototype, script.aculo.us, SWFObject, Yahoo! User Interface®, and/or the like, any of which may be used and) provide a baseline and mechanism of accessing and displaying information graphically to users.

A user interface component 1717 is a stored program component that is executed by a CPU. The user interface may be a graphic user interface as provided by, with, and/or atop operating systems and/or operating environments, and may provide executable library APIs (as may operating systems and the numerous other components noted in the component collection) that allow instruction calls to generate user interface elements such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 1718 is a stored program component that is executed by a CPU. The Web browser may be a hypertext viewing application such as Apple's (mobile) Safari®, Brave Software, Inc.'s Brave Browser (including Virtual Private Network (VPN) features), Google's Chrome®, Microsoft Edge®, Microsoft Internet Explorer®, Mozilla's Firefox®, Netscape Navigator®, The Tor Project, Inc,'s Tor Browser® (including VPN features), and/or the like. Secure Web browsing may be supplied with 128 bit (or greater) encryption by way of HTTPS, SSL, and/or the like. Web browsers allowing for the execution of program components through facilities such as ActiveX®, AJAX, (D)HTML, FLASH®, Java®, JavaScript®, web browser plug-in APIs (e.g., FireFox®, Safari® Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the DEPO enabled nodes. The combined application may be nugatory on systems employing Web browsers.

### Mail Server

A mail server component 1721 is a stored program component that is executed by a CPU 1703. The mail server may be an Internet mail server such as, but not limited to: dovecot, Courier IMAP, Cyrus IMAP, Maildir, Microsoft Exchange®, sendmail, and/or the like. The mail server may allow for the execution of program components through facilities such as ASP, ActiveX®, (ANSI) (Objective-) C (++), C# and/or .NET, CGI scripts, Java®, JavaScript®, PERL®, PHP, pipes, Python®, WebObjects®, and/or the like. The mail server may support communications protocols such as, but not limited to: Internet message access protocol (IMAP), Messaging Application Programming Interface (MAPI)/Microsoft Exchange®, post office protocol (POP3), simple mail transfer protocol (SMTP), and/or the like. The mail server can route, forward, and process incoming and outgoing mail messages that have been sent, relayed and/or otherwise traversing through and/or to the DEPO. Alternatively, the mail server component may be distributed out to mail service providing entities such as Google's® cloud services (e.g., Gmail® and notifications may alternatively be provided via messenger services such as AOL's Instant Messenger®, Apple's iMessage®, Google Messenger®, SnapChat®, etc.).

Access to the DEPO mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 1722 is a stored program component that is executed by a CPU 1703. The mail client may be a mail viewing application such as Apple Mail®, Microsoft Entourage®, Microsoft Outlook®, Microsoft Outlook Express®, Mozilla®, Thunderbird®, and/or the like. Mail clients may support a number of transfer protocols, such as: IMAP, Microsoft Exchange®, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 1720 is a stored program component that is executed by a CPU 1703, cryptographic processor 1726, cryptographic processor interface 1727, cryptographic processor device 1728, and/or the like. Cryptographic processor interfaces may allow for expedition of encryption and/or decryption requests by the cryptographic component; however, the cryptographic component, alternatively, may run on a CPU and/or GPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component facilitates numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), Transport Layer Security (TLS), and/or the like. Employing such encryption security protocols, the DEPO may encrypt all incoming and/or outgoing communications and may serve as node within a virtual private network (VPN) with a wider communications network. The cryptographic component facilitates the process of “security authorization” whereby access to a resource is inhibited by a security protocol and the cryptographic component effects authorized access to the secured resource. In addition, the cryptographic component may provide unique identifiers of content, e.g., employing an MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to allow the DEPO component to engage in secure transactions if so desired. The cryptographic component facilitates the secure accessing of resources on the DEPO and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### Machine Learning (ML)

In one non limiting embodiment, the DEPO includes a machine learning component 1723, which may be a stored program component that is executed by a CPU 1703. The machine learning component, alternatively, may run on a set of specialized processors, ASICs, FPGAs, GPUs, and/or the like. The machine learning component may be deployed to execute serially, in parallel, distributed, and/or the like, such as by utilizing cloud computing. The machine learning component may employ an ML platform such as Amazon SageMaker, Azure® Machine Learning, DataRobot Al Cloud, Google Al Platform, IBM Watson® Studio, and/or the like. The machine learning component may be implemented using an ML framework such as PyTorch, Apache MXNet, MathWorks Deep Learning Toolbox, scikit-learn, TensorFlow, XGBoost, and/or the like. The machine learning component facilitates training and/or testing of ML prediction logic data structures (e.g., models) and/or utilizing ML prediction logic data structures (e.g., models) to output ML predictions by the DEPO. The machine learning component may employ various artificial intelligence and/or learning mechanisms such as Reinforcement Learning, Supervised Learning, Unsupervised Learning, and/or the like. The machine learning component may employ ML prediction logic data structure (e.g., model) types such as Bayesian Networks, Classification prediction logic data structures (e.g., models), Decision Trees, Neural Networks (NNs), Regression prediction logic data structures (e.g., models), and/or the like.

### Distributed Immutable Ledger (DIL)

In one non limiting embodiment, the DEPO includes a distributed immutable ledger component 1724, which may be a stored program component that is executed by a CPU 1703. The distributed immutable ledger component, alternatively, may run on a set of specialized processors, ASICs, FPGAs, GPUs, and/or the like. The distributed immutable ledger component may be deployed to execute serially, in parallel, distributed, and/or the like, such as by utilizing a peer-to-peer network. The distributed immutable ledger component may be implemented as a blockchain (e.g., public blockchain, private blockchain, hybrid blockchain) that comprises cryptographically linked records (e.g., blocks). The distributed immutable ledger component may employ a platform such as Bitcoin, Bitcoin Cash, Dogecoin, Ethereum, Litecoin, Monero, Zcash, and/or the like. The distributed immutable ledger component may employ a consensus mechanism such as proof of authority, proof of space, proof of steak, proof of work, and/or the like. The distributed immutable ledger component may be used to provide functionality such as data storage, cryptocurrency, inventory tracking, non-fungible tokens (NFTs), smart contracts, and/or the like.

### The DEPO Database

The DEPO database component 1719 may be embodied in a database and its stored data. The database is a stored program component, which is executed by the CPU; the stored program component portion configuring the CPU to process the stored data. The database may be a fault tolerant, relational, scalable, secure database such as Claris FileMaker®, MySQL®, Oracle®, Sybase®, etc. may be used. Additionally, optimized fast memory and distributed databases such as IBM's Netezza®, MongoDB's MongoDB®, opensource Hadoop®, opensource VoltDB, SAP's Hana®, etc. Relational databases are an extension of a flat file. Relational databases include a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. Alternative key fields may be used from any of the fields having unique value sets, and in some alternatives, even non-unique values in combinations with other fields. More precisely, they uniquely identify rows of a table on the “one” side of a one-to-many relationship.

Alternatively, the DEPO database may be implemented using various other data-structures, such as an array, hash, (linked) list, struct, structured text file (e.g., XML), table, flat file database, and/or the like. Such data-structures may be stored in memory and/or in (structured) files. In another alternative, an object-oriented database may be used, such as Frontier™, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the DEPO database is implemented as a data-structure, the use of the DEPO database 1719 may be integrated into another component such as the DEPO component 1735. Also, the database may be implemented as a mix of data structures, objects, programs, relational structures, scripts, and/or the like. Databases may be consolidated and/or distributed in countless variations (e.g., see Distributed DEPO below). Portions of databases, e.g., tables, may be exported and/or imported and thus decentralized and/or integrated.

In another embodiment, the database component (and/or other storage mechanism of the DEPO) may store data immutably so that tampering with the data becomes physically impossible and the fidelity and security of the data may be assured. In some embodiments, the database may be stored to write only or write once, read many (WORM) mediums. In another embodiment, the data may be stored on distributed ledger systems (e.g., via blockchain) so that any tampering to entries would be readily identifiable. In one embodiment, the database component may employ the distributed immutable ledger component DIL 1724 mechanism.

In one embodiment, the database component 1719 includes several tables representative of the schema, tables, structures, keys, entities and relationships of the described database 1719a-z:
An accounts table 1719a includes fields such as, but not limited to: an accountID, accountOwnerID, accountContactID, assetIDs, deviceIDs, paymentIDs, transactionIDs, userIDs, accountType (e.g., agent, entity (e.g., corporate, non-profit, partnership, etc.), individual, etc.), accountCreationDate, accountUpdateDate, accountName, accountNumber, routingNumber, linkWalletsID, accountPrioritAccaountRatio, accountAddress, accountState, accountZIPcode, accountCountry, accountEmail, accountPhone, accountAuthKey, accountIPaddress, accountURLAccessCode, accountPortNo, accountAuthorizationCode, accountAccessPrivileges, accountPreferences, accountRestrictions, and/or the like;
A users table 1719b includes fields such as, but not limited to: a userID, userSSN, taxID, userContactID, accountID, assetIDs, deviceIDs, paymentIDs, transactionIDs, userType (e.g., agent, entity (e.g., corporate, non-profit, partnership, etc.), individual, etc.), namePrefix, firstName, middleName, lastName, nameSuffix, DateOfBirth, userAge, userName, userEmail, userSocialAccountID, contactType, contactRelationship, userPhone, userAddress, userCity, userState, userZIPCode, userCountry, userAuthorizationCode, userAccessPrivilges, userPreferences, userRestrictions, and/or the like (the user table may support and/or track multiple entity accounts on a DEPO);
An devices table 1719c includes fields such as, but not limited to: deviceID, sensorIDs, accountID, assetIDs, paymentIDs, deviceType, deviceName, deviceManufacturer, deviceModel, deviceVersion, deviceSerialNo, deviceIPaddress, deviceMACaddress, device_ECID, deviceUUID, deviceLocation, deviceCertificate, deviceOS, appIDs, deviceResources, deviceSession, authKey, deviceSecureKey, walletAppInstalledFlag, deviceAccessPrivileges, devicePreferences, deviceRestrictions, hardware_config, software_config, storage_location, sensor_value, pin_reading, data length, channel_requirement, sensor_name, sensor_model_no, sensor_manufacturer, sensor_type, sensor_serial_number, sensor_power_requirement, device_power_requirement, location, sensor_associated_tool, sensor_dimensions, device_dimensions, sensor_communications_type, device_communications_type, power_percentage, power_condition, temperature_setting, speed_adjust, hold_duration, part_actuation, and/or the like. Device table may, in some embodiments, include fields corresponding to one or more Bluetooth® profiles, such as those published at www.bluetooth.org/en-us/specification/adopted-specifications, and/or other device specifications, and/or the like;
An apps table 1719d includes fields such as, but not limited to: appID, appName, appType, appDependencies, accountID, deviceIDs, transactionID, userID, appStoreAuthKey, appStoreAccountID, appStoreIPaddress, appStoreURLaccessCode, appStorePortNo, appAccessPrivileges, appPreferences, appRestrictions, portNum, access_API_call, linked_wallets_list, and/or the like;
An assets table 1719e includes fields such as, but not limited to: assetID, accountID, userID, distributorAccountID, distributorPaymentID, distributorOnwerlD, assetOwnerID, assetType, assetSourceDeviceID, assetSourceDeviceType, assetSourceDeviceName, assetSourceDistributionChannelID, assetSourceDistributionChannelType, assetSourceDistributionChannelName, assetTargetChannelID, assetTargetChannelType, assetTargetChannelName, assetName, assetSeriesName, assetSeriesSeason, assetSeriesEpisode, assetCode, assetQuantity, assetCost, assetPrice, assetValue, assetManufactuer, assetModelNo, assetSerialNo, assetLocation, assetAddress, assetState, assetZIPcode, assetState, assetCountry, assetEmail, assetIPaddress, assetURLaccessCode, assetOwnerAccountID, subscriptionIDs, assetAuthroizationCode, assetAccessPrivileges, assetPreferences, assetRestrictions, assetAPI, assetAPIconnectionAddress, and/or the like;
A payments table 1719f includes fields such as, but not limited to: paymentID, accountID, userID, couponID, couponValue, couponConditions, couponExpiration, paymentType, paymentAccountNo, paymentAccountName, paymentAccountAuthorizationCodes, paymentExpirationDate, paymentCCV, paymentRoutingNo, paymentRoutingType, paymentAddress, paymentState, paymentZIPcode, paymentCountry, paymentEmail, paymentAuthKey, paymentIPaddress, paymentURLaccessCode, paymentPortNo, paymentAccessPrivileges, paymentPreferences, payementRestrictions, and/or the like;
An transactions table 1719g includes fields such as, but not limited to: transactionID, accountID, assetIDs, deviceIDs, paymentIDs, transactionIDs, userID, merchantID, transactionType, transactionDate, transactionTime, transactionAmount, transactionQuantity, transactionDetails, productsList, productType, productTitle, productsSummary, productParamsList, transactionNo, transactionAccessPrivileges, transactionPreferences, transactionRestrictions, merchantAuthKey, merchantAuthCode, and/or the like;
An merchants table 1719h includes fields such as, but not limited to: merchantID, merchantTaxID, merchanteName, merchantContactUserID, accountID, issuerID, acquirerID, merchantEmail, merchantAddress, merchantState, merchantZIPcode, merchantCountry, merchantAuthKey, merchantIPaddress, portNum, merchantURLaccessCode, merchantPortNo, merchantAccessPrivileges, merchantPreferences, merchantRestrictions, and/or the like;
An ads table 1719i includes fields such as, but not limited to: adID, advertiserID, adMerchantID, adNetworkID, adName, adTags, advertiserName, adSponsor, adTime, adGeo, adAttributes, adFormat, adProduct, adText, adMedia, adMedialD, adChannelID, adTagTime, adAudioSignature, adHash, adTemplateID, adTemplateData, adSourceID, adSourceName, adSourceServerIP, adSourceURL, adSourceSecurityProtocol, adSourceFTP, adAuthKey, adAccessPrivileges, adPreferences, adRestrictions, adNetworkXchangeID, adNetworkXchangeName, adNetworkXchangeCost, adNetworkXchangeMetricType (e.g., CPA, CPC, CPM, CTR, etc.), adNetworkXchangeMetricValue, adNetworkXchangeServer, adNetworkXchangePortNumber, publisherID, publisherAddress, publisherURL, publisherTag, publisherIndustry, publisherName, publisherDescription, siteDomain, siteURL, siteContent, siteTag, siteContext, siteImpression, siteVisits, siteHeadline, sitePage, siteAdPrice, sitePlacement, sitePosition, bidID, bidExchange, bidOS, bidTarget, bidTimestamp, bidPrice, bidImpressionID, bidType, bidScore, adType (e.g., mobile, desktop, wearable, largescreen, interstitial, etc.), assetID, merchantID, deviceID, userID, accountID, impressionID, impressionOS, impressionTimeStamp, impressionGeo, impressionAction, impressionType, impressionPublisherID, impressionPublisherURL, and/or the like;
An ML table 1719j includes fields such as, but not limited to: MLID, predictionLogicStructureID, predictionLogicStructureType, predictionLogicStructureConfiguration, predictionLogicStructureTrainedStructure, predictionLogicStructureTrainingData, predictionLogicStructureTrainingDataConfiguration, predictionLogicStructureTestingData, predictionLogicStructureTestingDataConfiguration, predictionLogicStructureOutputData, predictionLogicStructureOutputDataConfiguration, and/or the like;
A smart contracts table 1719k includes fields such as, but not limited to: smartContractID, smartContractType, smartContractParameters, smartContract_CALT_datastructures, and/or the like;
An NFTMetadata table 17191 includes fields such as, but not limited to: NFT_ID, NFT_metadata, and/or the like;
A market_data table 1719z includes fields such as, but not limited to: market_data_feed_ID, asset_ID, asset_symbol, asset_name, spot_price, bid_price, ask_price, and/or the like; in one embodiment, the market data table is populated through a market data feed (e.g., Bloomberg's PhatPipe®, Consolidated Quote System® (CQS), Consolidated Tape Association® (CTA), Consolidated Tape System® (CTS), Dun & Bradstreet®, OTC Montage Data Feed® (OMDF), Reuter's Tib®, Triarch®, US equity trade and quote market data®, Unlisted Trading Privileges® (UTP) Trade Data Feed® (UTDF), UTP Quotation Data Feed® (UQDF), and/or the like feeds, e.g., via ITC 2.1 and/or respective feed protocols), for example, through Microsoft's® Active Template Library and Dealing Object Technology's real-time toolkit Rtt.Multi.

In one embodiment, the DEPO database may interact with other database systems. For example, employing a distributed database system, queries and data access by search DEPO component may treat the combination of the DEPO database, an integrated data security layer database as a single database entity (e.g., see Distributed DEPO below).

In one embodiment, user programs may contain various user interface primitives, which may serve to update the DEPO. Also, various accounts may require custom database tables depending upon the environments and the types of clients the DEPO may need to serve. It should be noted that any unique fields may be designated as a key field throughout. In an alternative embodiment, these tables have been decentralized into their own databases and their respective database controllers (i.e., individual database controllers for each of the above tables). The DEPO may also be configured to distribute the databases over several computer systemizations and/or storage devices. Similarly, configurations of the decentralized database controllers may be varied by consolidating and/or distributing the various database components 1719a-z. The DEPO may be configured to keep track of various settings, inputs, and parameters via database controllers.

The DEPO database may communicate to and/or with other components in a component collection, including itself, and/or facilities of the like. Most frequently, the DEPO database communicates with the DEPO component, other program components, and/or the like. The database may contain, retain, and provide information regarding other nodes and data.

### The DEPOs

The DEPO component 1735 is a stored program component that is executed by a CPU via stored instruction code configured to engage signals across conductive pathways of the CPU and ISICI controller components. In one embodiment, the DEPO component incorporates any and/or all combinations of the aspects of the DEPO that were discussed in the previous figures. As such, the DEPO affects accessing, obtaining and the provision of information, services, transactions, and/or the like across various communications networks.

The features and embodiments of the DEPO discussed herein increase network efficiency by reducing data transfer requirements with the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., may reduce the capacity and structural infrastructure requirements to support the DEPO's features and facilities, and in many cases reduce the costs, energy consumption/requirements, and extend the life of DEPO's underlying infrastructure; this has the added benefit of making the DEPO more reliable. Similarly, many of the features and mechanisms are designed to be easier for users to use and access, thereby broadening the audience that may enjoy/employ and exploit the feature sets of the DEPO; such ease of use also helps to increase the reliability of the DEPO. In addition, the feature sets include heightened security as noted via the Cryptographic components 1720, 1726, 1728 and throughout, making access to the features and data more reliable and secure

The DEPO transforms decentralized exchange liquidity provision request, decentralized exchange crypto asset swap request, decentralized exchange liquidity redemption request datastructure/inputs, via DEPO components (e.g., BDELP, BDESP, BDELR, UDELP, UDESP, UDELR, CAEQC, CASCC), into decentralized exchange liquidity provision response, decentralized exchange crypto asset swap response, decentralized exchange liquidity redemption response outputs.

The DEPO component facilitates access of information between nodes may be developed by employing various development tools and languages such as, but not limited to: Apache® components, Assembly, ActiveX, binary executables, (ANSI) (Objective-) C (++), C# and/or .NET®, database adapters, CGI scripts, Java®, JavaScript®, mapping tools, procedural and object oriented development tools, PERL®, PHP, Python®, Ruby, shell scripts, SQL commands, web application server extensions, web development environments and libraries (e.g., Microsoft's® ActiveX®; Adobe AIR®, FLEX & FLASH®; AJAX; (D)HTML; Dojo, Java®; JavaScript®; jQuery(UI); MooTools; Prototype; script.aculo.us; Simple Object Access Protocol (SOAP); SWFObject; Yahoo!® User Interface; and/or the like), WebObjects®, and/or the like. In one embodiment, the DEPO server employs a cryptographic server to encrypt and decrypt communications. The DEPO component may communicate to and/or with other components in a component collection, including itself, and/or facilities of the like. Most frequently, the DEPO component communicates with the DEPO database, operating systems, other program components, and/or the like. The DEPO may contain, communicate, generate, obtain, and/or provide program component, system, user, and/or data communications, requests, and/or responses.

### Distributed DEPOs

The structure and/or operation of any of the DEPO node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion. As such, a combination of hardware may be distributed within a location, within a region and/or globally where logical access to a controller may be abstracted as a singular node, yet where a multitude of private, semiprivate and publicly accessible node controllers (e.g., via dispersed data centers) are coordinated to serve requests (e.g., providing private cloud, semi-private cloud, and public cloud computing resources) and allowing for the serving of such requests in discrete regions (e.g., isolated, local, regional, national, global cloud access, etc.).

Thus, DEPO may be implemented with varying functional, logical, operational, organizational, structural and/or topological modifications may be made without departing from the scope and/or spirit of the disclosure. For example, unless expressly described otherwise, it is to be understood that the logical and/or topological structure of any combination of any program components (e.g., of the component collection), other components, data flow order, logic flow order, and/or any present feature sets as described in the figures and/or throughout are not limited to a fixed operating order and/or arrangement, but rather, any disclosed order is exemplary and all equivalents, and the components may execute at the same or different processors. Furthermore, it is to be understood that such features are not limited to serial execution, but rather, any number of threads, processes, services, servers, and/or the like that may execute asymmetrically, asynchronously, batch, concurrently, delayed, dynamically, in parallel, on-demand, periodically, real-time, symmetrically, simultaneously, synchronously, triggered, and/or the like may take place depending on how the components and even individual methods and/or functions are called. For example, in any of the dataflow and/or logic flow descriptions, any individual item and/or method and/or function called may only execute serially and/or asynchronously in a small deployment on a single core machine, but may be executed concurrently, in parallel, simultaneously, synchronously (as well as asynchronously yet still concurrent, in parallel, and/or simultaneously) when deployed on multicore processor or even across multiple machines and in and from multiple machines and geographic regions.

As such, the component collection may be consolidated and/or distributed in countless variations through various data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so as discussed through the disclosure and/or through various other data processing communication techniques. Furthermore, any part or sub parts of the DEPO node controller's component collection (and/or any constituent processing instructions) may be executed on at least one processing unit, where that processing unit may be a sub-unit of a CPU, a core, an entirely different CPU and/or sub-unit at the same location or remotely at a different location, and/or across many multiple such processing units. For example, for load-balancing reasons, parts of the component collection may start to execute on a given CPU core, then the next instruction/execution element of the component collection may (e.g., be moved to) execute on another CPU core, on the same, or completely different CPU at the same or different location, e.g., because the CPU may become over taxed with instruction executions, and as such, a scheduler may move instructions at the taxed CPU and/or CPU sub-unit to another CPU and/or CPU sub-unit with a lesser instruction execution load. In another embodiment, processing may take place on hosted virtual machines such as on Amazon® Data/Web Services (AWS)® where virtual machines literally do not even exist while DEPO is executing, and as processing demands increase, such additional virtual machines may be spun up as necessary and created on the fly to increase processing throughput (e.g., by distributing processing of DEPO component collection processor instructions), and conversely, virtual machines may be spun down and cease to exist as processing demands decrease; these virtual machines may be spun up/down on the same, or in completely remote and physically separate facilities and hardware. As such, it may be difficult and/or impossible to predict on which CPU, processing sub-unit, and/or virtual machine a process instruction begins execution and where it will continue and/or conclude execution, as it may be on the same and/or completely different CPU, processing sub-unit, and/or virtual machine.

The configuration of the DEPO controller may depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like. For example, cloud services such as Amazon Data/Web Services®, Microsoft Azure®, Hewlett Packard Helion®, IBM® Cloud services allow for DEPO controller and/or DEPO component collections to be hosted in full or partially for varying degrees of scale.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON)®, NeXT Computer, Inc.'s® (Dynamic) Object Linking, Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as JSON, lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http://. . . Value1
   where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration may depend upon the context, environment, and requirements of system deployment.

For example, in some implementations, the DEPO controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via an SSL connection, parse the data to extract variables, and store the data to a database, is provided below:

```
<?PHP
header(′Content-Type: text/plain′);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message
do {
  $input = “”;
  $input = socket_read($client, 1024);
  $data .= $input;
} while($input != “”);
// parse data to extract variables
$obj = json_decode($data, true);
// store input data in a database
mysql_connect(″201.408.185.132″,$DBserver,$password); // access
database server
mysql_select(″CLIENT_DB.SQL″); // select database to append
mysql_query(“INSERT INTO UserTable (transmission)
VALUES ($data)”); // add data to UserTable table in a CLIENT database
mysql_close(″CLIENT_DB.SQL″); // close connection to database
?>
```

Also, the following resources may be used to provide example embodiments regarding SOAP parser implementation:
www.xav.com/perl/site/lib/SOAP/Parser. html publib.boulder.ibm.com/infocenter/tivihelp/v2r1/index.jsp?topic=/com.ibm.IBMDI. doc/referenceguide295.htm
   and other parser implementations:
publib.boulder.ibm.com/infocenter/tivihelp/v2r1/index.jsp?topic=/com.ibm.IBMDI. doc/referenceguide259.htm
   all of which are hereby expressly incorporated by reference.

In order to address various issues and advance the art, the entirety of this application for Decentralized Exchange with Price Oracle Apparatuses, Processes and Systems (including the Cover Page, Title, Headings, Field, Background, Summary, Brief Description of the Drawings, Detailed Description, Claims, Abstract, Figures, Appendices, and otherwise) shows, by way of illustration, various non-limiting example embodiments in which the claimed innovations may be practiced. The advantages and features described in the application are of a representative sample of embodiments only, and are not exhaustive and/or exclusive. They are presented to assist in understanding and teach the claimed principles. It should be noted that to the extent any financial and/or investment examples are included, such examples are for illustrative purpose(s) only, and are not, nor should they be interpreted, as investment advice. As such, all examples and/or embodiments are deemed to be non-limiting throughout this disclosure; it should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It may be appreciated that many of those undescribed embodiments incorporate and/or be based of same principles of the innovations and others are equivalent. As such, no inference should be drawn regarding those embodiments discussed herein relative to those not discussed herein other than it is as such for purposes of reducing space and repetition. Consequently, terms such as “lower”, “upper”, “horizontal”, “vertical”, “above”, “below”, “up”, “down”, “top” and “bottom” as well as derivatives thereof (e.g., “horizontally”, “downwardly”, “upwardly”, etc.) should not be construed to limit embodiments, and instead, again, are offered for convenience of description of orientation and/or convenience of reference, and as such, do not require that any embodiments be constructed or operated in a particular orientation unless explicitly indicated as such. Terms such as “attached”, “affixed”, “connected”, “coupled”, “interconnected”, etc. may refer to a relationship where structures are secured or attached to one another either directly or indirectly through intervening structures, as well as both movable or rigid attachments or relationships, unless expressly described otherwise. Similarly, descriptions of embodiments disclosed throughout this disclosure, any reference to direction or orientation is merely intended for convenience of description and/or of reference and is not intended in any way to limit the scope of described embodiments. Furthermore, it is to be understood, unless expressly described otherwise, that other embodiments may be utilized and functional, logical, operational, organizational, structural and/or topological modifications may be made without departing from the scope and/or spirit of the disclosure. For instance, unless expressly described otherwise, it is to be understood that the logical and/or topological structure of any combination of any program components (a component collection), other components, data flow order, logic flow order, and/or any present feature sets as described in the figures and/or throughout are not limited to a fixed operating order and/or arrangement, but rather, any disclosed order is exemplary and all equivalents, regardless of order, are contemplated by the disclosure. Also, it is to be understood that such features are not limited to serial execution, but rather, any number of threads, processes, services, servers, and/or the like that may execute asymmetrically, asynchronously, batch, concurrently, delayed, dynamically, in parallel, on-demand, periodically, real-time, symmetrically, simultaneously, synchronously, triggered, and/or the like are contemplated by the disclosure (e.g., see Distributed DEPO, above, for examples). Consequently, some of these features may be mutually contradictory, in that they cannot be simultaneously present in a single embodiment. Similarly, some features may be applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, provisionals, re-issues, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a DEPO individual and/or enterprise user, database configuration and/or relational model, data type, data transmission and/or network framework, library, syntax structure, and/or the like, various embodiments of the DEPO, may be implemented that allow a great deal of flexibility and customization. While various embodiments and discussions of the DEPO have included information technology, however, it is to be understood that the embodiments described herein may be readily configured and/or customized for a wide variety of other applications and/or implementations. For example, aspects of the DEPO also may be adapted for online marketplaces.

What is claimed is:

1. A bidirectional decentralized exchange apparatus, comprising:
at least one memory;
a component collection stored in the at least one memory;
at least one processor disposed in communication with the at least one memory, the at least one processor executing processor-executable instructions from the component collection, the component collection storage structured with processor-executable instructions, comprising:
obtain, via at least one processor, via a bidirectional decentralized exchange smart contract deployed on a blockchain, a decentralized exchange liquidity provision transaction structured as specifying:
a crypto assets liquidity tranche datastructure from a plurality of crypto assets liquidity tranche datastructures that constitute a liquidity pool associated with the bidirectional decentralized exchange smart contract,
a first contribution amount associated with a first crypto asset type,
a second contribution amount associated with a second crypto asset type, and
a provision blockchain address controlled by a sender of the decentralized exchange liquidity provision transaction;
determine, via at least one processor, a crypto assets exchange quotient for exchanging the first crypto asset type and the second crypto asset type;
calculate, via at least one processor, a quantity of fungible tokens specific to the crypto assets liquidity tranche datastructure to generate via a calculation involving:
the first contribution amount associated with the first crypto asset type,
the second contribution amount associated with the second crypto asset type,
the crypto assets exchange quotient,
a quantity of previously issued fungible tokens specific to the crypto assets liquidity tranche datastructure, and
a total value locked in the crypto assets liquidity tranche datastructure; and
transfer, via at least one processor, the calculated quantity of fungible tokens specific to the crypto assets liquidity tranche datastructure to the provision blockchain address controlled by the sender of the decentralized exchange liquidity provision transaction.

2. The apparatus of claim 1, in which the component collection storage is further structured with processor-executable instructions, comprising:
update, via at least one processor, crypto assets balances for the crypto assets liquidity tranche datastructure to reflect contributions of the first contribution amount associated with the first crypto asset type and of the second contribution amount associated with the second crypto asset type.

3. The apparatus of claim 1, in which the instructions to determine the crypto assets exchange quotient are structured as instructions to query a price oracle.

4. The apparatus of claim 3, in which the component collection storage is further structured with processor-executable instructions, comprising:
verify, via at least one processor, exchange quotient fidelity associated with the crypto assets exchange quotient by checking compliance of a confidence measure provided by the price oracle with a confidence measure threshold rule.

5. The apparatus of claim 3, in which the instructions to determine the crypto assets exchange quotient are structured as instructions to utilize a derived crypto assets exchange quotient upon determining that a timestamp associated with the derived crypto assets exchange quotient is more recent than a timestamp associated with a crypto assets exchange quotient from the price oracle.

6. The apparatus of claim 1, in which each of the plurality of crypto assets liquidity tranche datastructures that constitute the liquidity pool associated with the bidirectional decentralized exchange smart contract utilizes a different type of fungible tokens specific to the respective crypto assets liquidity tranche datastructure.

7. The apparatus of claim 1, in which the component collection storage is further structured with processor-executable instructions, comprising:
obtain, via at least one processor, via the bidirectional decentralized exchange smart contract deployed on the blockchain, a decentralized exchange liquidity redemption transaction structured as specifying:
the crypto assets liquidity tranche datastructure,
a first redemption quantity associated with the fungible tokens specific to the crypto assets liquidity tranche datastructure, and
a redemption blockchain address controlled by a sender of the decentralized exchange liquidity provision transaction;
calculate, via at least one processor, a first redemption amount associated with the first crypto asset type via a calculation involving:
the first redemption quantity associated with the fungible tokens specific to the crypto assets liquidity tranche datastructure,
a quantity of currently issued fungible tokens specific to the crypto assets liquidity tranche datastructure, and
a total amount of crypto assets of the first crypto asset type locked in the crypto assets liquidity tranche datastructure;
calculate, via at least one processor, a second redemption amount associated with the second crypto asset type via a calculation involving:
the first redemption quantity associated with the fungible tokens specific to the crypto assets liquidity tranche datastructure,
the quantity of currently issued fungible tokens specific to the crypto assets liquidity tranche datastructure, and
a total amount of crypto assets of the second crypto asset type locked in the crypto assets liquidity tranche datastructure; and
transfer, via at least one processor, the calculated first redemption amount of crypto assets of the first crypto asset type and the calculated second redemption amount of crypto assets of the second crypto asset type to the provision blockchain address controlled by the sender of the decentralized exchange liquidity redemption transaction.

8. The apparatus of claim 7, in which the component collection storage is further structured with processor-executable instructions, comprising:
update, via at least one processor, crypto assets balances for the crypto assets liquidity tranche datastructure to reflect redemption of the first redemption amount associated with the first crypto asset type and of the second redemption amount associated with the second crypto asset type.

9. The apparatus of claim 7, in which the component collection storage is further structured with processor-executable instructions, comprising:
verify, via at least one processor, that a timestamp associated with the decentralized exchange liquidity redemption transaction is within an allowed redemption time.

10. The apparatus of claim 7, in which the component collection storage is further structured with processor-executable instructions, comprising:
determine, via at least one processor, that a timestamp associated with the decentralized exchange liquidity redemption transaction is outside an allowed redemption time;
determine, via at least one processor, an updated crypto assets exchange quotient for exchanging the first crypto asset type and the second crypto asset type; and
allow, via at least one processor, execution of the decentralized exchange liquidity redemption transaction upon determining that exchange quotient fidelity associated with the updated crypto assets exchange quotient is not verified.

11. The apparatus of claim 7, in which the component collection storage is further structured with processor-executable instructions, comprising:
determine, via at least one processor, that a timestamp associated with the decentralized exchange liquidity redemption transaction is outside an allowed redemption time;
determine, via at least one processor, an updated crypto assets exchange quotient for exchanging the first crypto asset type and the second crypto asset type; and
deny, via at least one processor, execution of the decentralized exchange liquidity redemption transaction upon determining that exchange quotient fidelity associated with the updated crypto assets exchange quotient is verified.

12. The apparatus of claim 7, in which the component collection storage is further structured with processor-executable instructions, comprising:
remove, via at least one processor, the first redemption quantity of fungible tokens specific to the crypto assets liquidity tranche datastructure from circulation.

13. The apparatus of claim 12, in which a fungible token is removed from circulation by destroying the fungible token.

14. The apparatus of claim 12, in which a fungible token is removed from circulation by returning the fungible token to a fixed supply.

15. The apparatus of claim 7, in which the component collection storage is further structured with processor-executable instructions, comprising:
update, via at least one processor, a derived crypto assets exchange quotient for exchanging the first crypto asset type and the second crypto asset type upon execution of the decentralized exchange liquidity provision transaction; and
update, via at least one processor, the derived crypto assets exchange quotient for exchanging the first crypto asset type and the second crypto asset type upon execution of the decentralized exchange liquidity redemption transaction.

16. A bidirectional decentralized exchange processor-readable, non-transient medium, the medium storing a component collection, the component collection storage structured with processor-executable instructions comprising:
obtain, via at least one processor, via a bidirectional decentralized exchange smart contract deployed on a blockchain, a decentralized exchange liquidity provision transaction structured as specifying:
a crypto assets liquidity tranche datastructure from a plurality of crypto assets liquidity tranche datastructures that constitute a liquidity pool associated with the bidirectional decentralized exchange smart contract,
a first contribution amount associated with a first crypto asset type,
a second contribution amount associated with a second crypto asset type, and
a provision blockchain address controlled by a sender of the decentralized exchange liquidity provision transaction;
determine, via at least one processor, a crypto assets exchange quotient for exchanging the first crypto asset type and the second crypto asset type;
calculate, via at least one processor, a quantity of fungible tokens specific to the crypto assets liquidity tranche datastructure to generate via a calculation involving:
the first contribution amount associated with the first crypto asset type,
the second contribution amount associated with the second crypto asset type,
the crypto assets exchange quotient,
a quantity of previously issued fungible tokens specific to the crypto assets liquidity tranche datastructure, and
a total value locked in the crypto assets liquidity tranche datastructure; and
transfer, via at least one processor, the calculated quantity of fungible tokens specific to the crypto assets liquidity tranche datastructure to the provision blockchain address controlled by the sender of the decentralized exchange liquidity provision transaction.

17. A bidirectional decentralized exchange processor-implemented system, comprising:
means to store a component collection;
means to process processor-executable instructions from the component collection, the component collection storage structured with processor-executable instructions including:
obtain, via at least one processor, via a bidirectional decentralized exchange smart contract deployed on a blockchain, a decentralized exchange liquidity provision transaction structured as specifying:
a crypto assets liquidity tranche datastructure from a plurality of crypto assets liquidity tranche datastructures that constitute a liquidity pool associated with the bidirectional decentralized exchange smart contract,
a first contribution amount associated with a first crypto asset type,
a second contribution amount associated with a second crypto asset type, and
a provision blockchain address controlled by a sender of the decentralized exchange liquidity provision transaction;
determine, via at least one processor, a crypto assets exchange quotient for exchanging the first crypto asset type and the second crypto asset type;
calculate, via at least one processor, a quantity of fungible tokens specific to the crypto assets liquidity tranche datastructure to generate via a calculation involving:
the first contribution amount associated with the first crypto asset type,
the second contribution amount associated with the second crypto asset type,
the crypto assets exchange quotient,
a quantity of previously issued fungible tokens specific to the crypto assets liquidity tranche datastructure, and
a total value locked in the crypto assets liquidity tranche datastructure; and
transfer, via at least one processor, the calculated quantity of fungible tokens specific to the crypto assets liquidity tranche datastructure to the provision blockchain address controlled by the sender of the decentralized exchange liquidity provision transaction.

18. A bidirectional decentralized exchange processor-implemented process, including processing processor-executable instructions via at least one processor from a component collection stored in at least one memory, the component collection storage structured with processor-executable instructions comprising:
obtain, via at least one processor, via a bidirectional decentralized exchange smart contract deployed on a blockchain, a decentralized exchange liquidity provision transaction structured as specifying:
a crypto assets liquidity tranche datastructure from a plurality of crypto assets liquidity tranche datastructures that constitute a liquidity pool associated with the bidirectional decentralized exchange smart contract,
a first contribution amount associated with a first crypto asset type,
a second contribution amount associated with a second crypto asset type, and
a provision blockchain address controlled by a sender of the decentralized exchange liquidity provision transaction;
determine, via at least one processor, a crypto assets exchange quotient for exchanging the first crypto asset type and the second crypto asset type;
calculate, via at least one processor, a quantity of fungible tokens specific to the crypto assets liquidity tranche datastructure to generate via a calculation involving:
the first contribution amount associated with the first crypto asset type,
the second contribution amount associated with the second crypto asset type,
the crypto assets exchange quotient,
a quantity of previously issued fungible tokens specific to the crypto assets liquidity tranche datastructure, and
a total value locked in the crypto assets liquidity tranche datastructure; and
transfer, via at least one processor, the calculated quantity of fungible tokens specific to the crypto assets liquidity tranche datastructure to the provision blockchain address controlled by the sender of the decentralized exchange liquidity provision transaction.
